(19) United States
(12) Patent Application Publication
(10) Pub. No.: US 2026/0093384 A1
(43) Pub. Date: Apr. 2, 2026

(54) INTERACTIVE SNAPSHOT OF PROCESS STATES

(71) Applicant: Oracle International Corporation, Redwood Shores, CA (US)

(72) Inventors: Haiyan Wang, Parker, CO (US); Qiu Zhong, Greenwood Village, CO (US); Michael Patrick Rodgers, Lake Oswego, OR (US)

(73) Assignee: Oracle International Corporation, Redwood Shores, CA (US)

(21) Appl. No.: 18/901,153

(22) Filed: Sep. 30, 2024

(51) Int. Cl. G06F 3/0484

(52) U.S. Cl. CPC G06F 3/0484

(57) ABSTRACT

Systems, methods, and computer-readable media are provided for storing a snapshot of an interactive node graph. A data management system generates an interactive node graph having nodes that represent process states and edges representing connections between process states.

The data management system uses a first live metric for determining aggregated node values and a second live metric to use for determining aggregated edge values. Based at least in part on a selection of an option to save the interactive node graph, the data management system stores a snapshot. The snapshot includes the aggregated node values based on the first live metric as of a particular time, the aggregated edge values based on the second live metric as of the particular time, a first mapping between the first live metric and the nodes, and a second mapping between the second live metric and the edges. The stored snapshot is loadable without access to the first live metric and the second live metric to display the interactive node graph.

### BACKGROUND

Various industries use software systems to maintain information about tasks, steps, stages, phases, and other processes that are being performed. For example, software systems keep track of order status, shipping status, manufacturing progress, product development progress, services rendered, sales progress, etc. For a given item or entity involved in an ongoing process, the software systems may be used to investigate the status or progress of the ongoing process based on which activities have occurred and which activities are yet to occur. For example, an item to be shipped may be prepared for shipping with a label printed but not yet picked up by the shipping carrier, or the item may be in transit with the shipping carrier with an estimated time of delivery to a destination.

The software systems include databases that store information about records, such as orders, items, products, or services, and the information about those records may be retrieved from the databases. For example, a database may be queried to find or select activities that have occurred relating to an order, item, product, or service. The activities may be analyzed to determine a status of the order, item, product, or service, and whether the activities align with user expectations for the order, item, product, or service.

The databases may also be used to generate reports. The reports provide information about records as selected by the author of the report. The analysis of the records is tied to the report author's insights, and any further insight into the records is currently limited.

### BRIEF SUMMARY

In some embodiments, a computer-implemented method includes storing state model(s), aggregate dataset(s), ledger(s), and/or snapshot(s) and assembling interface component(s) such as an interactive node graph for display on a user interface.

Systems, methods, and computer-readable media are provided for storing a snapshot of an interactive node graph. A data management system generates an interactive node graph having nodes that represent process states and edges representing connections between process states. The data management system uses a first live metric for determining aggregated node values and a second live metric to use for determining aggregated edge values. Based at least in part on a selection of an option to save the interactive node graph, the data management system stores a snapshot. The snapshot includes the aggregated node values based on the first live metric as of a particular time, the aggregated edge values based on the second live metric as of the particular time, a first mapping between the first live metric and the nodes, and a second mapping between the second live metric and the edges. The stored snapshot is loadable without access to the first live metric and the second live metric to display the interactive node graph.

In one embodiment, a computer-implemented method comprises generating an interactive node graph comprising a plurality of nodes. Each node of the plurality of nodes represents a process state of a plurality of process states. The interactive node graph comprises a plurality of edges representing a plurality of connections between process states of the plurality of process states. The computer-implemented method further includes receiving input selecting a first live metric to use for determining one or more aggregated node values for one or more nodes of the plurality of nodes and a second live metric to use for determining one or more aggregated edge values for one or more edges of the plurality of edges. The computer-implemented method further includes causing display of the interactive node graph, including causing display of the one or more aggregated node values and the one or more aggregated edge values. The computer-implemented method further includes receiving selection of an option to save the interactive node graph, and, based at least in part on the selection of the option, saving the interactive node graph at least in part by storing a snapshot. The snapshot comprises the one or more aggregated node values based on the first live metric as of a particular time, the one or more aggregated edge values based on the second live metric as of the particular time, a first mapping between the first live metric and the one or more nodes, and a second mapping between the second live metric and the one or more edges. The stored snapshot is loadable without access to the first live metric and the second live metric to display the interactive node graph comprising one or more aggregated node values and the one or more aggregated edge values.

In a further embodiment, the computer-implemented method includes receiving an update to the first live metric or the second live metric, and, based at least in part on the update, updating display of the interactive node graph to include one or more updated aggregated node values or one or more updated aggregated edge values.

In the same or a different embodiment, storing the snapshot further includes storing one or more filters configured for the interactive node graph. In this embodiment, the stored snapshot is loadable without access to the first live metric and the second live metric to display the interactive node graph as filtered by the one or more filters.

In the same or a different embodiment, storing the snapshot further includes storing two or more groups for which the first live metric and the second live metric are aggregated for the interactive node graph. In this embodiment, the stored snapshot is loadable without access to the first live metric and the second live metric to display the interactive node graph according to selectable groups of the two or more groups. In a further embodiment, the interactive node graph is saved to show aggregated values corresponding to a first group of the two or more groups, and the computer-implemented method further includes loading the interactive node graph from the stored snapshot, and receiving other input on the interactive node graph as loaded from the stored snapshot. In this embodiment, the other input selects a second group of the two or more groups. Based at least in part on the other input, the computer-implemented method further includes updating the interactive node graph to show other aggregated values corresponding to the second group without access to the first live metric and the second live metric.

In the same or a different embodiment, storing the snapshot further includes storing one or more visualization settings separate from the interactive node graph. In this embodiment, the one or more visualization settings are based at least in part on a plurality of aggregated values of the one or more aggregated node values and the one or more aggregated edge values. The stored snapshot is loadable without access to the first live metric and the second live metric to display the interactive node graph concurrently with one or more visualizations according to the one or more visualization settings based at least in part on the plurality of aggregated values.

In the same or a different embodiment, storing the snapshot further includes storing one or more other aggregated node values or one or more other aggregated edge values according to another live metric that is not selected for display in the interactive node graph. The computer-implemented method further includes loading the stored snapshot to display the interactive node graph. The computer-implemented method further includes receiving input to change selection of the first live metric to use for determining the one or more aggregated node values or the second live metric to use for determining the one or more aggregated edge values to the other live metric. The computer-implemented method further includes updating display of the interactive node graph without access to the other live metric to show the one or more other aggregated node values or the one or more other aggregated edge values.

In the same or a different embodiment, the computer-implemented method further includes simulating the one or more aggregated node values or the one or more aggregated edge values as of the particular time based at least in part on values of the first live metric as of another particular time.

In the same or a different embodiment, the computer-implemented method further includes simulating the one or more aggregated node values or the one or more aggregated edge values as of the particular time based at least in part on aggregated values of the first live metric from one or more other snapshots as of another particular time.

In the same or a different embodiment, the computer-implemented method further includes concurrently displaying two or more interactive node graphs and a common set of controls. The common set of controls is used to change which aggregated values are shown in both of the two or more interactive node graphs.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1A illustrates a flow chart of an example process that generates an interactive node graph showing process states.

FIG. 1B illustrates a flow chart of an example process that generates an interactive node graph showing aggregate node and/or edge metrics.

FIG. 1C illustrates a flow chart of an example process that saves a snapshot from a live data source that allows an interactive node graph of process states to be generated from the snapshot without further access to the live data source.

FIG. 1D illustrates a flow chart of an example process that cycles through frames of process states for different data slices to update an interactive node graph.

FIG. 2 illustrates a system diagram showing an example data management system that stores state model(s), aggregate dataset(s), ledger(s), and/or snapshot(s) and assembles interface component(s) such as an interactive node graph for display on a user interface.

FIG. 3 illustrates a diagram of an example user interface for display of an interactive graph and associated data metrics.

FIG. 4 illustrates a diagram of an example user interface for display of an interactive graph and associated data metrics with expanded filter settings.

FIG. 5 illustrates a diagram of an example user interface for display of an interactive graph and associated data metrics with further expanded filter settings.

FIGS. 6A and 6B illustrates a diagram of an example user interface for display of related interactive graphs and depictions of the relationship.

FIG. 7 illustrates a diagram of an example user interface for display of an interactive graph and editing of associated data metrics.

FIG. 8 illustrates a table of data used for deriving associated data metrics for an interactive graph.

FIG. 9 illustrates a table of data detailing relationships between various process steps used for defining an interactive graph.

FIG. 10 illustrates a diagram of an example user interface for display and editing of an interactive graph and associated data metrics.

FIGS. 11A-11E illustrate diagrams of example interfaces for configuring and saving a snapshot of a node graph.

FIGS. 12A-12K illustrate diagrams of example interfaces for loading and analyzing snapshots.

FIGS. 13A-13C illustrate diagrams of example interfaces for viewing snapshots or other node graphs side-by-side.

FIG. 14 illustrates a diagram of an example interface for viewing merged snapshots, data groups, or live views from different data sources.

FIG. 15 illustrates a diagram of an example interface for filtering snapshots or other node graphs side-by-side.

FIG. 16 illustrates a diagram of an example interface for filtering merged snapshots, data groups, or live views from different data sources.

FIGS. 17A-17C illustrate diagrams of example interfaces for configuring and playing a timeline animation of node graphs.

FIGS. 18A-18B illustrate diagrams of example interfaces for configuring and playing a field-based animation of node graphs while showing edges to nodes that are represented in the model but not represented in the dataset.

FIGS. 18C-18D illustrate diagrams of example interfaces for configuring and playing a timeline animation of node graphs without showing edges to nodes that are not represented in the dataset.

FIG. 19 depicts a simplified diagram of a distributed system for implementing certain aspects.

FIG. 20 is a simplified block diagram of one or more components of a system environment by which services provided by one or more components of an embodiment system may be offered as cloud services, in accordance with certain aspects.

FIG. 21 illustrates an example computer system that may be used to implement certain aspects.

### DETAILED DESCRIPTION

In various embodiments, a data management system operates using a service instance and a client instance to generate, load, and display interactive node graphs and other visualizations. The visualizations may be based on live data feeds, from snapshots of live data feeds or other aggregations of the live data feeds, and/or from state models that model process state. The visualizations are interactive at the client instance to explore different data slices and different settings, groupings, filters, thresholds, and other configurations corresponding to the different data slices.

A description of storing state model(s), aggregate dataset(s), ledger(s), and/or snapshot(s) and assembling interface component(s) such as an interactive node graph for display on a user interface is provided in the following sections:
INTERACTIVE GRAPH GENERATION
DISPLAY OF THE INTERACTIVE GRAPH
INTERACTIVE GRAPH METRICS
CUSTOMIZING VISUALIZATIONS FOR SUBSETS OF DATA
NAVIGATING BETWEEN RELATED PROCESSES
ADJUSTING FILTERS FOR SNAPSHOTS, LIVE VIEWS, AND/OR ANIMATIONS
CONFIGURING AND SAVING SNAPSHOTS OF PROCESS STATES
INTERACTIVE ANIMATION OF PROCESS STATE ANALYSIS
MIXED SOURCE ANALYSES OF PROCESS STATES
SYNCHRONIZED ANIMATIONS FOR MIXED SOURCE ANALYSES
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Interactive Graph Generation

Multi-step processes for an organization can be difficult to track and even more difficult to obtain useful information about. A multi-step process may be any kind of process comprising steps required to be executed for successful completion of a process, such as a process involving item(s). For example, a multi-step process may be the fulfillment of a product or purchase order, a sales process, inventory tracking, manufacturing, the development process of a project, or any transactional based system. Such processes are important processes for a business often requiring multiple steps of possible failure which an organization would like to track and visualize to best optimize the process.

An organization may employ methods to track the various steps of a process as items flow through the process such as enterprise resource planning processes. An enterprise resource planning system may maintain an enterprise resource planning database for recording data collected about a process. The enterprise resource planning database may contain a table or ledger for tracking operations or steps within a process such as requisitions, purchase orders, sales orders, work orders, inventory movement, or warehouse activity. These various steps or operations may be performed for individual items that the organization tracks through the organization's processes.

As any item moves through an organization's processes, the organization's various methods for tracking processes, such as an enterprise resource planning system, may record a set of data within a table or ledger including data representing the status at various stages of a process. Various methods of tracking steps of a process may make use of data markers to track the statuses of items that are transitioning through various states. A status marker may be any kind of data with a known value that relates to a particular status within the process such as a status code. For example, a three digit numerical status code may be used where a unique number is assigned for each possible status within the process.

A status marker may be recorded in a table or ledger tracking the items. The table or ledger for tracking the items may record other data such as values relevant to the item or the progress or results of various steps of the process. The status marker recorded may indicate a current status of the item, a past status of the item, a next status for the item, or any combination thereof.

A table or ledger for tracking the items may record a single entry for each item tracked, where the status marker(s) recorded reflect the most recent status information about an item. The table or ledger for tracking the items may also record multiple entries for a given item, where each entry represents a change in status for the item. In this case, an item data marker may be recorded with each entry to act as a key to identify which item an entry describes.

A table or ledger for tracking items through a process may be derived from other systems employed by an organization, such as an enterprise resource management system. An enterprise resource management system may compile data in a table or ledger as an output of the enterprise resource management system, an output of workflows or other automations, or for other purposes of the enterprise resource management system. In either case, the table or ledger from the enterprise resource management system may be used by the data management system to generate an interactive graph to visualize the process described.

To describe or visualize a multi-step process, a data management system may generate an interactive graph depicting the process as a series of nodes, representing steps or candidate process states, interconnected via edges, representing the links between the steps. Within a graph, each step may be represented by one or more nodes. A node is a point within a graph containing a label to convey the node's representation of its corresponding step and connected to one or more other nodes via an edge. A node is often represented as a shape, image, or icon within a graph, optionally with a label or other means to distinguish the different nodes of a graph. An edge within a graph is a connection between nodes of the graph. An edge within a graph represents the connection or link between steps of a process so as to show a process flow, or the order in which different steps of a process are performed or relate to each other. In various examples, an edge may be represented as a line between two nodes. An edge may be represented directionally, so as to indicate whether items moving through the process represented by the interactive graph may move only in one direction between two connected nodes or in either direction between the connected nodes.

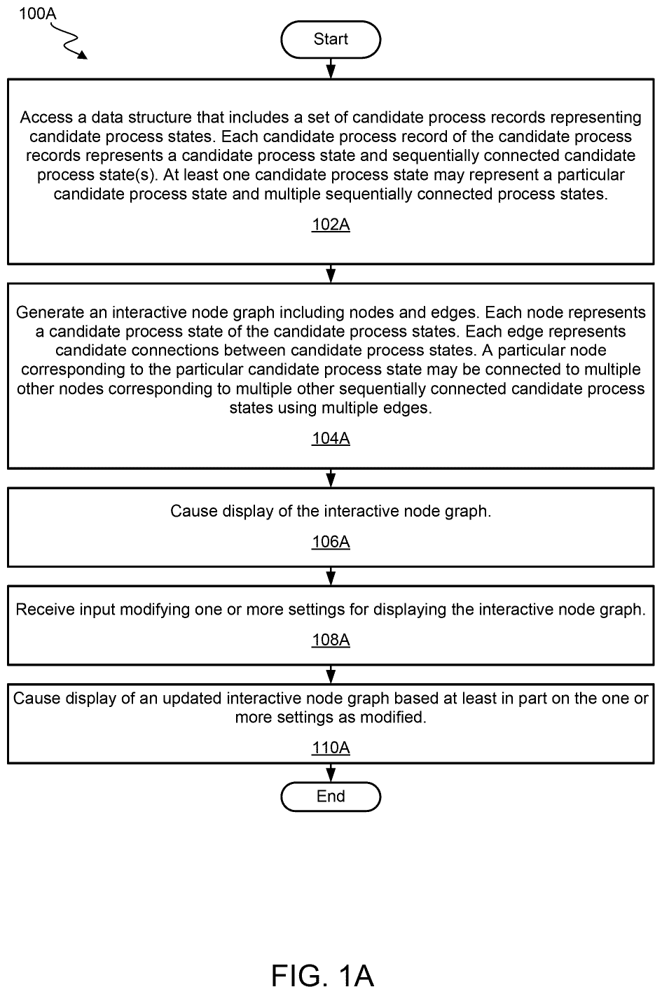

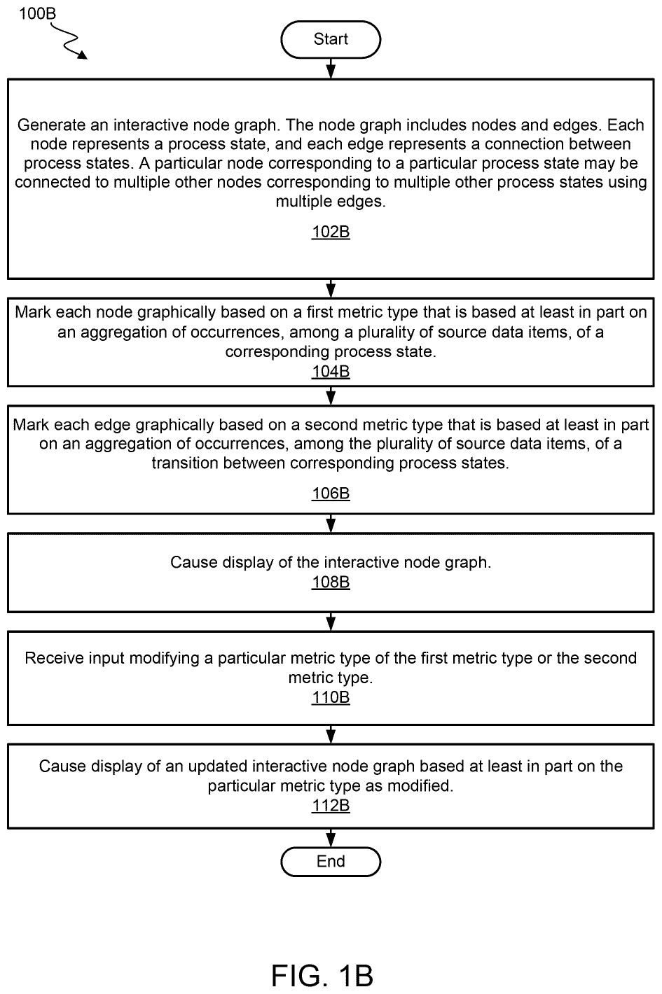

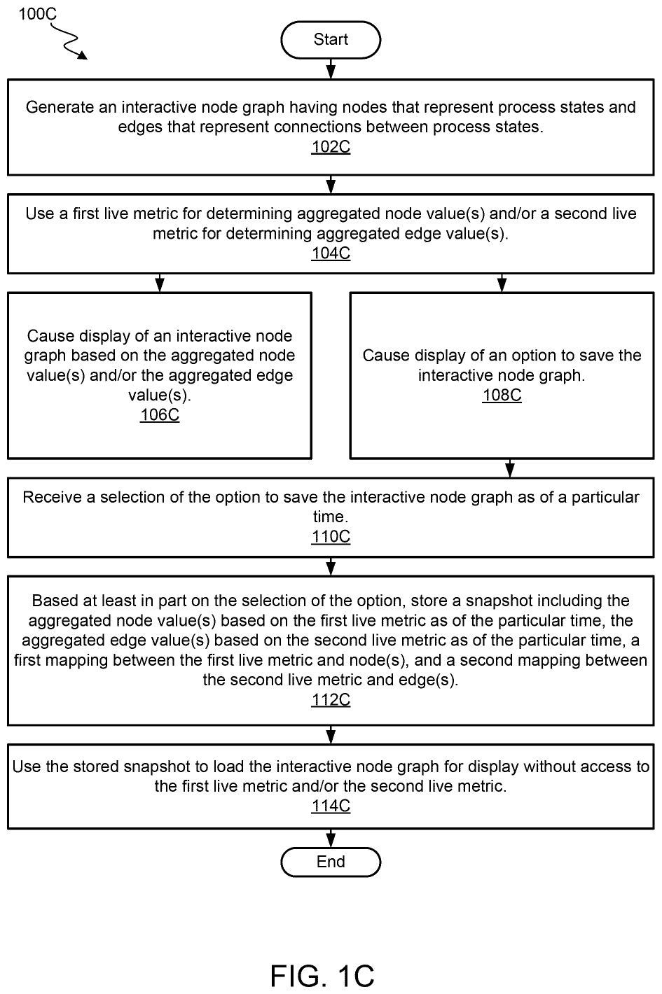

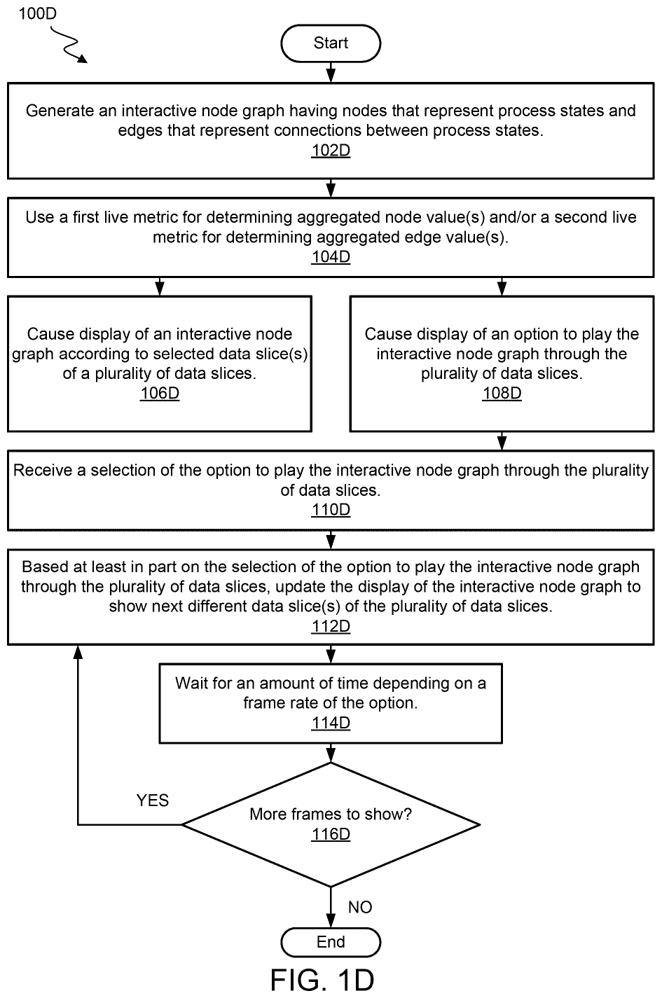

FIG. 1A illustrates a flow chart of an example process that generates an interactive node graph showing process states. In block 102A, the data management system accesses a data structure that includes a set of candidate process records representing candidate process states. Each candidate process record of the candidate process records represents a candidate process state and sequentially connected candidate process state(s). At least one candidate process state may represent a particular candidate process state and multiple sequentially connected process states. In block 104A, the data management system generates an interactive node graph including nodes and edges. Each node represents a candidate process state of the candidate process states. Each edge represents candidate connections between candidate process states. A particular node corresponding to the particular candidate process state may be connected to multiple other nodes corresponding to multiple other sequentially connected candidate process states using multiple edges. In block 106A, the data management system causes display of the interactive node graph. In block 108A, the data management system receives input modifying one or more settings for displaying the interactive node graph. In block 110A, the data management system causes display of an updated interactive node graph based at least in part on the one or more settings as modified.

An interactive graph may be displayed in a user interface on a client device. Display of any parts of or depictions on the user interface may be performed by command or direction of the data management system. The data management system may cause the display of any depictions on the user interface in a remote session with the user's client device. The user's client device may run an instance of a web application or other low-code or no-code environment for displaying the user interface without the need to process functions or calculations for processing actions to display the user interface and interpret input. The user interface may convey to the data management system any user input via the user interface, which may then be interpreted by the data management system to determine a desired action to perform and cause the display of an update in response to the user's input on the user interface.

An interactive graph depicting a multi-step process may be generated from a set of rules that define the rules for connections between steps of the process. A set of rules may define possible connections between steps in a process by direct reference to the other steps or by a set of premises by which the possible connecting steps within the process may be inferred. A set of rules may also define possible connections between steps separately than preferred connecting steps to continue the process to. A preferred connection may be a possible connection in which there is some preference within the process to move between the connected steps of the process over other possible connections to the originating step of the process. For example, a preferred connection may be a connection from a prior step to a most frequently advanced to step of the process or a step of the process with the least number of steps to and end step of the process.

A set of rules may be recorded in a rules table, a data table which stores rules for connections between steps of the process. The rules table may, for example, list each step of a process as a candidate process record in the table and for each candidate process record in the table may record possible connecting steps or preferred steps. The table may also record all possible connections to a step, either as prior steps or connecting steps to advance the process to. For example, a single candidate process record of the table may represent a candidate process state and records two other sequentially connected candidate process states.

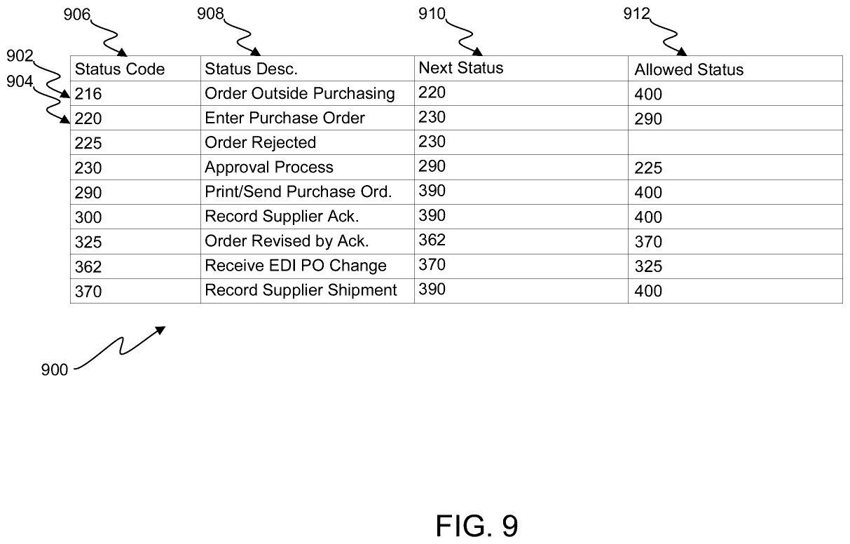

FIG. 9 depicts an example rules table 900. The rules table 900 may include a plurality of records 902-904. Each record of the rules table represents a step of a process described by the rules table 900. The rules table includes a status code domain 906 in which a value of a status code is recorded for each record. The status code may be a number used as a key to identify other records within the rule table 900 when referring to that number. The rules table 900 may also include a status description domain 908 where, for each record, a text-based status description or name is designated for each record. The status description 908 may be used as the label for a corresponding node of the interactive graph. The rules table 900 also includes a connected status code domain 910. The connected status code 910 designates a status code of another record in the rules table 900 as a connected status. When generating an interactive graph from the rules table 900, each connected status 910 may be represented as an edge connecting the node for the status code 906 to the connected status 910. The rules table 900 may also include one or more other connected statuses domains 912. The other connected status 912 may be used as further connected statuses as connected status 910, or the other connected status 912 may be used as a possible connected status while the connected status 910 is used as a preferred connected status.

A rules table may be user-defined by a user with knowledge of the process. A user may define rules of the rules table by recording within the interactive graph each step of the process as a record with a label and connecting steps for each step. The user may define connecting steps by entering a label of another record of the rules table within a connecting step domain record. After a user has entered all records for the rules table, the rules table may be used to construct an interactive graph.

A rules table may also be generated by digestion of data such as a table or ledger tracking items that have moved through the process. To generate a rules table from a table or ledger tracking items through a process, the table or ledger may be parsed to determine possible connections for each step of the process. A first status marker may be retrieved from a first entry of the table or ledger to determine a node to describe. A second status marker may be retrieved from the first entry to determine a possible connection from the first node to a second node representing the step of the second status marker. Within the rules table, a row is created to describe the first node with data describing the second node as a possible connecting node, if it is not yet recorded for the first node. This process may be repeated for each entry in the table or ledger such that all possible connections between nodes may be described.

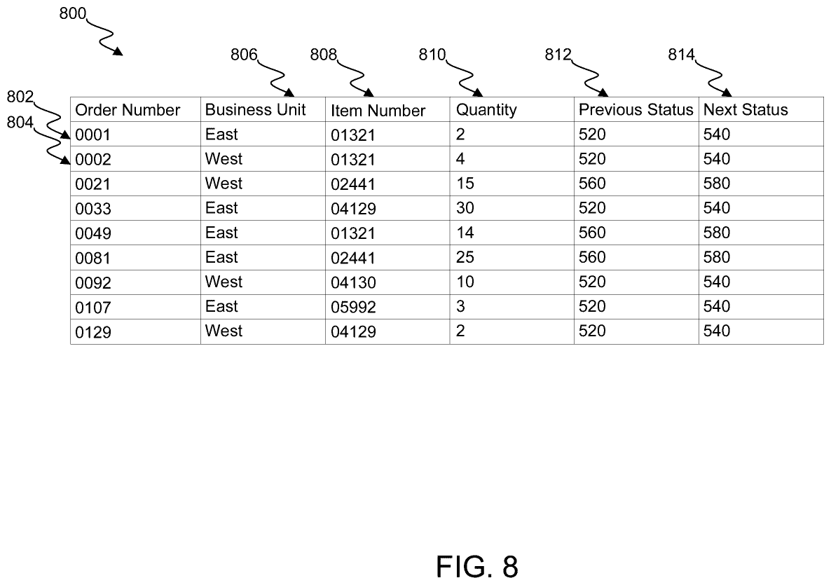

FIG. 8 depicts an example data table 800 used for generating a rules table or graph metrics. The data table 800 includes a plurality of records 802-804, each representing an entry recorded by a process management system. The data table 800 may record for each record one or more additional data domains 806-810. The additional data domains 806-810 may record data relevant to the entries that may be used for filtering the data or derived metrics. The data table 800 also includes a first status code domain 812. The first status code 812 may record a status code for the entry such as a current status code. The data table may also include a second status code domain 814, in which case each entry represents a specific time at which the item described transitioned from the first status code 812 to the second status code 814.

A rules table may also be generated to describe preferred connections. To generate preferred connections in a rules table, the entries of the table or ledger tracking items through a process may be parsed where the connection described in each entry is recorded in a tally such that a total number of instances of use of each connection may be recorded. The total number of instances of each connection are then compared such that, for each node, one or more preferred connection leading from that node may be determined. A preferred connection may be determined as a most frequent connection of the connections leading from a node or a connection having beyond a threshold level of instances of that connection. Preferred connections may also be generated by parsing the recorded rules table to determine each possible path to a final node of the set of nodes described in the rules table from a first node in the rules table to determine one or more connections with the least number of connections to a final node.

An interactive graph of nodes and edges representing the steps of a multi-step process may be generated from a rules table. For each candidate process state represented by a candidate process record of the rules table, a node for the graph is generated. The node may be associated with the candidate process state by metadata or data of the candidate process record may be recorded with the node such as a status marker. For each candidate process state represented by a candidate process record of the rules table, any recorded connecting candidate process states are parsed to generate an edge between the corresponding nodes of the graph for each listed connecting candidate process node if an edge does not already exist within the graph. Unless a directionality is indicated, the edge generated for a connection listed in a candidate process record is depicted as indicating a connection from the node of the candidate process record to the node of the connecting candidate process state.

For example, a rules table may contain a candidate process record for a first process state which indicates possible connections to a second process state and a third process state. A node is generated for the first process state, the second process state, and the third process state. To depict the candidate connections, a first edge is generated from the first process state to the second process state and a second edge is generated from the first process state to the third process state.

As generation of further edges continues through the rules table, a listed connection may connect from a first node to a second node where there already exists an edge connecting from the second node to the first node. The edge may be modified to indicate a connection either direction between the first and second node, or a new edge may be generated connecting the first node to the second node.

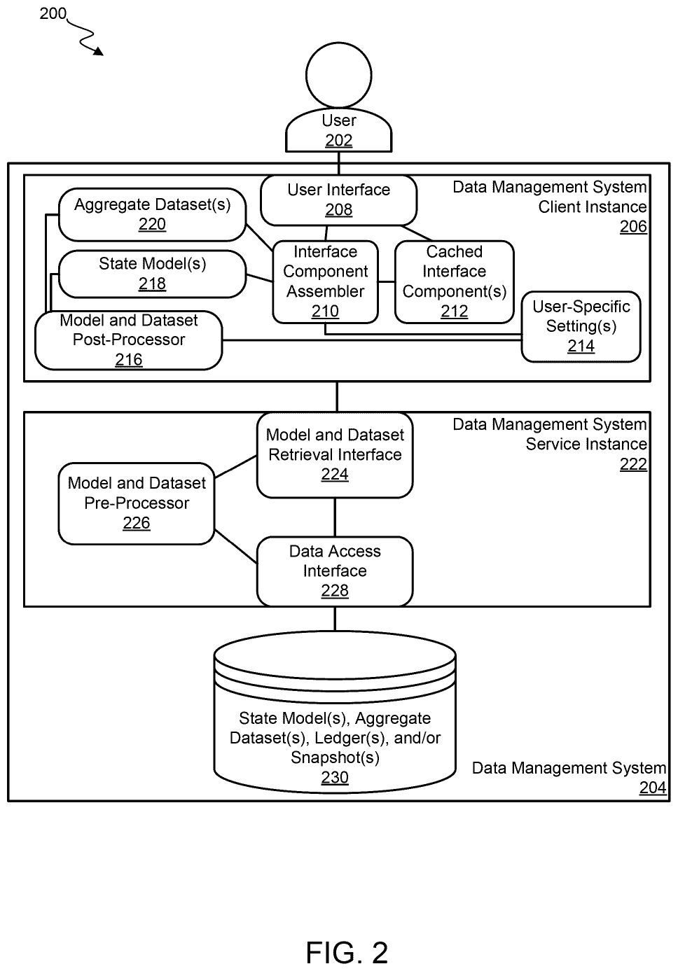

FIG. 2 depicts a system 200 for generating and displaying an interactive graph representing a process. A user 202 interacts with a data management system 204 via a user interface 208. The user interface 208 is managed by a data management system client interface 206. The user 202 submits a request via the user interface 208 to generate an interactive graph for a given process to display on the user interface 208. An interface component assembler 210 manages the generation of components for display on the user interface 208. The interface component assembler 210 first checks if a cached version of the requested graph exists in the cached interface components 212. If not, the interface component assembler sends a request to the data management system service instance 222 to retrieve required data for the graph.

The data management system service instance 222 contains a model and dataset retrieval interface 224 which interprets the request for data for depicting with the interactive graph and determines a proper model to retrieve or the proper aggregation of data to result in the dataset required for the metrics for depicting with the graph. The data retrieval is performed by a data access interface 228, which generates a data request or aggregation statement executable against a database 230 containing state models, aggregate datasets, ledger, and/or snapshots. The data retrieved by the data access interface 228 is pre-processed by a model and dataset pre-processor 226 such as to remove unnecessary data, validate that the data retrieved is responsive to the data requested, or generate a rules table or model based on the data retrieved. The data is then sent to the data management system client instance 206 for interpretation and display to the user 202.

The data management system client instance 206 includes a model and dataset post-processor 216 which may interpret the data retrieved such as to generate a rules table or model based on the data and store as a state model 218. The model and dataset post-processor 216 may also perform calculations on the data for determining metric values based on user-specific settings for which metrics to display. The data retrieved by the data management system service instance 222 may be stored as an aggregate dataset 220. A generated rules table, model, or graph data from the data retrieved by the data management system service instance 222 may be utilized by the interface component assembler 210 to generate an interactive graph with concurrent display of metrics based on user-specific settings 214 for determining the methods of representation of graph elements and metrics for display. The generated interactive graph and metrics may be displayed to the user 202 as well as cached as a cached interface component for future requests by the user 202 or another user.

The depiction of graph elements within the user interface may be edited by input of a user. A user may edit the location of graph elements after graph generation, such as by selecting a graph element to edit and selecting a new location for the depiction of the graph element. A user may also edit the depiction of a graph element. For example, a user may select a graph element and select from a set of representation settings for the graph element to change a graph element's shape, style, size, color, opacity, font, emphasis, or any other factor of the graph element's visual representation.

A connection within a candidate process record may list the same candidate process state as a connected candidate process state to itself. In this case, the edge generated may indicate a loop from and back to the same node. This edge may be depicted differently from other edges, based on a representation setting.

An interactive graph may be modified by a user to alter, create, or delete nodes or edges of the graph. The user interface may include a region for modifying node data. The region for modifying node data may display the data for each of the nodes or edges of the graph in a data format, such as a graph editing table of data describing the nodes and each connecting node or edge. The region for modifying node data may display the same data as the rules table for constructing the graph. A user may modify the graph by editing the data displayed in the region, such as by editing, removing, or adding rows of data to the graph editing table.

A user interface may also permit a user to alter, create or delete nodes or edges of the graph by editing elements of the graph directly. The user interface may allow a user to select elements of the graph for editing, where the graph element is put into an editing mode. When a graph element is in an editing mode, the user may, for example, delete the element, edit the element's label, edit the element's location in the graph, or edit aspects of the element's relation to other graph elements. When making edits to the graph, the updated graph data may be saved upon each edit and optionally edits may be automatically made to the rules table representing the associated edits made to the graph. For example, if an edge of the graph were to be deleted by a user, the graph data may automatically be saved and the corresponding connecting node label listed in the associated record of the rules table may be deleted. In another example, if a node label were to be edited, the graph data may be automatically saved, and a prompt may be displayed to the user to determine if the corresponding label of the rules table should also be edited.

When a user edits a graph element by editing the location of a graph element within the graph, the user interface may determine new depictions of the connected graph elements to the edited graph element. For example, if a user edits the location of a graph node by dragging the node to a new location on the graph, the connected edges to the graph may be displayed with a new depiction based on graph depiction settings.

The user interface may also include an option for a user to create new graph elements. The user interface may include a selection for a graph element to be created. When selecting a graph element to be created, the new graph element may be displayed on the graph for editing by the user or displayed in a temporary state for the user to select a location within the graph for display. When selecting to create a new edge of the graph, the user may optionally define whether the edge indicates a possible or a preferred edge. As well, when selecting to create a new edge of the graph, the user interface may display an indication in association with the user's cursor that an edge is to be created. The user may then select a first node and a second node to be connected by the new edge. The new edge may then be created between the first node and the second node and displayed. After creation of a new graph element, the user may define data for the graph element such as by entering a label for the graph element or designating a data source from a table or ledger.

When a new graph element is created by the user, the data of the new graph element may be saved with the graph data. The new graph element may also be optionally saved to a rules table associated with the graph, to indicate a pathway not previously included is possible. The new graph element may also optionally be saved to the ledger to indicate an occurrence of the data according to input provided by the user on the graph. The user interface may display a prompt to the user to query whether to save data to the rules table based on the newly created graph element. For example, a region of the user interface displaying data of the rules table may display an indication of a predicted edit based on the newly created graph element. The user may select to approve of a predicted edit to the rules table or edit the data of the rules table.

A user may also generate an entirely new graph without prior generation from a rules table. The user interface may permit a user to create a new graph by selecting to create new graph elements. When creating new graph elements for a user-defined graph, the user may be prompted to enter data for the graph element such as by entering a label for the graph element or designating a data source from a table or ledger for the graph element. After creation of a user-defined graph of when creating a new graph element of a user-defined graph, a new rules table may be defined based on the user-created graph element(s). For each new graph node created by a user, a new record of the rules table may be created and labeled with a user-entered label. For each new graph edge created by a user, an indication may be created within the records of the connected graph nodes to indicate the connection between the nodes. Data occurrences may also be added in a ledger based on input provided by the user on the graph corresponding to the new graph nodes and/or edges.

### Display of the Interactive Graph

After generation of the graph, the data management system may display the graph on a user interface. Alternatively, the data management system may, after generating the graph, store graph structure data recording the structure of the graph such that the graph may be displayed by referencing the graph structure data. The graph structure data may be a data object recording the nodes and edges of the graph to display. Alternatively, the graph structure data may be an image data file such as a JPEG, PNG, GIF, or other image file.

The data management system may cause the display of the graph to a user either on a remote device, such as the user's device, or on a display connected to the data management system. The data management system may cause the display of the graph in one or more user interfaces. A user interface for displaying the graph may contain a region for displaying the graph and a region for receiving user input to request display of the graph. A region for receiving user input to request display of the graph may be, for example, a region for receiving natural language input, a region for binary user selection, such as a button, or one or more data selection regions for selecting data to use in display of the graph. In response to user input in a region for receiving user input to request display of the graph, the data management system may receive a request and any additional data or settings of the request for display of the graph. In response to receiving the request for display of the graph, the data management system may generate the graph for display or may access graph structure data of a prior-generated graph for display.

The graph may be displayed using multiple methods of visualization in a single user interface. For example, a user interface may contain a first region for display of the graph in a detailed representation. The user interface may contain a second region for concurrent display of the graph in a less detailed or smaller representation. In this way, a user may inspect individual elements of the graph in the first region while the graph displayed in the second region is visible to depict the context of the whole graph for the individual elements of the graph. A user selection, edit, or change of a representation setting for of the regions displaying the graph may cause a change to the display of the graph in the other region. For example, selection by a user of a specific graph element from the graph displayed in the first region may cause a change to the display of the graph in the second regions such that the corresponding specific graph element of the graph in the second region is identified to the user.

Nodes, edges, and other components of the graph may be displayed visually according to one or more representation settings for the graph. A representation setting may be stored data describing an individual graph element, such as a specific node, or a graph element type such as all nodes or edges. A representation setting may record visual representation data for display of the graph elements such as a graph element's shape, size, color, opacity, style, visibility, or other settings affecting the visual display of a graph element.

Representation settings may be defined by a user, such as by a user's interaction with a user interface region for selecting representation settings of the graph. A user may also pre-determine a set of representation settings to be saved as user preferred representation settings. A representation setting may also be pre-defined such as a default representation setting. A default representation setting may be a standard representation setting for all graphs or may be one default representation setting of a set of default representation settings for a given graph display mode. A default representation setting may be used for display of a graph unless a user has pre-defined a user preferred representation setting.

A representation setting may also be defined by a set of rules for defining representation settings, such as a rule defining representation based on a value of a given metric for a graph element. A rule defining representation settings may define a representation setting based on values of data for the graph or based on the structure of the graph and details of graph elements. For example, a rule may define a representation setting for display of edges of a graph that connect from a given node to the same node that is different from a default representation setting for all nodes of the graph.

A rule for defining representation settings may vary the representation of a graph element based on a current user selection or setting. For example, when a user selects a node of the graph, a rule may define a representation setting for the nodes of the graph to display each node with emphasis based on the number of edges or connections away from the selected node the node is. The node or an edge may be selected as a focal graph element, and a region around the focal graph element may be adjusted to place graphical emphasis on the focal graph element. A rule for defining representation settings based on a current user setting may define the representation of graph elements based on the selected setting such as a representation color of edges of the graph based on a selected metric type to display for edges of the graph.

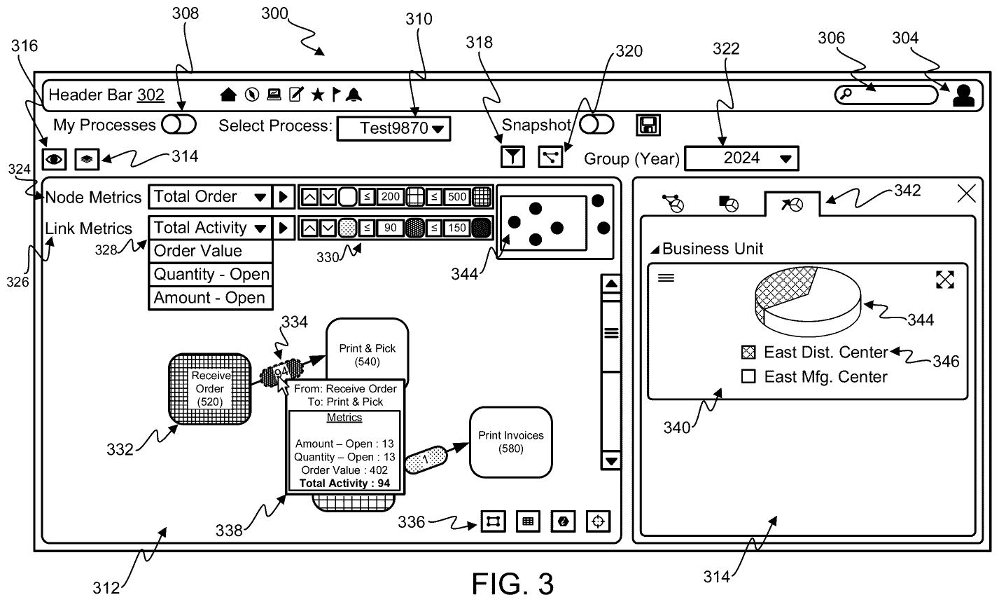

FIG. 3 depicts an example user interface 300 for displaying an interactive node graph. The user interface 300 may include a header bar 302 with various selections for navigating or changing global display settings for the user interface. The user interface 300 may be displayed as part of a session with a data management system, and the user interface may recognize a user 304 via a set of user credentials and load personalized user settings. The user interface may contain a search function 306 for identifying information within or otherwise navigating the user interface 300. By recognizing the user 304, the user interface may load processes associated with the user credentials. The user may select to limit the view of processes to only those processes associated with the user via a process filter selection 308.

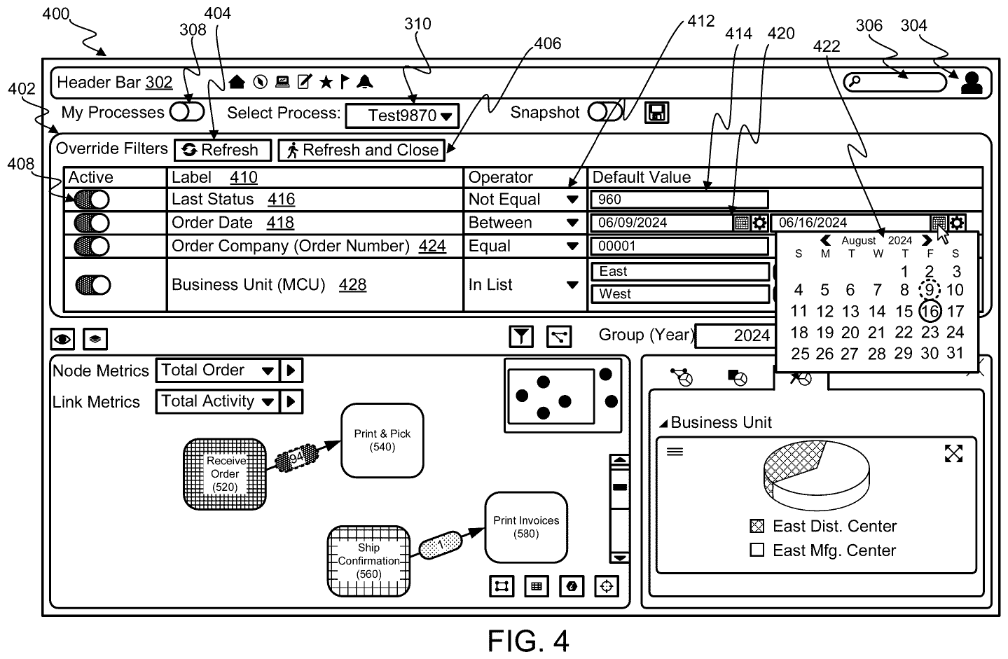

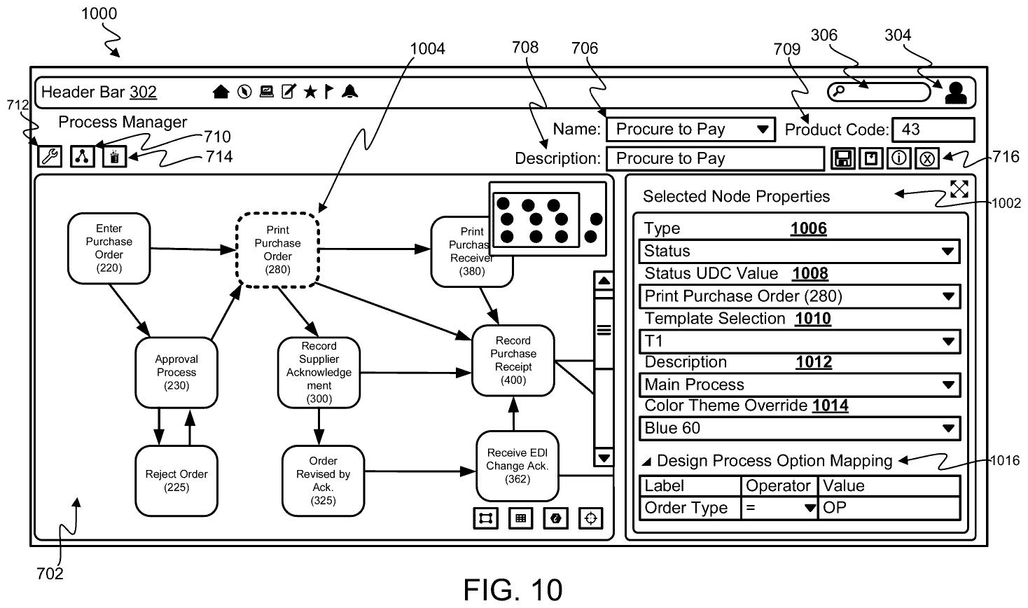

The user interface 300 may include a selection to determine the current process for display or editing via a process selection 310. The data for the selected process, including a generated interactive graph, is then retrieved by the data management system and displayed within the user interface 300, such as in an interactive graph display region 312. The interactive display region 312 may be controlled by a number of interactive graph display controls 314-320. Interactive graph display controls 314-320 may contain further controls or settings for editing the display of the interactive graph and data. For example, an interactive graph display control 314 may open a first expanded window for displaying settings related to the display of analytics. In another example, an interactive graph display control 316 may open a second expanded window for displaying settings related to display options of the graph, such as graph element depiction settings. Another interactive graph display control 318 may control filter options for the display of an interactive graph with associated data. The interactive graph display control 318 for displaying filter options may, for example, open a filter window 402 as depicted in FIG. 4. Yet another interactive graph display control 320 may control underlying graph element settings. The interactive graph display control 320 for controlling graph element settings may, for example, open a graph element properties region 1002 as depicted in FIG. 10. The user interface 300 may also include a commonly used filter setting 322 for selecting a value on which to filter the data displayed with the interactive graph. The commonly used filter setting 322 may, for example, be a time period selection for filtering the data displayed to a specific period of time.

A graph may be displayed with specific data from a table or ledger for display with the graph. The data of the table or ledger may be used for determining representation settings of the graph or may be depicted concurrently with the display of the graph such as displaying the table or ledger in another region of the user interface for displaying the graph. Alternatively, data of the table or graph may be displayed in association with the graph element they describe. For example, data from an individual record of the table or ledger may represent a specific status for a given item. Data about the item may be displayed in association with the node associated with the specific status. The data of the table or ledger may also be aggregated based on the status of the process each entry of the data represents and metrics may be derived from the aggregation.

Referring back to FIG. 3, the interactive graph display region 312 may contain graph element controls 324-330 for altering the data depicted with the interactive graph. A node metric display control 324 may include one or more node display settings for determining the display of metrics associated with each node. The node metrics display control 324 may include, for example, a selection of node metric for display or a node metric display setting for determining the representation of a node 332 based on the associated metric value. A link metric display control 326 may similarly include one or more link display settings for determining the display of metrics associated with a link 334. The link metrics display control 326 may include a link metric selection 328. The link metric selection may permit the selection of one or more pre-defined link metrics for display in association with the links of the interactive graph. As link metrics may be pre-defined, the link metric selection may be, for example, a drop-down menu populated by the pre-defined metrics for links. The link metric display control 326 may also include a link metric display setting 330. The link metric display setting 330 may allow the selection of one or more link metric display aspects for determining the display of links depending on the value of the associated link metric. The link metric display setting 330 may be, for example, a plurality of color display selections and logical statements for defining the color display of a link metric. The link metric display setting 330 may include a selection for the user to determine a logical operator such as an inequality symbol and a value to define a logical statement for the comparison of a metric value to determine a link metric display setting. The interactive graph display region 312 may include further graph navigation settings 336 for navigating the graph or displaying additional data related to the graph.

Representation settings of graph elements may be defined based on data of a ledger or table of data to display with a graph. For example, a rule for defining representation settings may define a representation setting to display newly generated nodes or edges of the graph generated based on the ledger or table of data to display with the graph. In this example, the different display of newly generated nodes or edges may be used to detect anomalies in the data of the table or ledger. In another example, a rule for defining representation settings may define a representation setting to display nodes or edges that are not represented in the data of the table or ledger for display with the graph.

### Interactive Graph Metrics

FIG. 1B illustrates a flow chart of an example process that generates an interactive node graph showing aggregate node and/or edge metrics. In block 102B, the data management system generates an interactive node graph. The node graph includes nodes and edges. Each node represents a process state, and each edge represents a connection between process states. A particular node corresponding to a particular process state may be connected to multiple other nodes corresponding to multiple other process states using multiple edges. In block 104B, the data management system marks each node graphically based on a first metric type that is based at least in part on an aggregation of occurrences, among a plurality of source data items, of a corresponding process state. In block 106B, the data management system marks each edge graphically based on a second metric type that is based at least in part on an aggregation of occurrences, among the plurality of source data items, of a transition between corresponding process states. In block 108B, the data management system causes display of the interactive node graph. In block 110B, the data management system receives input modifying a particular metric type of the first metric type or the second metric type. In block 112B, the data management system causes display of an updated interactive node graph based at least in part on the particular metric type as modified.

An interactive graph may be displayed with one or more metrics describing the data of the table or ledger to display with the graph. A metric may be any kind of quantitative description of the data of the table or ledger and may relate specifically to elements of the interactive graph. The one or more metrics may be derived from the data of the table or ledger. The one or more metrics may be calculated based on a pre-determined formula as part of a pre-determined metric definition. The one or metrics may also be determined by aggregating data from the table or ledger so as to determine metrics across multiple entries or records of the table or ledger.

For example, a metric may describe the number of items moving through a node or edge of the graph. In this case, the metric may be calculated by first constructing an aggregation command to execute on the table or ledger. The aggregation command may aggregate all entries within the table or ledger based on a status code associated with each of the entries of the table or ledger. The aggregation command may aggregate all records relevant to nodes or edges of the graph. Alternatively, a separate aggregation command may be executed to aggregate records individually for each node or edge.

The aggregation command may be, for example, a SQL SELECT statement executed on the table or ledger. The SQL SELECT statement may include a WHERE clause to aggregate only those entries for the node or edge in question. For example, a SQL statement may be “SELECT ItemID FROM SalesData WHERE CurrentStatus=240”. In this example, the aggregation command is aggregating all values in the ItemID dimension for entries with a status code associated with the current node, “240.”

After execution of the aggregation command, the resulting set of data retrieved from the table or ledger may be parsed to calculate the metric for each node or edge of the graph in question. For example, for a metric to determine the number of instances of items passing through a given node of the graph, the data may be parsed to determine the number of instances, represented by the number of individual entries in the set of data. A set of data retrieved from an aggregation command may contain multiple entries representing the same item for a given node or edge. Depending on the metric to calculate or based on user settings, the data may be parsed to determine a number of unique entries in the data, representing the instances of any item passing through a node or edge, or a number of unique items passing through a node or edge, distinguished by an item identification dimension of the data or unique item keys associated with the data.

A metric may be an extreme of the data or identify an edge case within the data. For this case, an aggregation command may be executed to aggregate all the relevant data, which is then parsed by performing a search on the data for an extreme or edge case within the data. For example, a metric may be a highest value within a domain of the data such as a time from entering a given status to passing to another status. The data of the table or ledger may contain a total time for each entry recording the time spent within that status. The retrieved data may be searched by using a search algorithm to determine a highest value of the total time domain and a corresponding item ID for the highest value found. Alternatively, each entry may define a transition between statuses with a recorded time code. In this case, a time between each status transition may be calculated after a matching is performed for each entry in chronological order, such as based on the time codes. The highest value of the calculated time codes is then determined by performing a search on the calculated time codes.

Separate metrics may be defined for nodes and edges of the graph. A graph may be displayed with the same metric for all graph elements. Alternatively, the graph may be displayed with a first metric for display with nodes of the graph and a second metric for display with edges of the graph. Some metrics may be specifically defined for only nodes or edges of the graph. For example, a metric may be defined specifically for edges that describes a numerical relationship to other edges based on the common node they are connected to.

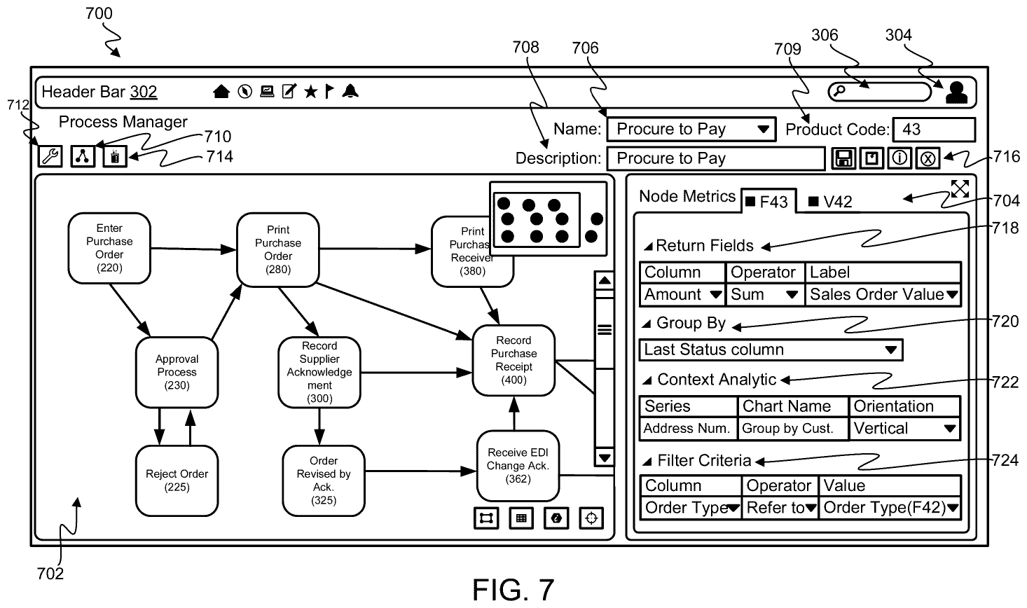

FIG. 7 depicts a user interface 700 including an interactive graph display region 702 and a metrics properties region 704. The metric properties region 704 includes settings for defining a metric. The user interface 700 may include a process selection option 706 and corresponding process data selections 708 and 709. The user interface 700 may also include process management settings 716 for saving or modifying process data. The user interface may include a set of display settings 710-714 for selecting different interface settings. The metric properties region 704 may include a set of metric properties 718-724. A return field setting 718 may include a value to return as the metric value, defined by a calculation or aggregation on a given domain of the data. A grouping setting 720 may define a data domain to group data by such that entries for a given item are treated as separate from records of other items. A context analytic setting 722 may define settings for the visualization of context-specific metrics for the metric. A filter criteria setting 724 may define possible filter criteria that may be used to filter the data when the metric is calculated.

A metric may require a calculation to be performed on data aggregated by an aggregation command to determine a final metric value. In various examples, calculations performed on live data may be cached and re-used if the relevant underlying live data has not been updated since last use. Calculations performed for snapshots may be cached and re-used since the underlying data is not live and changing on-the-fly. In one example, a metric for edges of a graph may be a percentage of the total items for a connected node that pass through each given edge connected to that node. For this metric, an aggregation command may be performed for each node of the graph. The aggregated data may be parsed to determine a number of items that were transitioned between the node and each connected node. Alternatively, a separate aggregation command may be performed for each connected node, where the total entries or items determined by the aggregation command are determined to be the number of items that were transitioned between the node and the connected node. The percentage for each edge connected to the node may then be determined by dividing the number of items transitioned to the edge's connected node by the total number of items for the node. As not all items may be yet transitioned to another node, the total number of items for the node may be determined by an aggregation statement for the node or by a summation of the items transitioned to each of the connected nodes based on a metric setting for the metric.

A metric may be determined using access to data outside the table or ledger. In this case, the metric may have a predetermined source for the outside data as defined in a metric setting for the metric, or the source of the outside data may be defined by the user in response to a prompt upon selection of the metric for display. The outside data may be accessed when calculating the metric or, in the case that the source of the outside data is defined prior, the outside data may be accessed and stored, optionally with regular accesses to update the stored data. For example, a metric may be a total value of all items passing through a given node or edge of the graph, where a conversion is to be made from a currency value indicated in the data and another target currency value. In this case, a current exchange rate for the two currencies must be obtained for the calculation of the metric. A network request may be made to an outside data source based on a pre-defined network location stored in the metric setting or entered by a user in response to a prompt when selecting the metric to display. A current exchange rate may be obtained from the outside data source as a modifier value and used to calculate a final target currency value by multiplying the current exchange rate by a total value of the items calculated by parsing the results of an aggregation command.

After a metric is calculated, it may be displayed concurrently with the interactive graph. Each calculated value of the metric may be displayed concurrently with the interactive graph in association with the graph element that calculated value describes. The metric may be displayed according to one or more metric display settings. A metric display setting may define a visual depiction setting for the metric, such as a font, color, opacity, or style, or a metric display setting may define a method of depiction in association with the associated graph element, such as a location relative to the graph element, whether or not to display the metric for the particular graph element, or whether to match a display setting for the graph element. A metric display setting may also define an association display relationship for determining how to display a metric in association with a graph element. For example, a metric display setting for an association display relationship may define that a metric should be displayed a pre-defined distance from the graph element.

A metric may be concurrently displayed in association with a graph element by first determining if there is a metric display setting defining an association display relationship. If there is no association display relationship metric display setting, a default association display relationship may be used. An anchor point for the display of the metric may then be defined based on the association display relationship and the current location of the associated graph element. The data management system may then determine a graphical representation for the metric to display based on any other metric display settings or default display settings for the interactive graph such as a globally defined font size. The determined graphical representation for the metric may be displayed concurrently with the interactive graph based on the determined anchor point for the display of the metric.

In one example, the interactive node graph may be adjusted by making changes using the Node Metrics and Link Metrics drop-down lists. When the Node Metrics and Link Metrics fields are changed, the values and colors on the nodes and links on the node graph visualization change accordingly, and the data management system displays the corresponding changes on the charts in the Node Analytics and Link Analytics tabs, for example, indicated as extended visualizations on the right-hand side.

The data management system may also receive user input changing the node and link metrics by using the Show Analytics Options. For example, the data management system may receive user input selecting the Node Metrics drop-down list (in the model pane) and further selecting a metric to be shown. To make changes to the threshold values of the nodes, the data management system may receive user input selecting the Expand Threshold Configurator icon and may receive user input selecting the Ascending or Descending icons or entering the values in the fields. The data management system shows, in the node graph, the statuses of the nodes and links by their color codes or other graphical indications according to the defined thresholds.

The node graph may be further interacted with using a hover or click on a node, which, in one embodiment, causes the data management system to show the status code and metric details on a hover form. In one example, on the hover form, the field selected in the Node Metrics drop-down list is displayed in bold, and the value of the field is displayed in the threshold color.

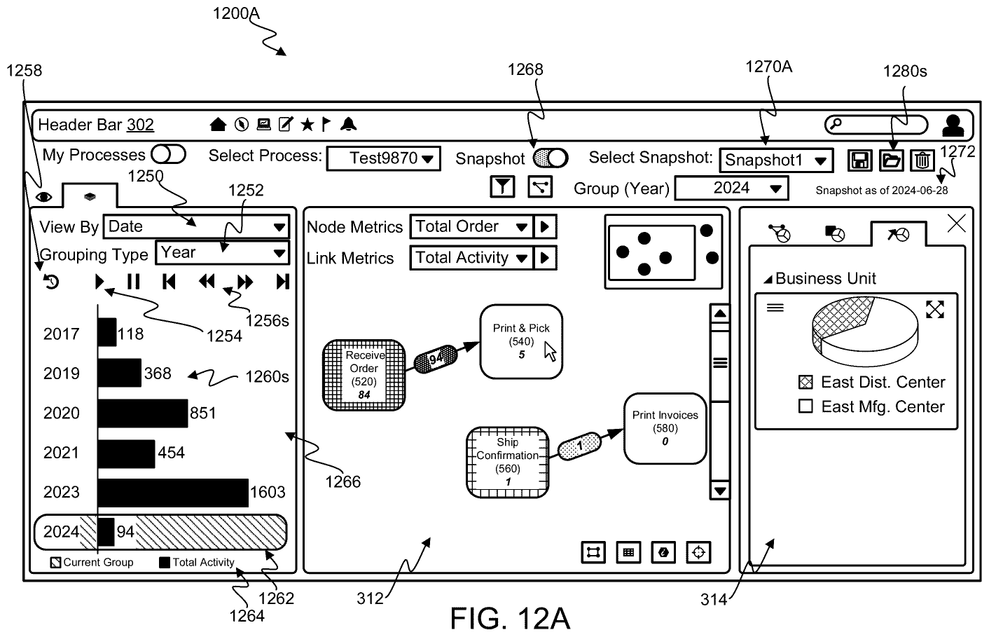

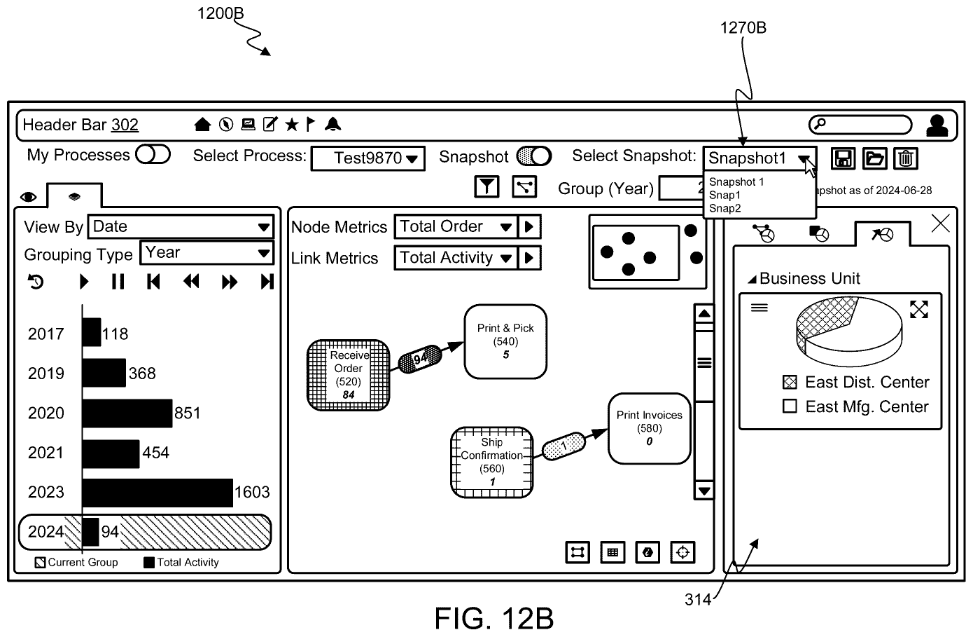

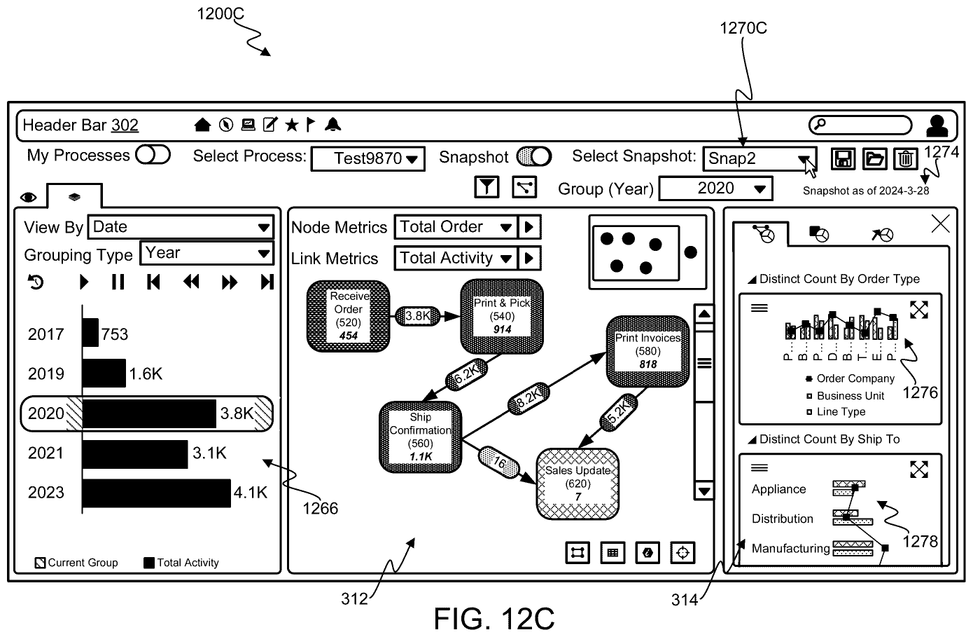

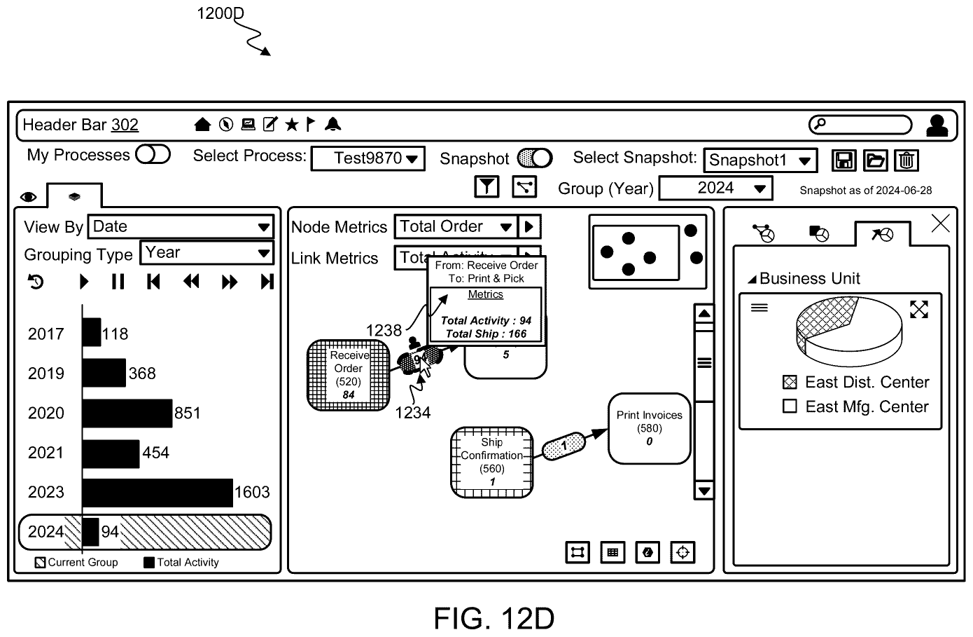

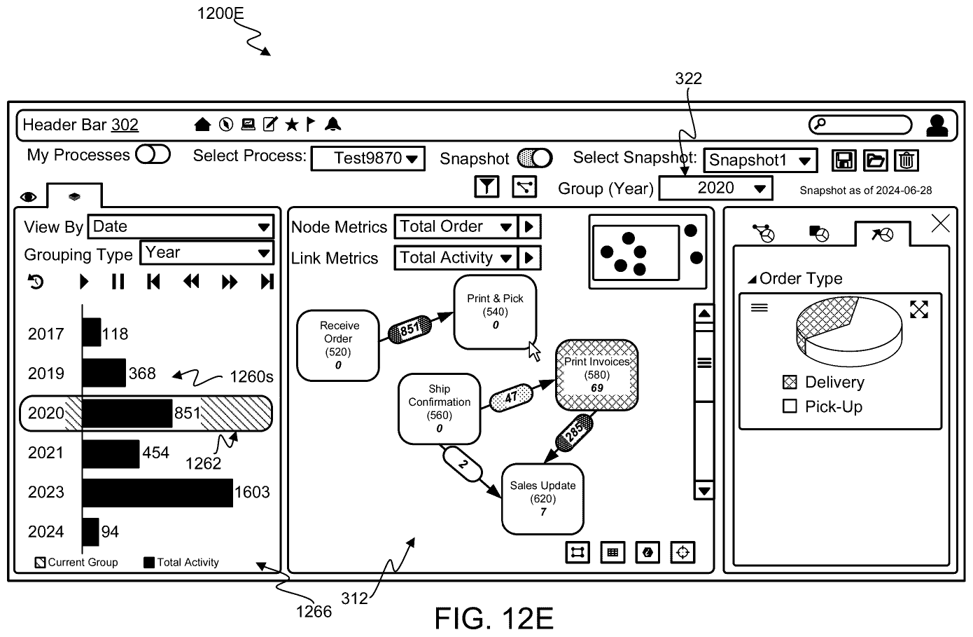

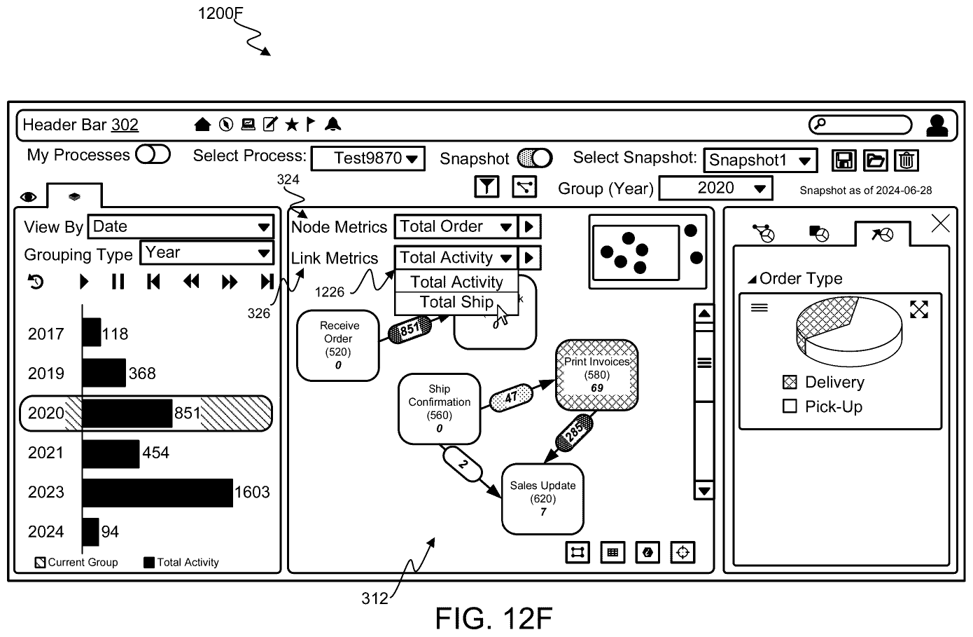

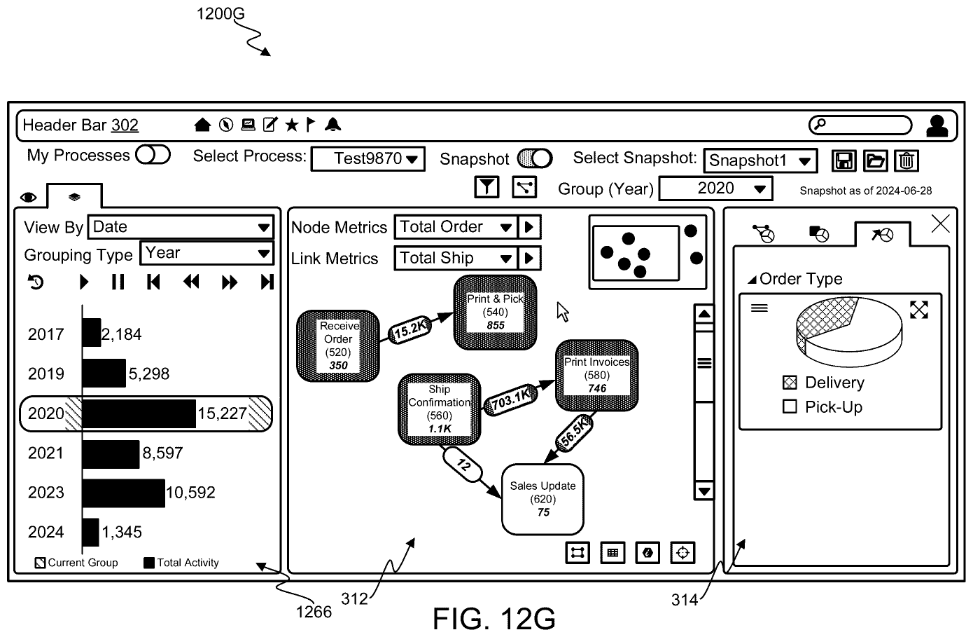

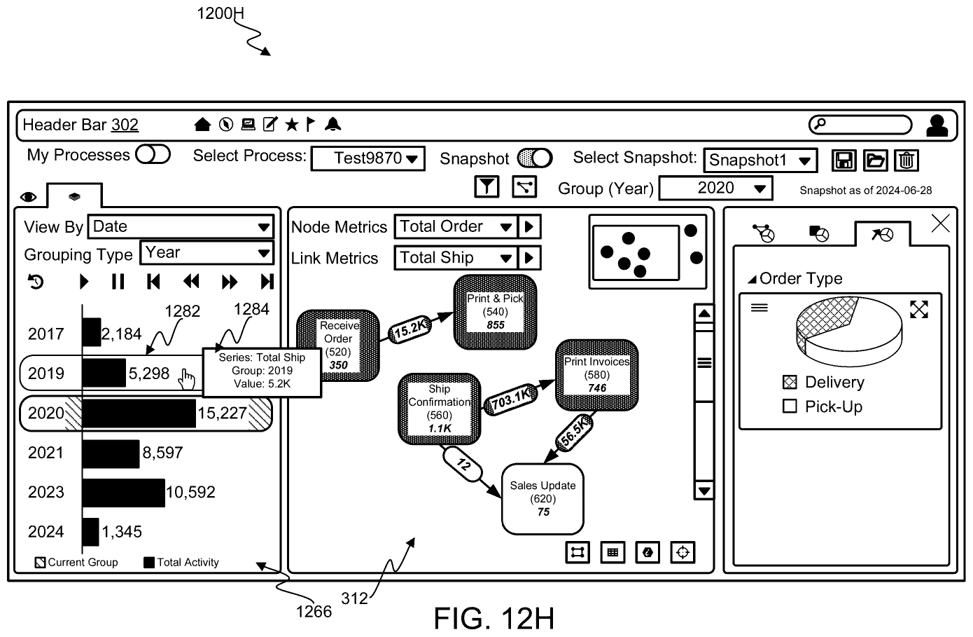

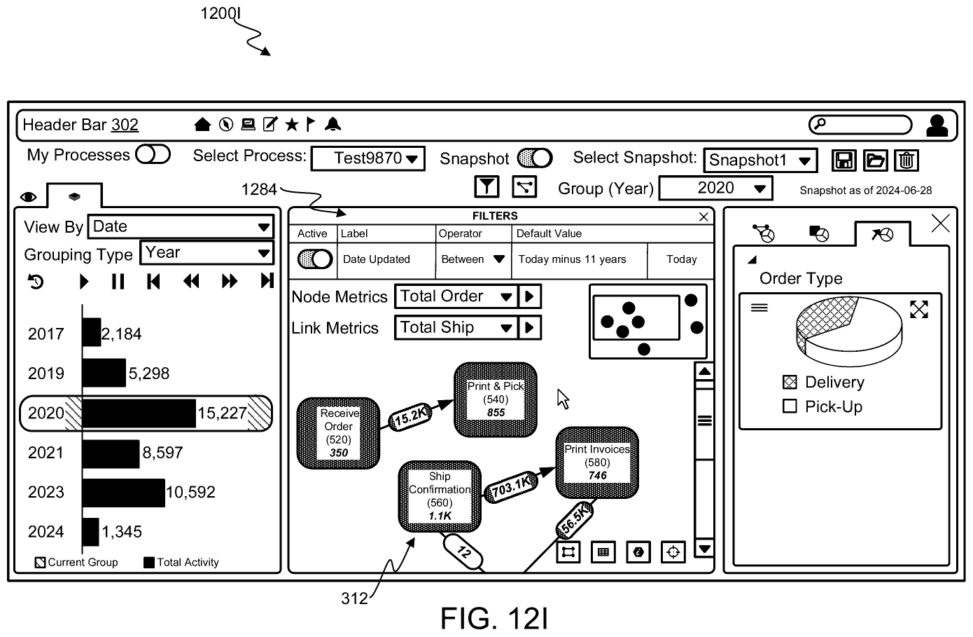

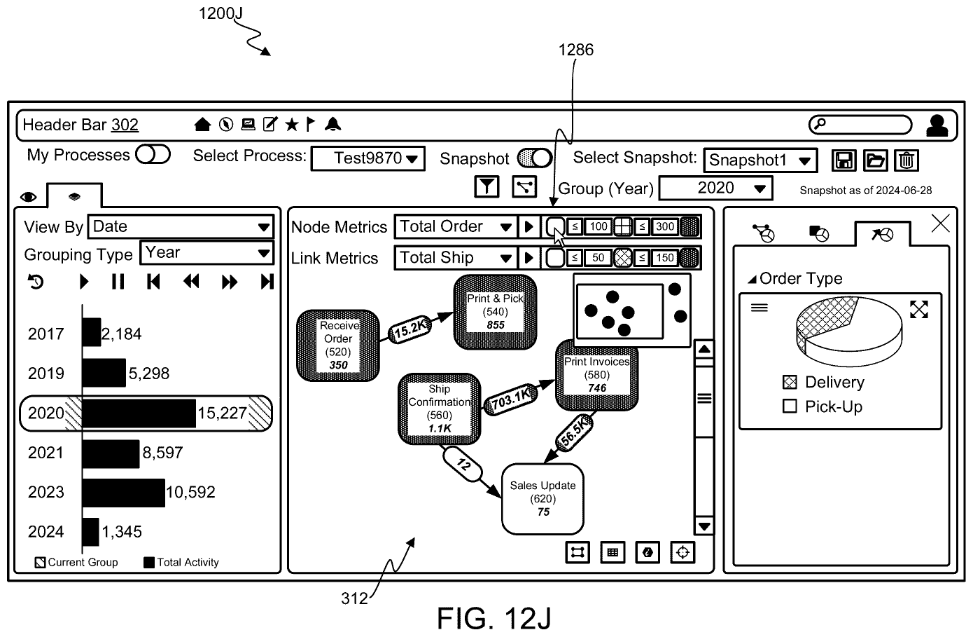

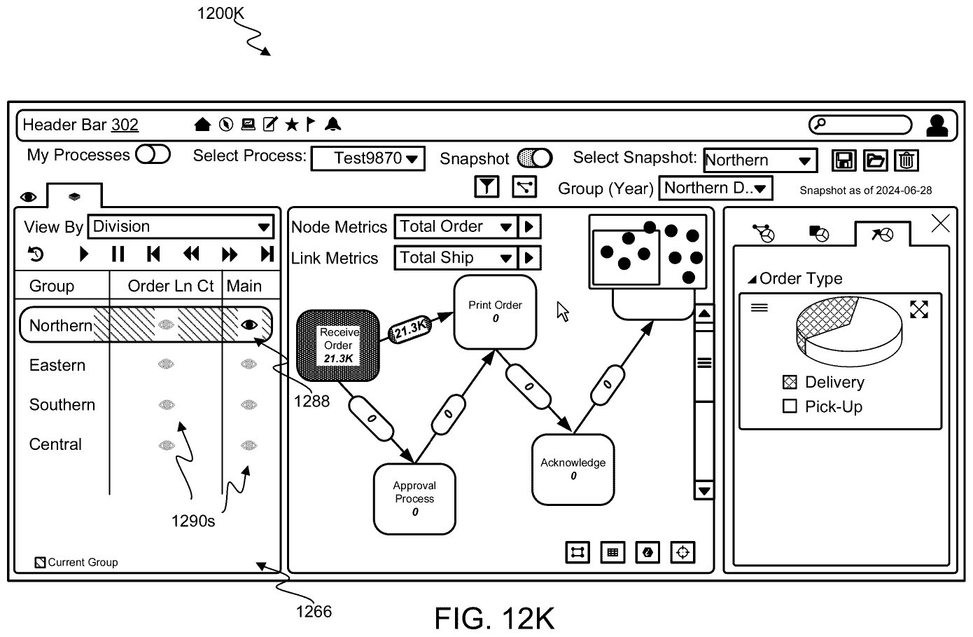

In one example, a particular field is selected from the Node Metrics drop-down list. On the hover form, the selected field may be displayed in bold, and its value is displayed in red on the node, and on the hover form, according to a specified threshold setting. In the example, the value may be displayed in red since the value exceeds the threshold value. The corresponding metrics and details for the node states are displayed on the Node Analytics tab on the right. The data management system may display a people icon above a selected node or link to indicate that the node or link is selected, as shown in FIG. 12D. The data management system displays a dashed border (with a “marching ants” effect) around the node when you hover over a selected node or link.

In one example, another particular field is selected from the Node Metrics drop-down list. On the hover form, the name may be displayed in bold, and its value is displayed in orange since it is in the warning status. In the example, the corresponding metrics and details for the other particular field may be displayed on the Node Analytics tab on the right.

The Collapse Threshold Configurator (arrow) icon may be selected to close the configurator window. Similarly, to change and analyze the link metrics, the Link Metrics drop-down list may be selected, and a target value may be further selected.

Changes to the threshold values of the links may be performed based on a selection of the Expand Threshold Configurator (arrow) icon, and further selection of the Ascending or Descending icons, or direct entry of the values in the fields. The data management system shows the states of the nodes and links by their color codes or other graphical indications.

In one embodiment, the data management system shows From and To values of the link, and other metric details of the link in a hover form, in response to a user input hovering over, clicking, or otherwise selecting the link. On the hover form, the field selected in the Link Metrics drop-down list may be displayed in bold and the value of the field displayed in the threshold color. The corresponding changes may be displayed on the Link Analytics tab on the right as extended visualizations.

In an example, a particular field is selected from the Link Metrics drop-down list. The field name may be displayed in bold, and the value of the field may be displayed in orange on the link, and on the hover form. The value may be displayed in Orange since the value is in the warning status indicated by the threshold settings. The corresponding changes are displayed on the Link Analytics tab on the right. The Collapse Threshold Configurator (arrow) icon may be selected to close the configurator window.

### Customizing Visualizations for Subsets of Data

An interactive graph may be displayed concurrently with one or more context-specific metric visualizations (also referred to as extended visualizations). A context-specific metric visualization may be a representation of data for a process or partial process that describes a specific metric with a visualization that is specific to the context of that metric. For example, a context-specific metric visualization may be a bar graph representation for a given metric over a given time series. The bar graph representation may be chosen to represent the context-specific metric visualization based on the metric described being a countable value such as a number of items moving through a node of the graph.

A context-specific metric visualization may be describe a whole process or a partial process, such as a single step of the process. When displaying the interactive graph, a current selection may be determined for the interactive graph. The current selection may be determined based on a user input such as a user clicking on a graph element or a current state of the graph such as a user cursor being over a graph element or the graph being in a focus mode for a specific graph element. When no current selection may be determined, the current selection may be determined to be for the whole graph. When displaying the interactive graph, a context-specific metric visualization for the current selection may be displayed concurrently with the interactive graph.

A context-specific metric visualization may be displayed concurrently with the interactive graph by displaying the context-specific metric visualization over the interactive graph or in a separate region for displaying context-specific metric visualizations. A separate region for displaying context-specific metric visualizations may be, for example, a side-bar next to the graph.

Referring back to FIG. 3, the user interface 300 may include a context-specific metric visualization display region 314 for displaying additional, context-specific metrics concurrently with the interactive graph. The context-specific metric visualization display region 314 may include one or more context specific metric visualization 340, for example a pie chart graph. The particular context-specific metric visualization displayed in the context-specific metric visualization display region 314 may be selected from one or more context-specific metric visualization selections 342.

Referring back to FIG. 3, an example context-specific metric visualization 340 is displayed. The example context-specific metric visualization 340 depicts a pie chart for the various values within the business unit domain of the table or ledger. Referring to FIG. 12C, a first example context-specific metric visualization 1276 is depicted. The first example context-specific metric visualization 1276 represents a horizontal bar and line chart of distinct counts by order type. The second example context-specific metric visualization 1278 is depicted and represents a vertical bar and line chart of distinct counts by ship to.

In various examples, the following analytics tabs are displayed on the right side of the Enterprise Process window as extended visualizations:
Process Analytics display the analytics charts for the process as a whole, covering multiple node(s) and/or link(s).
Node Analytics display the analytics charts for the selected node(s).
Link Analytics display the analytics charts for the selected link(s).

The Process Analytics tab displays the charts based on the design of the metrics in the template. The charts displayed in the Node Analytics and Link Analytics tabs are based on the aggregation operator types. Example Aggregation Operator Types include counter, sum, distinct count, average, min, and max. Example chart types include a pie chart, scatter plot, bar chart (with an optional reference line to present a contextual value), line charts, histograms, heat maps, box plots (box-and-whisker plots), tree maps, area charts, bubble charts, radar charts (spider charts), Sankey diagrams, chord diagrams, Gantt charts, waterfall charts, violin plots, word clouds, etc.

The analytics tabs may be hidden or unhidden to provide more space for the main node graph or less space for the main node graph but more space for the additional analytics, respectively. The arrow icons in the corner may be used to collapse or expand the individual charts in the analytics tabs. The Maximize or Minimize icons on the charts are selectable to view them in maximized or minimized modes.

When a node is selected, the Node Analytics tab may be displayed along with the node-specific charts. When a link is selected, the Link Analytics tab may be displayed along with the link-specific charts. The data management system displays a click to set the context to the process level icon that shows up as a mini node graph when the Node Analytics or Link Analytics tabs are displayed on the right. This icon may be selected to view the Process Analytics tab.

The Process Analytics tab may be analyzed or modified by selecting, on the chart, the Configure icon (three horizontal lines). For example, the Stack Series option may be enabled to extend the bar chart to compare the numeric values between levels of a categorical variable. For a pie chart, the Stack Series option causes the data management system to display the data in a bar chart format.

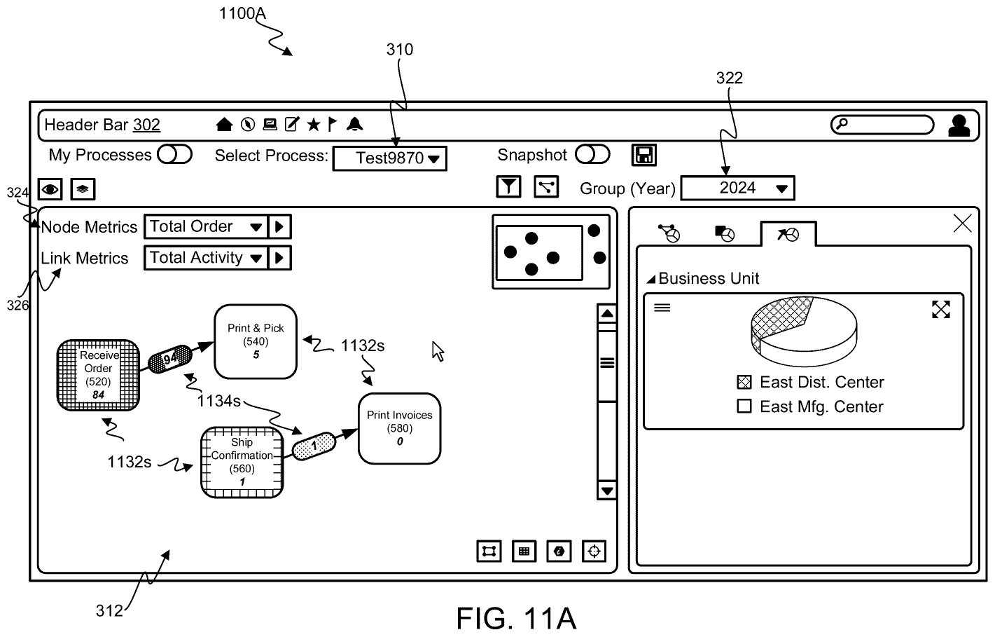

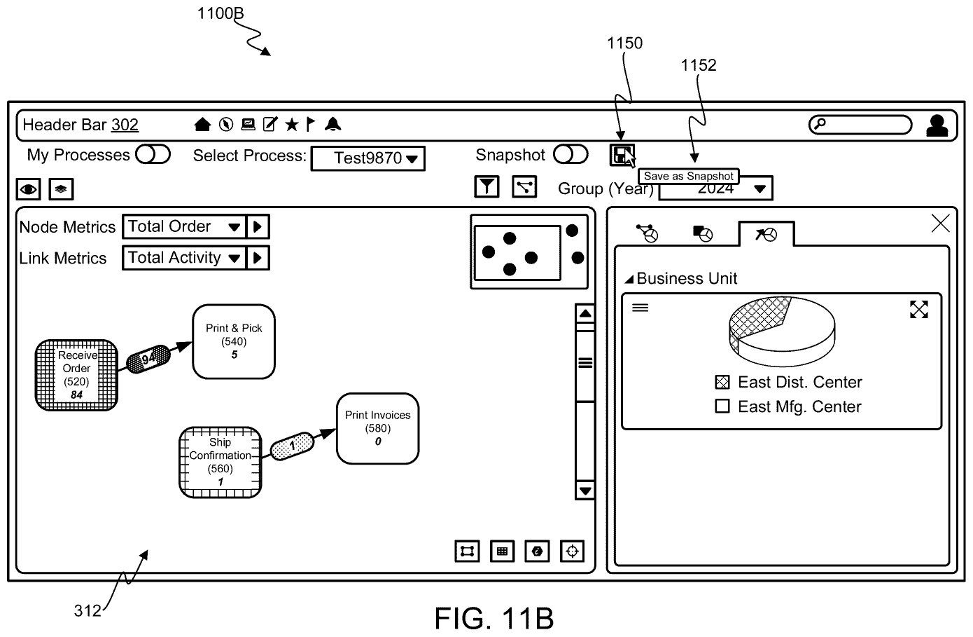

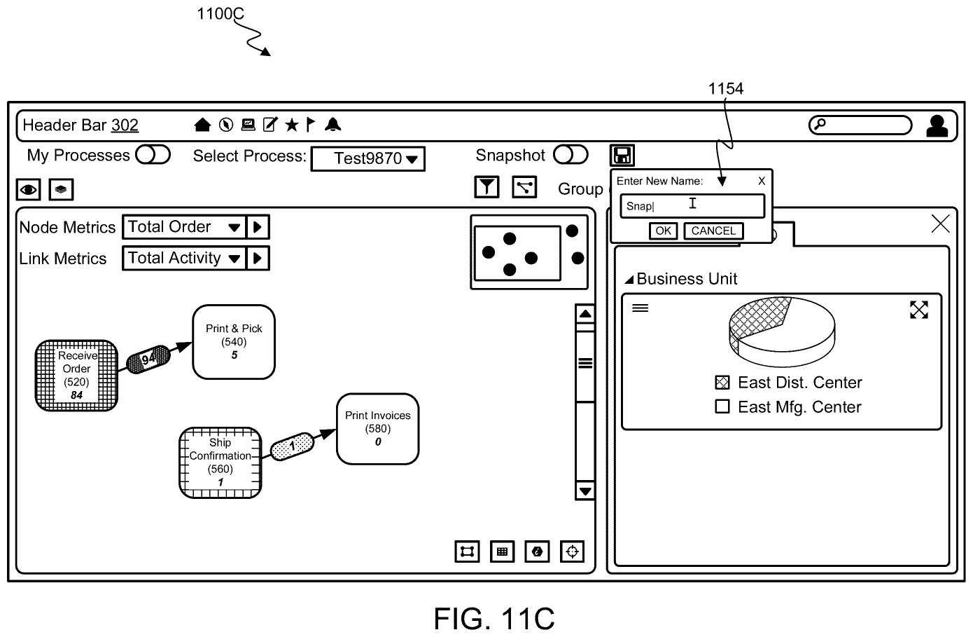

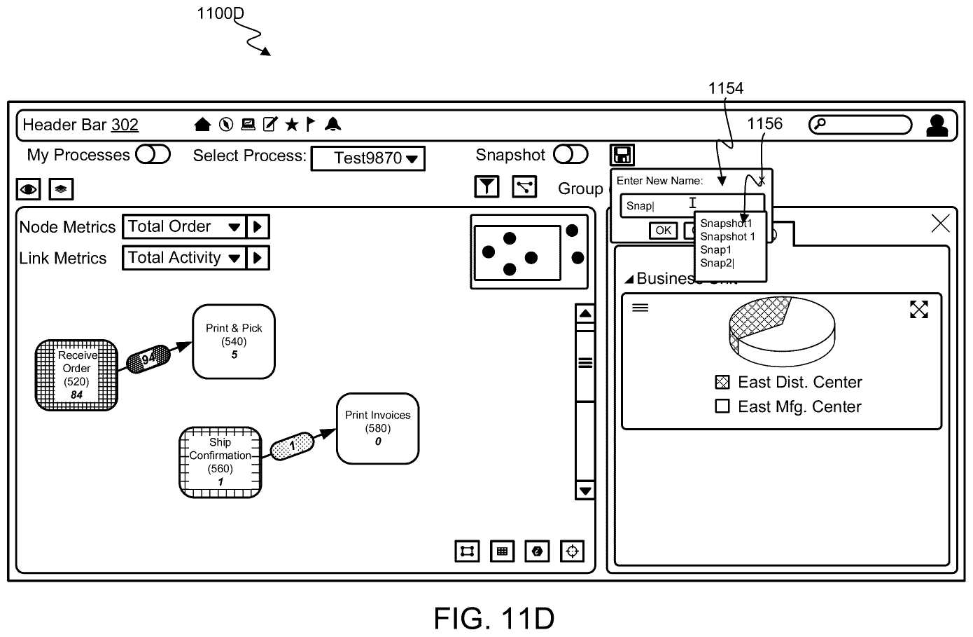

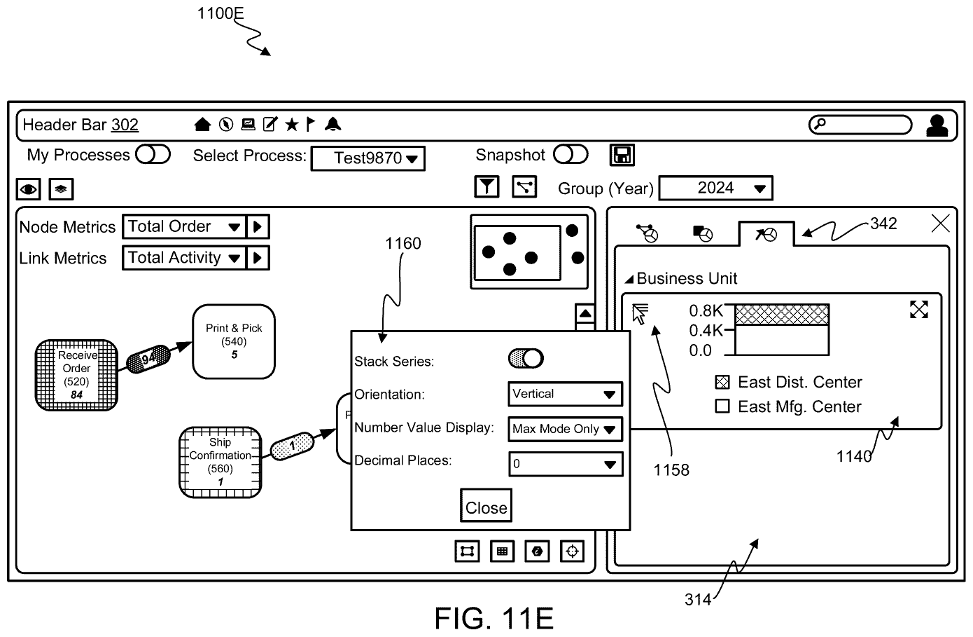

For a Bar chart, the data management system allows a selection of Orientation (Vertical or Horizontal) from the drop-down list. A vertical orientation is shown in FIG. 11E, and a horizontal orientation is shown at the bottom of FIG. 12C.

In the Configure window of the Process Analytics tab, the data management system provides an interface for making changes to the metric related fields such as: Threshold Amount, Threshold limit, or Alert Limit. These fields are available if they are enabled during the design time.

In one example, when configuring analytics, the data management system allows override of a default value in the Decimal Places field based on a selection of the Decrement or Increment icons (“∧” or “∨”) or based on entry of a value to set the number of decimal places for the numbers on the charts, as shown by entering “0” for “Decimal Places” in FIG. 11E. The Number Value drop-down list is selectable to override the example default value (Max Mode Only displays the numbers in the maximized mode but hides them in the embedded mode) to select Never or Always display numbers.

The colors on the charts are selectable or may be hovered over to analyze the details. The data management system allows changes to be made to the charts and node-specific analytic details to be analyzed and drilled into. Selection of a node may cause the data management system to show the node-specific analytics in the Node Analytics tab on the right, for example. In some embodiments, the data management system displays a People icon and a border to indicate that the node is selected, as shown for the selected link in FIG. 12D. The data management system displays a dashed border (with a “marching ants” effect) around the node when you hover over a selected node.

Link-specific analytics may be shown and/or modified on selection of a link in the interactive node graph. In one embodiment, the data management system displays a People icon and a border around the value of the link to indicate that the link is Selected, as shown in FIG. 12D. The data management system displays a dashed border (with a “marching ants” effect) around the value on the link when you hover over a selected node.

### Navigating Between Related Processes

A first process described by an interactive graph may be related to another second process described by another possible interactive graph. A first process may be related to a second process, for example, as a sub-process of the second process. A sub-process may be a process that, in total, acts as a step of the process above it. A sub-process may comprise multiple sub-steps that make up the sub-process.

Related processes may be associated within the user interface by recording a relationship between the processes. A first process may be associated with a second process by first selecting a step of the first process that comprises the second process. The selected step of the first process is then designated as a linked process step and a prompt may be displayed to indicate the other candidate processes that may be associated with the selected step as a related process. In response to the second process being selected as the related process for a selected step, the second process is recorded as a related process for the first process and an indication of the relationship's connection via the selected step is also recorded. When displaying the first process, the selected step may be displayed, such as by an alternate node display setting, so as to indicate that the step is related to another process. The method of display to indicate the selected step relates to another process may also indicate that the second process is the related process.

Related processes may be navigated within a user interface by changing the currently displayed graph to a related graph. Within the display of an interactive graph, a node connected to a related process may be selected to navigate to the connected process. A user may select a node connected to a related process, which may be indicated by a display setting of the node. Upon selection, a prompt may be displayed for navigating to the related process. In response to confirmation of the prompt by the user, the graph of the related process may be displayed in the user interface.

The user interface may also contain a region for depicting the connections between related processes. The region for depicting connections between related processes may depict, for example, each process as a node of a related process graph where edges of the graph represent connections between processes. An edge of the related process graph may be directional, where the direction of the edge indicates a parent-child relationship between related processes where a parent process is a process where a step of the parent process is related to an entire child process.

The related process graph may be depicted concurrently with the interactive graph. The related process graph may indicate, via a graph element display methods or settings, which node of the related process graph represents the currently displayed process in the interactive graph. The related process graph may further indicate, via graph element display methods or settings, which other processes are parent processes for the currently selected nodes. For example, a first node may be indicated as the current process by representation as a highlighted or emphasized node. A second node may be connected to the first node with a directional edge pointing from the second node to the first node, indicating the process represented by the second nodes is a parent related process to the current process. The directional edge between the first and second nodes may also be depicted as a solid edge line, indicating it to be a direct parent node, where an edge connecting from the second node to a third node, which is not connected to the first node, is depicted as a dashed edge line.

The related process graph may be used to navigate between connected processes. A user may select a node within the related process graph, and, in response, the user interface may display the associated interactive graph of the process represented by the selected node. As the interactive graph displayed is changed, the related process graph may also be updated to indicate the selected node of the related process graph as the currently displayed process in the interactive graph.

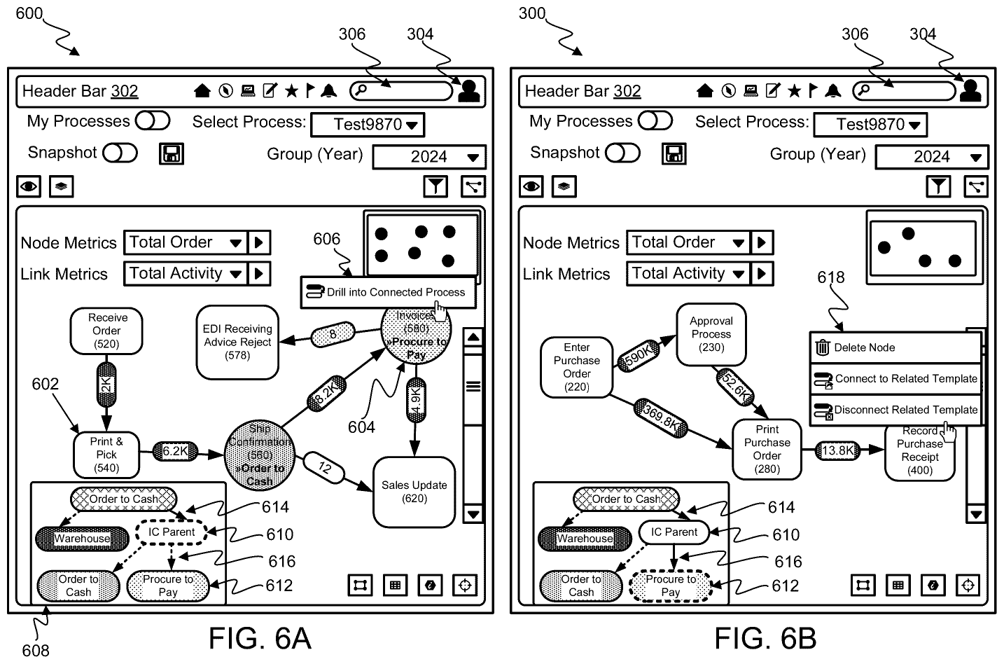

FIGS. 6A and 6B depict related interactive graphs displayed in a user interface 600. The interactive graph depicted in FIG. 6B relates to the interactive graph depicted in FIG. 6A via the node 604. The node 604 may be differentiated as being a related node by a different representation setting (e.g. shape) from an unrelated node 602. The related interactive graph of FIG. 6B may be navigated to by selecting the related node 604 and selecting a prompt 606 to navigate to the related graph.

The user interface 600 may also include a related process graph 608 depicting the family of related processes. The currently selected process 610 may be depicted in an alternate display method (e.g. dotted or emphasized shape) from another related process 612. The relationship between the selected process 610 and the related process 612 may be indicated by an edge 616. The edges 614 and 616 may indicate the ancestor relationship of other processes such as by indicating child or unrelated process relationships as dotted edges 616 and ancestor relationship as solid lines 614. A node within an interactive node graph may be selected to connect or disconnect a related process by a relationship connection prompt 618.

### Adjusting Filters for Snapshots, Live Views, and/or Animations

A metric display setting may define an aspect of the representation of graph elements variably based on a logical expression. An aspect of the representation of a graph element may be the graph element's color, shape, style, opacity, or other setting for visual display of the graph element. The metric display setting may define a logical statement, such as a Boolean statement, that, when true, causes the data management system to display the graph element of the associated metric value with the given setting for the aspect of the representation. For example, a metric display setting may define a range of values for the metric and a logical operator that define a logical expression for comparing the metric value to. The logical operator may be a mathematic equivalency or inequality relation such as a less-than operator. The value and the logical operator may be defined by a user along with the aspect of representation for display if the logical expression is true. In one example, a user may define a metric display setting for a style of edges of the graph where a logical expression defined by the user states that the color should be used if the value of the metric is less than or equal to 500. The data management system will then compare the metric value for each of the edges of the graph and display any of the edges whose metric value is less than or equal to 500 with the selected style.

A metric display setting may define whether or not an associated graph element is displayed. For example, a predefined Boolean statement may check whether the value of a given metric is zero. In the case that the value of the metric is zero, the metric display setting may cause the associated graph element to not be displayed in the graph. This setting may be pre-defined and selectable as a binary setting by a user as a means of detecting anomalous nodes or edges with zero values.

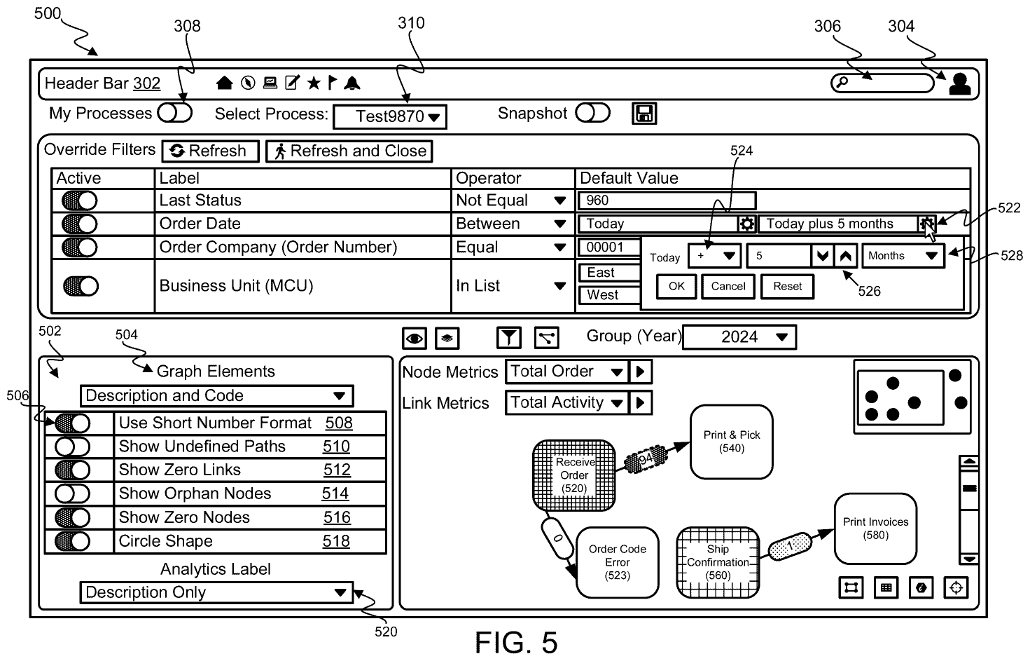

FIG. 5 depicts an example user interface 500 including an additional filters region 502. The additional filters region 502 may include a graph elements setting 504 for entering settings for display of graph elements depending on metric values. The graph element settings may each include a graph element settings toggle 506 to select or deselect the graph element setting. Example graph settings depicted in FIG. 5 include a short number format setting 508, an undefined paths setting 510, a zero links setting 512, an orphan nodes setting 514, a zero nodes setting 516, and a nodes shapes setting 518. A short number format setting 508 may toggle whether to display numbers for metrics with an abbreviated number format or an extended number format. An undefined paths setting 510 may toggle whether or not to show paths that are not represented in the rules. A zero links setting 512 may toggle whether to display graph edges where the associated metric value for the edge is zero. An orphan nodes setting 514 may toggle whether to depict nodes of the graph that do not connect to any other node of the graph. A zero nodes setting 516 may toggle whether to display nodes of the graph where the associated metric value for the node is zero. A nodes shapes setting 518 may toggle between alternate shapes of graph elements. The additional filters region 502 may also include an analytics label setting 520 for selecting the data to display in association with the metric and the corresponding graph element.

Multiple metric display setting for various aspects of the representation of graph elements may be defined for nodes or for edges of a graph. In one embodiment, the user interface may include a region for defining metric display settings for a given aspect of the representation of graph elements. The region may include an option to add new logical expressions and to define a representation mode for that logical expression. The region may also include a selection for user input to select from a set of pre-defined logical operators, such as mathematical symbols, and an associated number entry selection for user input to define a value for comparison using the selected logical operator. The region may include one or more of the above user input selections such that the user may define a multiple range equivalency statement. For example, a user may define a first logical expression defines a first numerical range where a first representation mode is to be used, a second logical expression defines a second numerical range where a second representation mode is to be used, and a third numerical range is defined by the range of possible numbers outside the first and second numerical ranges where a third representation mode is to be used, which may be a default representation mode.

When a metric display setting is defined or selected by a user, the metric display setting may be stored for future display of the graph. A metric display setting may be stored in association with a user's credentials such that the graph is displayed using the same metric display settings for the user each time when viewing the graph. A metric display setting may also be stored in association with the metric it is defined for. In this way, when a user selects a metric for display, the previously defined metric display settings may be loaded and used to display the metric selected.

A metric display setting may be conditional to a specified condition existing within the graph or user interface before displaying the metric with the specific metric display setting. A condition may depend on the current viewable area of the user interface such that the metric is not displayed if a part or the whole of the associated graph element is not currently visible within the user interface.

A condition may also depend on the current user input or selection. For example, a metric may not be displayed unless the user has selected a graph element associated with the metric. In this example, selecting a graph element may be performed by clicking on the graph element, hovering over the graph element, or otherwise indicating one or more specific graph elements to be in focus for the user interface. In some embodiments, a set of other metrics that are not a currently selected metric for display with the graph may have a metric display setting defined such that the metrics for a given node or edge may display all of the metric values for the set of other metrics for the given node or edge when the user hovers a cursor over the given node or edge.

Referring back to FIG. 3, the user interface may depict a node 332 or a link 334 with a currently selected metric based on the metric display settings 324-330. A separate metric display setting may be defined such that additional metrics beyond the selected metric may be displayed for a graph element when the user hovers a cursor over the graph element. The user interface 300 may detect a user's cursor hovering over the link 334, and in response accesses the separate metric display setting to determine if an additional metric display 338 should be displayed. Based on the separate metric display setting, the additional metric display 338 is populated with the additional metrics for display determined by the separate metric display setting. The additional metric display 338 may include, for example, all the metric values for the graph element currently hovered over that may be selected in the metric selection 328. Additionally, the additional metric display 338 may differentiate the currently selected metric value from the additional metrics displayed.

When a new metric selection is made, when an update is detected for a metric value, or when a change is made to a metric display setting, the display of the graph may be updated in whole or in part. The data management system may generate an update flag for each setting or value update. The update flag may be recognized by a display configuration system for handling the updating of display to the user. In response to the update flag, the display configuration system may generate an updated display of the user interface including the updated setting or value. The updated display of the user interface is then made to be displayed to the user in the user interface.

Metrics displayed concurrently with the graph may be calculated using a limited data set by applying one or more filters to the data of the table or ledger. The one or more filters may be a condition or range of values for a given domain of the data, used as a filtering domain, the values of which are compared to the condition or range to determine if a given record of the data is to be included in the limited data set. For example, a filter may limit a current metric calculation to only records or entries where an organization unit value is equal to a specific organization unit.

When determining if a record of the table or ledger is restricted by the filter or not, a corresponding value within the record may be compared with the filter. The filter may designate a comparison domain of the table or ledger for comparison to and a filter condition. The filter condition may be a value, in which case the filter is applied by checking, for each record, the value of the comparison domain and comparing if the value is equivalent to the filter's value. The filter condition may also be a logical statement, comprising a logical operator and a value. The logical operator may be a mathematic equivalency or inequality relation such as a less-than operator. The value and the logical operator may be defined by a user along with the aspect of representation for display if the logical expression is true. To implement the filter in this case, for each record, the value of the comparison domain is compared to the filter value by comparison of the logical operator to determine if the logical expression is true for the record's comparison value. In either case, if the comparison value is determined to satisfy the filter, the corresponding record may be included in the limited data set.

When a record is determined to satisfy the filter and is included in the limited data set, the record may be copied to a separate data storage that records the limited data set. To implement this process, the comparison for applying the filter may be performed by an aggregation statement on the table or ledger. For example, a SQL aggregation statement such as a SQL SELECT statement may be performed on the table or ledger, including the limitation of the filter as a clause such as a SQL WHERE clause. The SQL SELECT statement may be a same SQL SELECT statement used in an aggregation statement to apply the metric before the filter was applied or defined.

Alternatively, when a record may be determined to satisfy the filter and be included in the limited data set as the data management system is calculating a running total for the metric by parsing the table or ledger. The records of the table or ledger, or an aggregated set of records aggregated for the metric in question, may be parsed to determine the metric by performing a calculation at each record and storing a running total that is modified by the results of the calculation at each record. The filter may be applied as a step prior to performing the calculation for any given record when parsing through the records such that the filter is checked and the calculation is performed only if the comparison value of the record satisfied the filter. In this way, the filter may be applied to locally stored versions of the records parsed without performing a separate data request to the database.

FIG. 4 depicts an example user interface 400 for displaying an interactive graph and filtering metrics depicted with the graph. The user interface 400 may include a filters selection region 402. The filters selection region 402 may include filter control settings 404-406, which may control the display of the interactive graph and associated metrics when altering filters such as to re-display of the graph when a filter has been changed. A filter may include a filter toggle 408 for activating or deactivating the filter. Each filter may also include a label 410 for identifying a value of the table or ledger on which to filter the data for the metrics. The filter may also include an operator selection 412 for selecting by the user a logical operator to use in determining if the logical statement of the filter is satisfied. The operator 412 may be an inequality (e.g. between, not equal) or an equality statement (e.g. equal to, contains, or in list). The filter may also include a value selection 414 for selecting a value by which to compare the value in the data via the operator 412. The value selection 414 may include a specialty selection operation 420 specific to the type of value to be selected. For example, the specialty selection operation 420 that is depicted in FIG. 4 relates to a date value and opens a calendar date selector 422. An alternate date selector 522 is depicted in FIG. 5 where the end date of a range may be selected dependent on the beginning of the date range by selecting a numerical operation 542, a delta 526, and a unit for the delta 528.

Another filter may be applied to limit the data for calculating metrics to a given time period. A time code may be included as a domain within the table or ledger that records a time where a status change is made. When a time period filter is selected, the time code for each record may be compared to the time period to determine if the time code is within the time period. If the time code is within the time period, the record for that time code may be included in the limited data set.

Depending on the metric to calculate, a record may be considered to be included or excluded from a time period if that record existed at a given status prior to the time period's beginning. For example, for a metric that details the total number of items that have touched a given node or edge, a time period filter is inclusive of records that were already at a given status at the beginning of the time period. For such a metric, the filter condition may be said to be a logical OR operation between records with a time code within the time period and records that are a most recent record prior to the beginning of the time period. A second operation may be performed in applying the filter to determine if a record in question is the most recent record prior to the beginning of the time period. This may be performed by parsing the records for corresponding records or records of the same item for different status updates, to determine the most recent record to the beginning of the time period. This process may be performed separately such that the parsing of records to determine the most recent record may only be performed once per item of the set of records.

In one example, the data management system allows the node graph to be further analyzed by applying filters configurable using the Show Filter Options element (indicated by a funnel) above the model pane. The system displays a pane above the model pane with filter options based on the template, and some fields may be read-only.

Various figures show filter criteria being added or modified to change the data shown in the node graph visualization, such as FIGS. 4-5 and 15-16. Filter criteria are shown that can be enabled or disabled, and different colors may be assigned to data that satisfies different filter criteria. For example, a filter for a first division may be marked in blue, and a filter for a second division may be marked in green.

The Active field, when selected, indicates that the filter is applied and not skipped. The Operator drop-down list is selectable to display the operator value. In various embodiments, the data management system uses the following filter operator values for the data types:
For Numbers: =, !=, <, >, <=, >=, between, and in list.
For Strings: equal, not equal, greater than, greater equal, less than, less equal, contains, starts with, ends with, is blank, is not blank, between, and in list.
For Dates: =, !=, <, >, <=, >=, between, and is blank and is not blank.
For UTIMEs: =, !=, <, >, <=, and >=.

In one example, the “is blank” and “is not blank” operators do not use an additional value in the way that the comparison or between operators do.

The data management system allows for list editing for the “in list” operator (system supports tab key, auto-clean empty entries, keep at least one entry). In one embodiment, when an entry is typed, the data management system automatically appends a new empty input as a new last entry to allow additional entries to be added.

In various embodiments, the data management system supports the following calendar and special value controls:
The Calendar icon may be selected and a target date further selected from the calendar window. For example, the target date may be selected as Jan. 1, 2024.
The Configure icon may be selected and a special date format, such as a relative date format, may be specified. For example, the date format may be indicated as a distance relative to a particular day, such as “Today minus 5 months.”

Refreshed results may be viewed on the node graph visualization and extended visualizations tab, with updated filters applied, from within the filter options pane using the Refresh or Refresh and Close options (to also close the filter options pane).

### Configuring and Saving Snapshots of Process States

FIG. 1C illustrates a flow chart of an example process 100C that saves a snapshot from a live data source that allows an interactive node graph of process states to be generated from the snapshot without further access to the live data source. In block 102C, the data management system generates an interactive node graph having nodes that represent process states and edges that represent connections between process states. In block 104C, the data management system uses a first live metric for determining aggregated node value(s) and/or a second live metric for determining aggregated edge value(s). In block 106C, the data management system causes display of an interactive node graph based on the aggregated node value(s) and/or the aggregated edge value(s). In block 108C, the data management system causes display of an option to save the interactive node graph. In block 110C, the data management system receives a selection of the option to save the interactive node graph as of a particular time. In block 112C, based at least in part on the selection of the option, the data management system stores a snapshot including the aggregated node value(s) based on the first live metric as of the particular time, the aggregated edge value(s) based on the second live metric as of the particular time, a first mapping between the first live metric and node(s), and a second mapping between the second live metric and edge(s). In block 114C, the stored snapshot may be used to load the interactive node graph for display without access to the first live metric and/or the second live metric.

Once a node graph user interface is configured with one or more data sources, one or more groups, zero or more filters, and one or more visualizations (including one or more node graph visualizations and zero or more side visualizations), the configuration of the node graph user interface may be saved as a snapshot along with values based at least in part on the one or more live data sources as they existed at the time the snapshot was initially taken or saved. A snapshot may be taken for current data as the data exists from data source(s) at a current time, and/or from historical data as the data existed as of data source(s) approximated at a historical time based on data that exists at a current time and/or other time(s) for which snapshots already exist. The timestamps of data used to generate the current snapshot and/or the timestamp representing an as-of time for the snapshot may be saved in association with the snapshot and optionally displayed in association with the snapshot to indicate what data is represented by the snapshot.

A snapshot may save values that include raw values and/or aggregated values (optionally without the raw values) of the live data source(s) or simulated data source(s) based on other snapshot(s), and the saved values may be persisted as snapshot data source values. The saved data values may cover data shown in a saved view of the node graph visualization and also data not shown in the saved view of the node graph visualization. The node graph visualization may be modified to view different subsets of the saved data even after the snapshot is taken. The snapshot may be re-loaded later by finding or selecting the saved snapshot, determining which snapshot data source value(s) are used by the snapshot, and/or which filter(s), grouping(s), and/or visualization(s) or visualization setting(s) apply to the saved snapshot, and loading the node graph(s) on the node graph user interface corresponding to the data source.

Once a snapshot is stored, the snapshot may be re-loaded without accessing the live metric(s) that were used to generate the snapshot. Instead, the snapshot is re-loaded based on information saved in association with the snapshot, such as node and/or edge values that were aggregated for the snapshot as of a certain time, and/or mappings that indicate which node and/or edge values were shown on the node graph for given data slices when the node graph was saved. The snapshot may include additional information about which part(s) of the node graph were visible according to a location of a view window in a mini-map. The snapshot may also include information about which extended visualizations were visible for which node(s), edge(s), and/or for the node graph as a whole, the metric(s) covered by the extended visualizations, and/or any visualization configurations for the extended visualizations. The saved snapshot may also include information about selected group(s) or dataset(s), group(s) or datasets de-selected for visualization, dimension(s) grouped, grouping type(s) selected for the node graph and group(s) available according to the grouping type(s), group order(s), threshold(s) for graphical distinctions relating to node(s), edge(s), or to the node graph as a whole, and/or any other information about selection(s) or setting(s) made in the user interface.

The data saved or the snapshot is accessible when the snapshot is re-loaded even if the data was not in view on the snapshot at a time when the snapshot is saved. Saved settings applicable to non-viewed data may be applied when the data becomes viewed as the node graph is interacted with after re-loading the node graph from the saved snapshot. For example, group(s) not shown in the node graph region may be selected and shown in the node graph region after the snapshot is reloaded. The different group(s) may show different node(s), different edge(s), different aggregate value(s) for the node(s) or edge(s), different extended visualization(s), different corresponding threshold(s) for graphical distinctions on the node(s) or edge(s), etc. As another example, non-fixed filter criteria may be changed to access a larger saved snapshot dataset that included data where the non-fixed filter criteria were not applied. As yet another example, thresholds for graphical distinctions on the node graph may be adjusted to change the way the node graph appears. As another example, the fields used or selected to be shown as node metric(s) and/or edge metric(s) may be modified after the node graph is re-loaded, changing the data shown on the node graph. As another example, the snapshot may include information about different visualization(s) visible for different edge(s), node(s), or for the graph as a whole for different group(s) when the different group(s) are selected, even if some of the groups are not shown in a default view of the node graph in node graph region as saved. In this manner, the node graph loaded according to the snapshot is interactive based on snapshot data even though the node graph no longer needs to access the live data source.

Any data that is saved in a snapshot for a single node graph may also be saved for multiple node graphs if the multiple node graphs are shown side-by-side or merged in the snapshot. Additional information may also be stored for side-by-side or merged node graphs, including settings for graphically labeling differences or similarities between the node graphs, thresholds or settings for how different or similar features of the node graphs would be before being labeled as different or similar, and settings regarding a common control pane and whether the node graphs have separately selectable groups or synchronized group selection.

The live metrics may be updated before the snapshot is saved, and the updates to the live metrics may be included in the saved snapshot. Once the snapshot is saved, and continuing after the snapshot is re-loaded, the live metrics may be updated at a data source of the live metrics, but the snapshot may be loaded from the snapshot data source without access to updates to the live data source. In this manner, the snapshot data source may be immutable with respect to the live data source, depending on the configuration of the data management system. This allows the snapshot to remain in a more fixed form suitable for presentation or analysis without having underlying data values changing as the data is being analyzed unless the node graph configuration settings are updated.

FIGS. 11A-11E illustrate example diagrams of interfaces for configuring and saving a snapshot of a node graph. FIG. 11A shows interface 1100A where a data source relating to an example process Test9870, as indicated by process selector 310, is loaded. The data is grouped using group selector 322 into 2024 data, and the node graph shown in node graph region 312 includes nodes 1132s and edges 1134s, where node metrics 324 are selected as “Total Order” and link metrics 326 are selected as “Total Activity”. As shown, the selected metrics show up in bolded italicized marking on the nodes and links, respectively. FIG. 11B shows interface 1100B where a cursor is moved to a save as snapshot button 1150 for saving the data used to generate the node graph in node graph region 312. As shown, a dialog box 1152 appears to indicate the button is for saving the data as a snapshot. FIG. 11C shows a snapshot save field for entering a snapshot name in a snapshot save box 1154. As shown, partial user input has been received to begin typing a snapshot name. FIG. 11D shows an example type ahead prompt 1156 for displaying optional selections of existing snapshots that match or partially match the partial user input received in snapshot save box 1154.

FIG. 11E shows an example configuration of an extended visualization in region 1140 as part of data to be saved as a snapshot. The configuration panel 1160 may include an adjustment to whether the series is stacked, to an orientation (vertical or horizontal), number value display, and/or decimal places to show for the extended visualization. The configuration panel 1160 may appear based on a selection of configuration option 1158 on the extended visualization in region 1140. When a snapshot is saved, the saved snapshot may also include visualization configuration options for visualizations specific to nodes and/or edges of the node graph visualization, and/or generic to the process shown in the node graph visualization (or based on multiple nodes and/or edges). Upon loading the snapshot, the visualization configuration options may also be loaded so that extended visualizations appear consistently according to pre-configured settings before the snapshot was saved.

FIGS. 12A-12K illustrate example diagrams of interfaces for loading and analyzing snapshots. As shown, in a summary visualization region 1266, a view by selector 1250 is available for selecting a dimension on which to separate slices of data for visualizing with the node graph in region 312. In the example, “Date” is selected as the dimension. A grouping type selector 1252 is provided for selecting a grouping type for the dimension on which to split slices of data for visualizing with the node graph in region 312 and for summarizing the slices of data with different graphical indications 1260s in summary visualization region 1266. Media controls 1256s are provided for controlling playback of an animation of the node graph to cycle through data slices represented by the groups depicted by the different graphical indications 1260s. The media controls 1256s include a play button 1254 for starting playback of an animation and a reset button 1258. As shown, current group selector 1262 indicates which graphical indication of graphical indications 1260s is selected, indicating which group is shown in the node graph of node graph region 312. As shown, the 2024 group is selected for showing in node graph region 312. In the three-panel view of FIG. 12A, an example extended visualization region 314 is also shown on the right side.

Also as shown in FIG. 12A, a snapshot toggle 1268 is toggled to “on,” indicating that a snapshot is being viewed, and the snapshot being viewed is indicated as Snapshot1 in snapshot selector 1270A with a timestamp of Jun. 28, 2024, indicated by timestamp 1272. FIG. 12A also provides options 1280s for saving, opening, or deleting a snapshot.

FIG. 12B shows a modification of which snapshot is being shown using dropdown 1270B. FIG. 12C shows Snap2 as the selected snapshot of snapshot selector 1270C. As shown, Snap2 has an updated timestamp 1274 of Mar. 28, 2024, indicating that the two snapshots of FIG. 12A and FIG. 12C were taken at different times. Also as shown, the summary visualization elements in summary visualization region 1266 have been updated, as well as the node graph in node graph region 312 and the extended visualizations in extended visualization region 314. Unlike the pie chart of FIG. 12A and Snapshot1, Snap2 of FIG. 12C is loaded with a horizontal chart 1276 and a vertical chart 1278.

FIG. 12D shows that the example snapshot of FIG. 12A may be interacted with, for example by selecting an edge 1234 to show additional aggregate metrics associated with the edge in overlaid metric information box 1238. Although the total activity metric is shown on the edge in node graph, the total ship information of 166 is shown in overlaid metric information box 1238 but not directly on edge 1234 in the node graph itself.

FIG. 12E shows further interaction with the node graph and node graph summary region 1266 for a snapshot. As shown in FIG. 12E, a different graphical element of graphical elements 1260s has been selected, and the node graph in node graph region 312 has been updated to show node and edge data corresponding to the selected 2020 group. The Group selector 322 is also correspondingly updated to match the selection of the different graphical element of graphical elements 1260s.

FIG. 12F shows further interaction with the node graph region 312 for a snapshot. As shown, a field selected for viewing with the link metrics 326 is being changed to “Total Ship” via activated dropdown menu 1226. As shown in FIG. 12G, the change may cause updates in node graph summary region 1266, node graph region 312, and/or extended visualization region 314. In the example, changes are shown in regions 1266 and 312.

FIG. 12H shows further interaction with the changed node graph via further interactions in node graph summary region 1266. As shown, a mouseover action causes display of an overlay box 1284 including total ship information for a 2019 group that is not currently the group shown in node graph region 312. Also as shown, the mouseover action causes a highlighting or marking 1282 of the graphical element for 2019 for which the additional information is being shown.

FIG. 12I shows further interaction with the snapshot via filters region 1286. As shown, filters region includes an indication of whether a current filter is active or not, a label of “Date Updated” for the current filter, and an operator of “Between” with values selected of “Today minus 11 years” and “Today.” In other words, the currently active filter filters out process state data that is not within the past 11 years. The filter may be toggled on or off using the toggle in the Active column of filter region 1284. Updates in filter region 1284 cause corresponding updates to the node graph in node graph region 312.

FIG. 12J shows further interaction with the snapshot via updated metric thresholds in metric threshold region 1286. As shown, metric thresholds are configured to show certain colors or graphics for certain ranges of values for nodes and edges, and the node graph is updated accordingly in node graph region 312.

FIG. 12K shows an example interaction with node graph summary region 1266 where a group of data from a certain source or associated with edges or nodes is shown, corresponding to “Main,” and other groups of data from other sources or associated with other edges or nodes is not shown, as indicated by the activated select metrics icon 1288 and inactivated select metrics icons 1290s. The inactivated select metrics icons may be shown in different colors or graphical indications from the activated select metrics icons, such that selection of corresponding groups of data causes only the activated selected metrics to be shown and not the inactivated (deselected) metrics.

In one example, if the snapshot includes aggregated values without the underlying raw values, the snapshot may be loaded without re-computation of the aggregated values but also without a drill-down into individual occurrences that contributed to the aggregated values. In another example, if the snapshot includes aggregated values and a copy of the underlying raw values, the snapshot may consume more memory but may also be loaded without re-computation of the aggregated values. In this example, a drill-down may be done into individual occurrences that contributed to the aggregated values using the copy of the underlying raw values.

The snapshot may cover a variety of dimensional members of the dataset, such as a variety of members of the time dimension. For example, the snapshot may cover multiple years, quarters, months, weeks, or days of data, and the node graph visualization may allow the data to be visualized on smaller units of the dimension, such as individual years, quarters, months, weeks, or days.

The user interface may include an option to switch between viewing a snapshot, viewing other snapshots, and/or viewing real-time data. For example, the snapshots may be selected using a drop-down list of available snapshots, and the real-time data or snapshot may be toggled on or off to indicate whether snapshot mode is toggled on or real-time data mode is toggled on.

In various embodiments, as different dimensional members of the dataset are selected, different process states relevant to or present in the snapshot data values for the selected dimensional members are displayed on the screen. Process states that have zero occurrences in the selected dimensional members may be displayed as having zero occurrences, grayed out, or not displayed at all. In this manner, the shape of the node graph visualization may change as different dimensional members of the dataset are selected, resulting in different nodes corresponding to different process states that occur for the selected dimensional members, and/or resulting in different edges between nodes that occur as transitions between different process states for the different dimensional members of the dataset that are selected.

The flexibility to change views of the persisted data set is included as part of the snapshot. In another example, the node graph visualization may allow different node metric(s) and/or different edge (“link”) metric(s) to be selected while the snapshot is being viewed, analyzed, or interacted with. As the node metric(s) and/or edge metric(s) are changed, the data represented by the node(s) and/or edge(s) visualized in the node graph visualization also change. For example, the node metric(s) may change to show different values from different fields, and/or different quantities or counts, sums, derived values, or other aggregate data associated with a process state represented by the corresponding node(s). As another example, edge metric(s) may change to show different values from different fields, and/or different quantities or counts, sums, derived values, or other aggregate data associated with a transition between process states represented by the corresponding edge(s). Changes to node metric(s) and/or link metric(s) may be made for the entire node graph visualization and/or for individual nodes, edges, regions or sub-graphs of the node graph visualization. In this manner, snapshots retain flexibility to change which metric(s) may be viewed in the node graph visualization for a snapshot, even after the snapshot has been taken and saved, and without revisiting the live data.

In addition or alternative to changing the metric(s) in view on the node graph visualization, the user interface may also provide option(s) for configuring threshold value(s) to use for changing the way different value(s) of the selected metric(s) are displayed in the node graph visualization. For example, the option(s) may allow threshold values to be set for green colors, gray colors, yellow colors, orange colors, and/or red colors to visually indicate, on the node graph visualization, which values are labeled as good or positive (e.g., beyond or within threshold values for green), medium (e.g., between positive threshold values and negative threshold values), or bad or negative values (e.g., beyond threshold values for yellow, orange, or red). The option(s) allow user configuration for the threshold value(s) to change for different metric(s), and the threshold value(s) corresponding to the given metric(s) may be recalled from storage in association with the snapshot, when the metric is selected for display in the node graph visualization. In this manner, threshold value(s) for metrics may be saved, and the user interface switches between displaying different metrics using different thresholds that are specially configured for the corresponding different metrics.

The metric(s) to be shown as well as the threshold(s) to use for visualizing different metric(s), whether shown or not shown, may be saved as part of the snapshot. In this manner, even if the snapshot is closed and re-opened, the threshold values specially configured for different metrics may remain specially configured as the metrics are selected for display or not selected for display.

In one embodiment, a snapshot taken at an individual point in time is immutable in the sense that the snapshot does not change if the live data sources continue to change. In other words, the snapshot is protected from any change. In another embodiment, the snapshot may be immutable in the sense that the snapshot is unimpacted by changes to the live data sources from which the snapshot was taken even though the snapshot may be changed directly by editing the persisted snapshot data source values that exist and may be stored separately from the live data sources. Additionally or alternatively, filters or visualizations may also be modified and optionally saved for the snapshot. In one example, a user may modify aggregated values, further refine filter settings (e.g., by adding limitations), or other information associated with the snapshot separately from ongoing changes being made to the live data sources from which the aggregated values were initially determined. In this embodiment, although some changes are allowed, the snapshot is still protected from any changes that would otherwise occur due to changes in data from the live data sources, such as updated averages due to changes that may be occurring day-by-day, hour-by-hour, or at any regular or irregular frequency.

If one or more filters were applied when a snapshot was taken, the one or more filters serve to limit the data included in or represented by the snapshot data source values. In one embodiment, the filters are fixed to define the data included in the snapshot. In another embodiment, the filters may be further refined by further limiting the data to be included in the snapshot. For example, divisions, regions, years, or other dimension members may be filtered out while keeping a remainder of the data otherwise originally included in the snapshot. The further filtered data may be visualized, analyzed, or otherwise viewed. The further filtered data may even be saved as a new snapshot with a new set of baseline data that results from the filters and further filters, and the new set of baseline data may be filtered even further.

In one example, a snapshot may be taken for a prior year's, quarter's, or month's data, and the snapshot may be used in an interactive report that allows the data to be visualized and interacted with, embedded in a PowerPoint presentation or other visualization (for example, as web page content, interactive video content, interactive image content, or other content), or otherwise relied upon without having the data represented by the snapshot change unexpectedly and result in a changed reality during interaction with the report, presentation, visualization, or other use case.

In one embodiment, a snapshot may be generated retroactively for a certain time in the past by simulating what data values may have existed as of a certain time based on other snapshot(s) that exist before and/or after that certain time. For example, one or more past snapshots may be used to determine trend(s) to the certain time before or after the past snapshot(s). For example, a trend may be determined between two prior snapshots by applying an average, weighted average, or other aggregation or weighted aggregation between the two prior snapshots. As another example, a single snapshot from a specific time in the past that includes data values covering a variety of slices of a time dimension may be used to simulate what the data values might be at a time slice before or after the specific time, for example, using time series analysis and/or applying trends or predictive analytics to a time series of each set of values that changes over time. In a particular example, the predictive analytics may account for data dependencies and correlations present and consistent in the dataset over time. In another example, the data management system may track individual items, orders, or other entities that traverse a process state graph and predict or reverse state transitions to go forward or backward in time from past snapshot(s), based on historical state transitions that have occurred over similar or analogous periods of time.

In yet another example, the simulation of past data values may be done based on live data based at least in part on what data appears to have been generated and accessible at different times. For example, the live data may be adjusted to remove data generated after a certain point in time to simulate what the data would have looked like as of another certain point in time. Such simulation might not determine for certainty what the data would have looked like as of the other certain point in time, as data values from the past may have been changed later in the live dataset as corrections or updates were made to the live dataset over time.

The data management system may generate a confidence score for predicted or reversed state transitions based on how closely the predicted or reversed state transitions match existing sets of data and how much prediction was needed. For example, predicted scores may receive a lower confidence score if they are distant from any existing snapshot and/or if the existing snapshot did not have a complete set of analogous values from which a prediction could be made. If the prior snapshot has a partially overlapping subset of fields with the subset of fields used for the predicted snapshot, the overlapping fields may have higher confidence than the non-overlapping fields. The data management system may store confidence scores as metadata for the predicted values.

In some embodiments, an existing snapshot or live set of data may be used to generate a what-if scenario for a specified future time. In these embodiments, future process states for the specified future time may be determined by traversing process states according to historical process state transitions that have occurred, as well as ingesting new data according to historical data that has been ingested into the data management system, optionally accounting for trends, detected time series signatures or partial signatures, or other patterns. For example, if 30% of occurrences historically transition from process state A to process state B in a day and 70% of occurrences historically transition from process state A to process state C in a day, the what-if scenario for a following day may simulate the transition of 30% to process state B and 70% to process state C, as well as any other process states or other data that may transition into process state A based on historical patterns. In another embodiment, the data management system provides an interface to configure a what-if scenario by specifying which quantities or amounts may hypothetically transition between which process states over a period of time, and the data management system simulates process states at future times that may be further away than the period of time, closer than the period of time, or spaced equally to the period of time, based on simulating state transitions according to the configured what-if scenario.

One or more side visualizations may be configured to be displayed concurrently with the node graph visualization, with certain metric(s) or metric combination(s) displayed for the node graph visualization, or with certain dimensional members selected for the node graph visualization. The side visualization(s) may also be saved as part of the snapshot such that different side visualizations may appear with different views of data and/or metrics, as pre-configured, such that the different side visualizations appear when the snapshot is loaded depending on which data and/or metric(s) are in view, and such that the side visualizations change as the node graph visualization is interacted with to change the views of data and/or metrics shown. For example, one side visualization may include a bar chart of total items or entities represented in the node graph visualization that have “complete” states (e.g., indicating that the entities are no longer traversing process states) versus total items or entities represented in the node graph visualization that have “incomplete” states (e.g., indicating that the entities are still traversing process states).

In various embodiments, the data management system allows a user to view a historical snapshot of what the business process looked like at a particular time, with aggregated values determined as of a moment corresponding to the particular time.

Evaluating the health of business processes is useful in an enterprise resource planning (ERP) setting, but the evaluation is even more useful if the analysis can be performed relative to certain times. Such analysis can be performed either to assess a failure or to analyze what has historically happened at a critical moment such as end of quarter or around a significant event, etc.

The data management system allows for a snapshot view of a particular moment in the past in a variety of modes. In one mode, a user can explicitly save a snapshot at a moment in time, which may include writing the current counts of nodes in specific statuses and any other relevant aggregations or other metrics, external data points, etc. to a saved snapshot table. This can be initiated manually, or saving the snapshot can be triggered by on a schedule or by evaluating a more complicated rule/criteria.

In another mode, a snapshot can be reconstructed retroactively using a ledger or transaction table, provided the ledger table captures adequate data.

In another mode, multiple snapshots can be combined and aggregated together. For instance, a company could aggregate and display a combined snapshot for December 15 on each of the last five years.

In another mode, the data management system is also able to compare and contrast two or more snapshots.

In one embodiment, comparing and contrasting two or more snapshots includes viewing two or more process models/diagrams or other interactive node graphs side by side. In another embodiment, comparing and contrasting two or more snapshots includes graphing or otherwise comparing specific metrics across multiple snapshots. For example, the data management system can generate a plot of the number of records or total dollar amount of records at a user-selected status X in a time plot with data points for each of a series of snapshots.

The data management system is able to capture and save a full representation of the state of a business process, including instance states, transition counts, and other metrics. The saved representation may be loaded and used to render the saved representation as an interactive node graph for future analysis.

The state may be captured and saved by manual kick-off, for example, in response to user input. Additionally or alternatively, the state may be captured and saved on a user-defined schedule, based on a user-defined set of rules/criteria which are evaluated on a schedule, and/or based on a user-defined set of rules/criteria which are evaluated based on the occurrence of a triggering event.

In one embodiment, a snapshot is constructed at least in part by reading a ledger or other transactional table and using that ledger data to reconstruct what the state of the business process was at a particular point in time. The reconstructed state or an aggregation of reconstructed states may be saved for future analysis without requiring reconstruction.

In one embodiment, the data management system loads a set of 2 or more snapshots and performs aggregation over them to determine a combined snapshot.

In another embodiment, the data management system loads two or more snapshots and renders them next to each other, optionally including graphical highlighting/emphasizing of similarities and/or differences.

In one embodiment, the data management system loads two or more snapshots and renders a visualization of a time-based trend over one or more saved metrics.

The ability to see snapshots in time allows for evaluating trends over time and especially evaluating what effect changes made to a business process have had on the health/efficiency/effectiveness of the process.

There are various modes for retroactive creation of a snapshot. In one mode, the ledger data is presumed to go back to “the start of time.” The ledger data does not actually need to go back to the very beginning of time, but the notion is that all state counts begin at zero in a virtual model of the process that is then played forward through time by executing and evaluating each ledger entry against the model as if it were a new ERP transaction rather than a record of a historical one. By executing these transactions against the virtual model up until the snapshot date, the data management system then captures a representation or snapshot of the business process at that point in time.

In one variation of this mode, rather than initializing the model with zero counts at the start of the ledger, the data management system initializes the counts based on a previously saved snapshot. The data management system then plays forward or executes ledger activities that happened since the snapshot to create another snapshot. For example, if the data management system had access to a Sep. 1, 2019 snapshot but did not have access to an Oct. 1, 2019 snapshot, the data management system could use this method to combine the Sep. 1, 2019 snapshot and the ledger to create a Oct. 1, 2019 snapshot. In some examples, this variation has the advantage of being more accurate and more efficient than starting from zero and executing the entire ledger if sufficient data is available.

In another mode, rather than start at an arbitrary point in the past and run the ledger forward, the data management system starts at the present and runs the ledger in reverse. That is, the data management system may initialize counts and other metrics to the current state of the system as captured by ERP objects, and the data management system may execute the ledger activities in reverse and in reverse chronological order against a virtual model of state transitions to arrive at a snapshot. In some examples, this method can yield better results when the ledger data only exists for a certain, relatively recent period of time and starting values are unknown.

In a variation of this mode, the ledger is run in reverse starting with an explicitly saved snapshot rather than starting with the current state of the system.

In one embodiment, an Enterprise Process Modeler is an interface tool that allows capturing and saving a snapshot of the current runtime enterprise process data, enabling the snapshot to be reviewed later via the interface. In a particular embodiment, to save an enterprise process data as a snapshot: In the Enterprise Process window, the interface receives a user-selection of a “Save As Snapshot” option. In an Enter New Name window that appears, the interface receives a user-entered name and user confirmation that the user-entered name is completed.

In various embodiments, the data management system displays the Snapshot option (enabled), Select Snapshot drop-down list, Save Snapshot, Save As Snapshot, Delete Snapshot, and the time stamp of the snapshot. The data management system may receive user input to Cancel or Close the Enter New Name window. The data management system may also receive changes to the enterprise process snapshot and receive user input to save the snapshot, triggering the changes to be saved. The timestamp of the snapshot will not change when you make changes and save a snapshot again.

To save the snapshot with a new name, the user interface may receive input to select the Save As Snapshot option, enter a new name, and confirm the name choice (e.g., by submitting the choice or clicking “OK”). The data management system may save the new snapshot with the original timestamp. The data management system may limit changes or allow for limited changes to the enterprise process snapshot. For example, changes to the fields in the Show Filter Options and Show Analytics Options windows may or may not be supported, to prevent the snapshot from changing to a form that does not resemble the original timestamp using data captured based on an original set of filters. The data management system displays the “Disabled when a snapshot is opened.” message when you attempt to make changes that are not supported.

In one embodiment, to close the snapshot and view the current runtime enterprise process, the Snapshot option may be disabled or toggled off.

The data management system may be used to save multiple snapshots, and any of the saved snapshots may be listed in the Select Snapshot drop-down list.

In one embodiment, an existing snapshot is viewed when the Snapshot option is selected or enabled in the Enterprise Process window. In a particular embodiment, by default, the data management system displays the first snapshot in the Select Snapshot drop-down list automatically. From the Select Snapshot drop-down list, alternative snapshots may be selected for viewing instead.

A snapshot may be deleted via the interface using the Delete Snapshot option.

### Interactive Animation of Process State Analysis

FIG. 1D illustrates a flow chart of an example process 100D that cycles through frames of process states for different data slices to update an interactive node graph. In block 102D, the data management system generates an interactive node graph having nodes that represent process states and edges that represent connections between process states. In block 104D, the data management system uses a first live metric for determining aggregated node value(s) and/or a second live metric for determining aggregated edge value(s). In block 106D, the data management system causes display of an interactive node graph according to selected data slice(s) of a plurality of data slices. In block 108D, the data management system causes display of an option to play the interactive node graph through the plurality of data slices. In block 110D, the data management system receives a selection of the option to play the interactive node graph through the plurality of data slices. Based at least in part on the selection of the option to play the interactive node graph through the plurality of data slices, in block 112D, the data management system updates the display of the interactive node graph to show next different data slice(s) of the plurality of data slices. In block 114D, the data management system waits for an amount of time depending on a frame rate of the option. In block 116D, a determination is made as to whether there are more frames to show, for example, for yet-to-be-shown data slices of the plurality of data slices. If so, the process continues to block 112D for next different data slice(s) of the plurality of data slices. If not, the process ends or loops back to the first data slice of the plurality of data slices.

In one embodiment, a timeline playback or other interactive animation feature is displayed on a user interface to show transitions between grouping or dynamic filter criteria of data sets, such as live raw data sources or snapshots of raw data sources. The dynamic filter criteria are filter criteria that is capable of changing during the animation. The interactive animation feature may be transitioned between adjacent frames or from frame to frame by using an option such as a play button, fast forwarded or skipped ahead using a forward button, stepped ahead incrementally using a step ahead button, rewound or stepped back using rewind or step back buttons, and paused using a pause button. In this manner, the animation may be controlled using video controls even though the application is updating grouping or filtering criteria and pulling and displaying different datasets (or different portions of a same dataset), rather than merely loading images of a predefined video, as the animation proceeds forward.

An animation of these changes to grouping or other dynamic filter criteria viewed by a date or time value is referred to herein as a “timeline playback.” Other animations may also be available, such as an animation comparing different divisions, different regions, different products, or other criteria for which data matching discrete values may be stepped through in frames as a grouping or filter is updated to reference different ones of the discrete values. The forward and reverse progression of the animation may be time-ordered if the grouping or filter criteria is time-related, or have alphabetical, first-to-exist ordering (prioritizing values that first occurred before other values in the data set), or other ordering if the grouping or filter criteria is relating to another dimension.

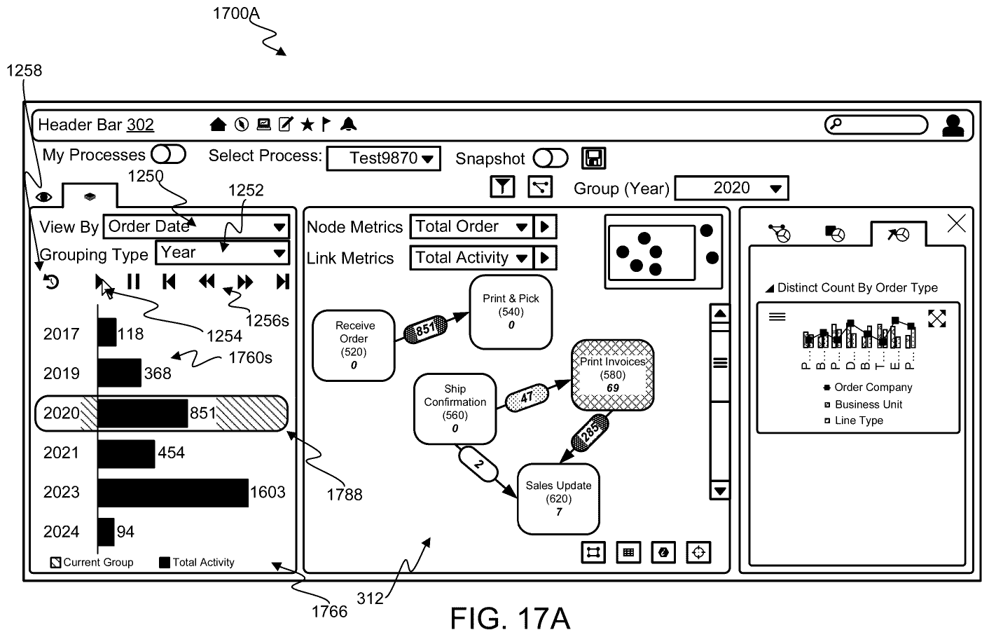

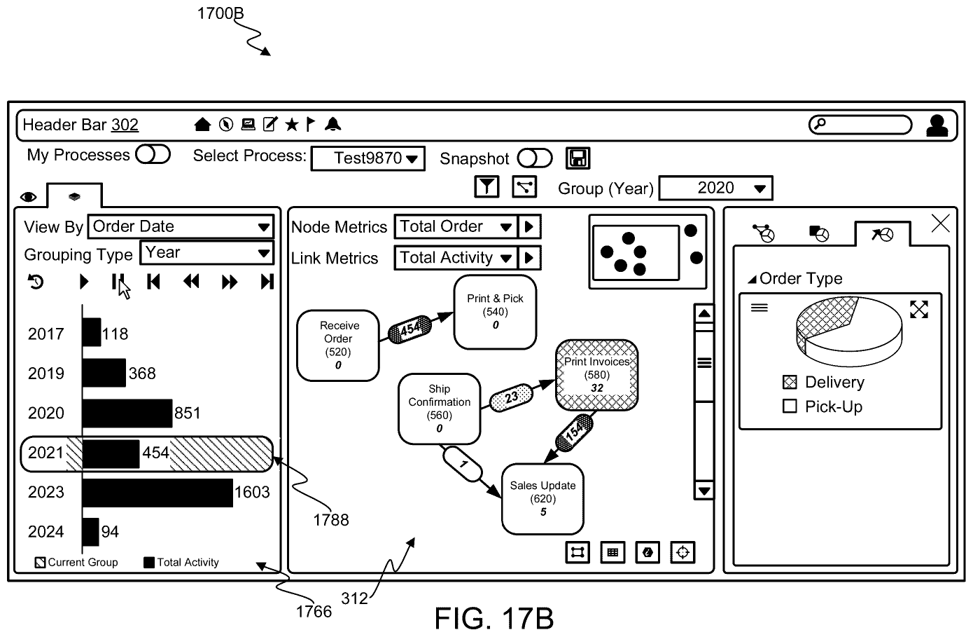

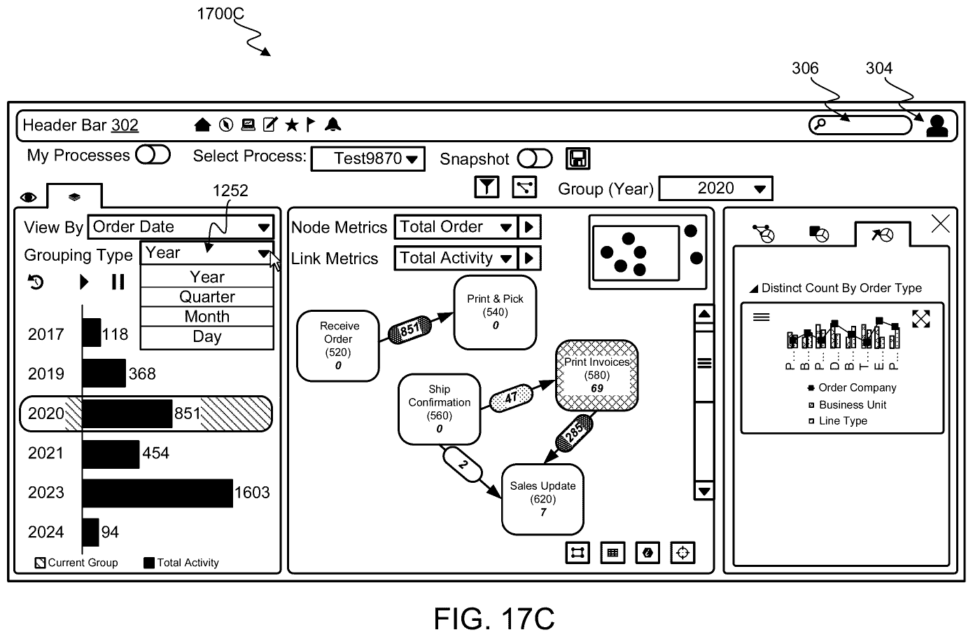

FIGS. 17A-17C illustrate example diagrams of interfaces for configuring and playing a timeline animation of node graphs. As shown, node graph summary region 1766 includes graphical elements 1760s corresponding to different groups that are available for display in node graph region 312. A particular group is selected as indicated by selection graphic 1788. Animation controls 1256s are available for controlling an animation as node graph frames step through or cycle through groups indicated by graphical elements 1760s. Play button 1254 triggers playback of the animation through different data slices indicated by the different groups. Reset option 1258 returns to the first data slice, which is the 2017 group in the example. As shown in FIG. 17A, the animation is playing through the group 2020 as indicated by selection graphic 1788 that follows along with the animation. Node graphs are updated in node graph region 312 as the animation steps through different groups. As shown in FIG. 17B, selection graphic 1788 has moved to group 2021, and the node graph has been updated in node graph region 312. Updated node and/or edge values are shown, optionally with updated nodes and edges corresponding to the different group. FIG. 17C shows grouping type selector activated as a drop-down menu is used to select from among different groups. Selecting quarter, month, or day would change the data slices that are stepped through or cycled through by the animation as well as the graphical elements shown in the node graph summary region. As shown for the time dimension used, the node graph is changed by cycling through groups chronologically. Depending on the selection of the grouping type selector, the chronological cycling may occur by cycling through, for example, different years, quarters, months, or days during playback.

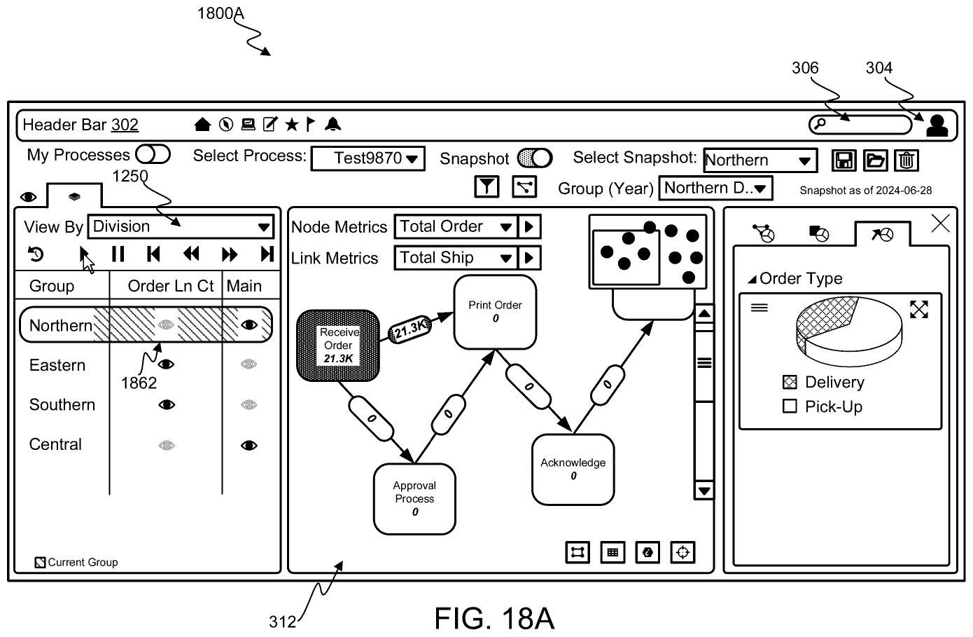

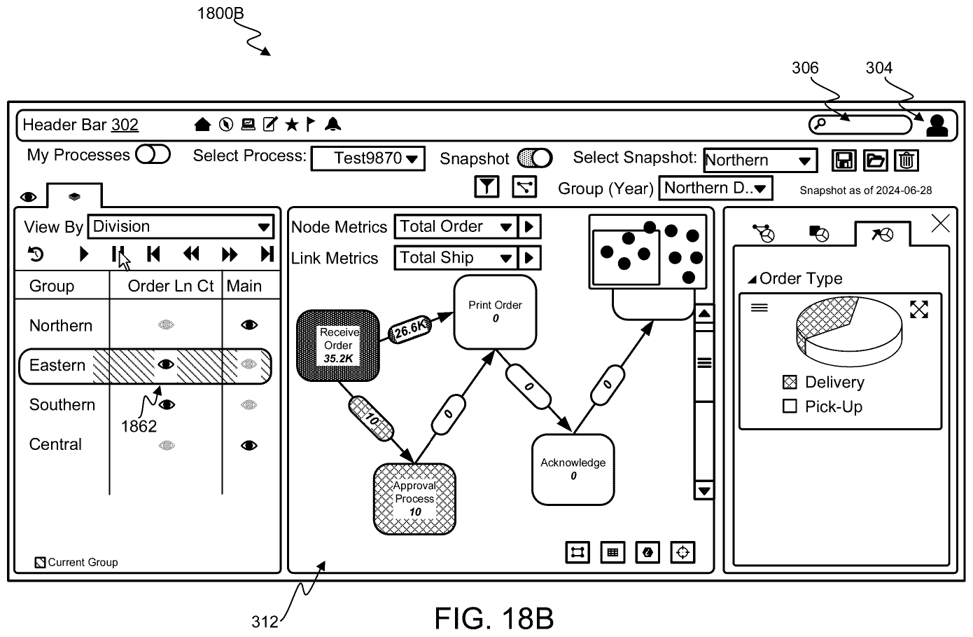

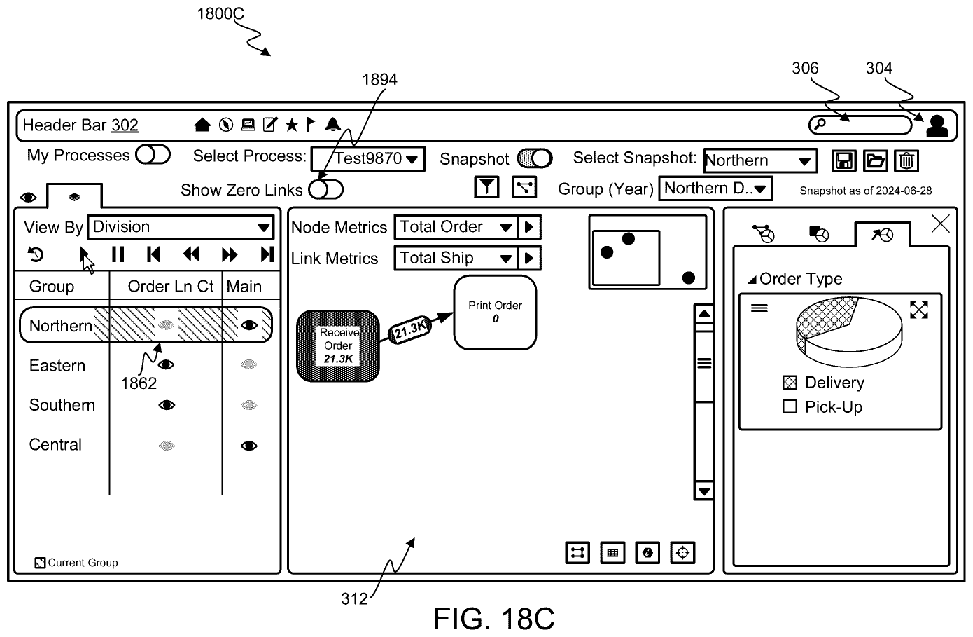

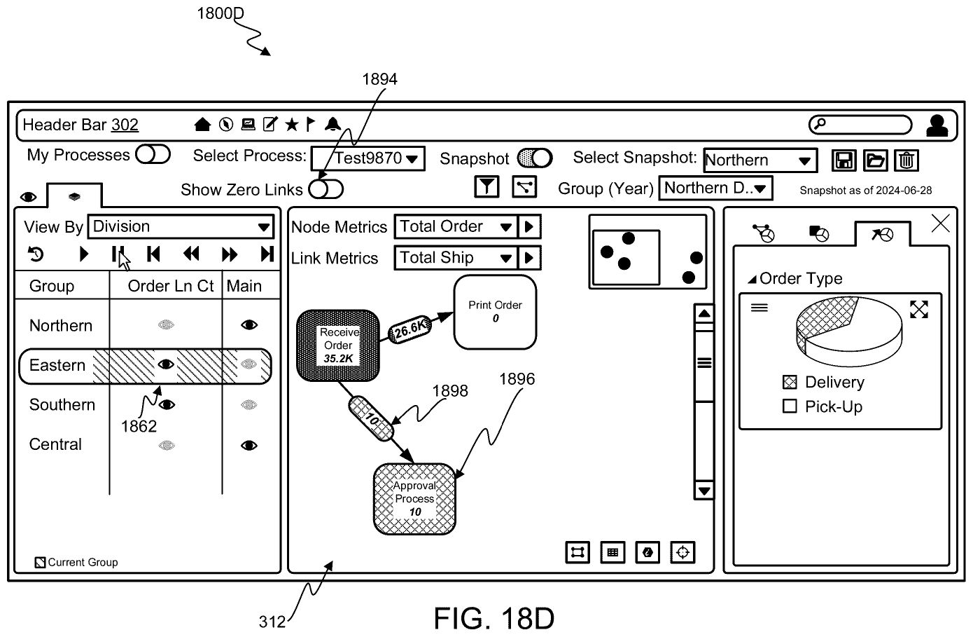

FIGS. 18A-18B illustrate example diagrams of interfaces for configuring and playing a field-based animation of node graphs while showing edges to nodes that are represented in the model but not represented in the dataset. As shown in FIG. 18A, the dimension viewed is “Division,” and the group of the “Division” dataset being viewed is “Northern,” as indicated by section graphic 1862. As shown, the Main data is selected for viewing but the Order Ln Ct data is de-selected for viewing. In FIG. 18B, the animation is shown to have played to the Eastern dataset, which is next in line, and is showing the Order Ln Ct data but not the Main data, which is de-selected for the Eastern group. Different data may be selected or de-selected for different groups, and the animation may play through the groups showing the selected data without showing the de-selected data. As shown for the non-time dimension selected, the data is cycled through on the node graph in an order that the groups appear in the summary visualization region.

Regardless of the dimension selected to view the animation, the user interface may include further criteria for selecting a grouping type or level of the dimension from which to pull the discrete values for stepping through the various grouping or filter criteria (e.g., various ones of the groups) in frames. For example, a grouping type of “Year” may step through the data values with groups or filters applied to select different years in different frames at different times as the timeline playback proceeds. As another example, a grouping type of “Quarter” may step through the data values with filters applied to select different quarters in different frames at different times as the timeline playback proceeds. As yet another example, a grouping type of “Month” may step through the data values with filters applied to select different months in different frames at different times as the timeline playback proceeds. For non-time dimensions, levels may be selected such as “site,” “city,” “state,” “region,” or “country” for a location dimension, in which case the animation would step through discrete values known to the system for the selected level of the selected dimension with graphical elements corresponding to the different values being shown in different frames at different times.

In one embodiment, as an animation steps through different discrete values or other groups of values, an animation summary visualization is modified to indicate which of the discrete values is being visualized in the node graph visualization, which may be separate from the animation summary visualization. For example, the animation summary may include a bar chart with different amounts of data points or other aggregate data existing for different filters or groupings corresponding to different ones of the discrete values featured in different frames of the animation. As the animation proceeds, different bars on the bar chart may be highlighted or selected on the animation summary visualization to indicate that the separate node graph visualization has been updated to include data for the discrete value or group of values associated with the selected bar, which corresponds to the current frame of the animation. The animation may step through highlighting the different bars as the separate node graph visualization is updated frame-by-frame to correspond to the different bars at different times.

The animation summary visualization may include a legend indicating what aggregate value is being shown for each of the discrete values and what color or graphical indication is being used to indicate the selected discrete value for which the separate node graph visualization is being updated or has been updated to represent.

The animation summary visualization may be selectable such that selection of a graphical element corresponding to a discrete value causes the animation to transition to a frame featuring the discrete value corresponding to the selected graphical element. Selecting a particular graphical element during playback may cause the playback to pause, temporarily pause for a frame delay period or a longer period of time that also accounts for an attention transition time based on the user input received, and/or may allow the playback to proceed from that point forward.

Because the playback is not an actual video, interactive elements on the user interface may be selected or modified during the playback while the playback resumes. For example, graphical elements in the animation summary visualization may be selected, node(s) and/or edge(s) may be selected in the separate node graph visualization to display more detail about the selected node(s) and/or edge(s). Filter criteria may be changed for the node graph visualization as a whole. Settings for different graphical markings of the separate node graph visualization may be adjusted. A mini-map of the separate node graph visualization may be used to navigate the graph, and/or the graph may be panned, zoomed in or out, and/or reset to a default view. Extended visualizations may be interacted with, rearranged, copied, opened, zoomed in on, drilled into, or modified. Such interactions may cause the playback to pause, temporarily pause for a frame delay period or a longer period of time that also accounts for an attention transition time based on the user input received, and/or may allow the playback to proceed, accounting for any settings, data, views, perspectives, or visualizations selected, changed, or moved by the user input.

Different extended visualizations such as side charts, graphs, or other representations of data may be configured to be displayed in association with different filtered slices of data as the different filtered slices are displayed in different frames at different times for the node graph visualization. As the animation plays frame-by-frame from filtered slice to filtered slice, the extended visualizations may change corresponding to which extended visualizations are configured for a displayed filtered slice of data corresponding to the current frame. For example, the extended visualizations may highlight different aggregated aspects of data shown in the node graph visualization for different periods of time. When the animation enters a first frame corresponding to a first time slice, the extended visualization may show aggregated data based on a first metric, and when the animation proceeds to a second frame corresponding to a second time slice, the extended visualization may show aggregated data based on a different metric. These transitions in the extended visualizations may highlight different metrics or different aspects of the data that change over time in a manner beyond what is shown in the node graph visualization, where data values of the extended visualizations may be based on multiple nodes, multiple edges, or multiple different metrics of node(s) and/or edge(s). The extended visualizations may show a first level of data aggregation that covers multiple members of a dimension together and may be drilled-in to show finer-grained data relevant to individual members of the dimension. The extended visualizations may be synchronized with the node graph by causing concurrent display of different corresponding extended visualizations as different data slices are viewed on the node graph. In this manner, as the interactive node graph cycles through data slices during playback, the interface also synchronously cycles through extended visualizations that provide particular insights into the individual data slices being visualized in a current frame of the playback.

In one embodiment, node metrics and/or edge or “link” metrics may be modified before, during, or after playback, with changes taking effect immediately not just on the currently displayed data for the current frame but also on data being prepared for display in the next or future frame(s) of the playback. For example, the node metrics and/or edge metrics may be modified to mark different value threshold(s) with different graphical indication(s) (such as color, size, or transparency) of the value threshold(s) on the node graph visualization. Because different data slices are shown in different frames, a threshold may be satisfied by one slice of data shown in one frame but not satisfied by another slice of data shown in another frame. In this manner, the color, size, or transparency of nodes and/or edges may change from frame to frame as different thresholds are satisfied by different nodes and/or edges in different frames.

In an embodiment, graphic elements that represent nodes, edges, and/or extended visualizations may include fade-out and fade-in transitions or other smoothed transitions as the graphical elements change between different frames during playback. The graphical elements displayed in a prior frame may be blurred with the graphical elements to be displayed in a next frame before the graphical element in the next frame comes into focus. In this manner, the nodes, edges, and/or extended visualizations may be visually tracked during the transitions without causing a juddering effect that may, in some implementations, interfere with data analysis.

The data management system may animate changes in the node graph visualization over time. If node(s) and/or edge(s) do not have occurrences in the data slice covered by the frame (also called “zero nodes” or “zero links”), the node(s) and/or edge(s) may be hidden such that the graph changes shape depending on which node(s) and/or edge(s) have occurrences for a current data slice corresponding to a current frame of the animation. Different frames may show node graph visualizations with different numbers of nodes, different nodes, different numbers of edges, and/or different edges as different node(s) and/or edge(s) qualify as zero nodes or zero links for different frames. In this manner in the example, the interactive node graph changes shape, showing different nodes corresponding to different process states applicable to different data slices as the interactive node graph cycles through data slices of the plurality of data slices during playback.

FIGS. 18C-18D illustrate example diagrams of interfaces for configuring and playing a timeline animation of node graphs without showing edges to nodes that are not represented in the dataset. As shown in FIG. 18C, selection graphic 1862 indicates that the Northern group is selected, and data is shown in node graph region 312 without showing zero links. The show zero links option 1894 is toggled off, indicating that links having no value and nodes connected only through those links are removed from the node graph. As shown, the node graph in node graph region 312 is simplified to two nodes and one link for the Northern group. In FIG. 18D, after the selection graphic 1862 has played forward to the Eastern group, the node graph in node graph region 312 has changed shape to include a new node 1896 and a new edge 1898 that were not shown for the Northern group in FIG. 18C. As the node graph plays forward with the animation, the graph may change shape to add nodes and/or edges, remove nodes and/or edges, or show different nodes and/or edges for different groups shown at different times in different frames during playback.

In one embodiment, portions of an animation that change most from frame to frame may be graphically highlighted or emphasized to draw attention to the changing features. For example, a brighter region like a spotlight may be shown around the node and/or edge values changing most rapidly frame-to-frame. As another example, the more rapidly changing values may be circled, made non-transparent, or otherwise emphasized with a temporary graphic to draw attention to the change. Another way to draw attention to changing portions of the animation is to draw attention away from non-changing portions of the animation. The portions of the animation changing least from frame to frame may be grayed out, blurred, or made transparent to draw attention away from the non-changing portions. The animation settings may be configured for the node graph visualization as a whole and/or for individual nodes or edges in the node graph visualization, such that some nodes may be marked as candidates for graphical emphasis or de-emphasis and other nodes may be marked as non-candidates for graphical emphasis or de-emphasis. In a particular example, important nodes showing critical process states may be marked as non-candidates for de-emphasis to ensure that the important nodes are shown in each frame where occurrences are available. In the example, other nodes may be marked as candidates for emphasis if they represent disruptive process states that occur less frequently or that cost more resources to transition away from.

In one embodiment, after dynamic filter criteria has been selected and before or during selection of an option to play back the animation, data slices supporting the different frames of the animation are retrieved from a data source. The different data slices may be determined by a group by operation, for example, where the grouping is done according to the dynamic filter criteria, such as year, quarter, or month. The different data slices may be ready for display based on this data retrieval from the source and the initial grouping without requiring a re-retrieval of data during the playback. The different data slices may be stored in memory by the data management system, ready to display as the animation transitions from frame to frame. By storing the data slices in memory based on the initial data retrieval, the data management system may support a more seamless animation from frame to frame even when the animation is based on aggregations of large quantities of data (e.g., thousands, tens of thousands, or hundreds of thousands of data points).

The data management system may provide configuration options for animation playback to control not just the dynamic filter criteria selected but also the frame rate of the playback. For example, the frame rate could be selected to allocate a certain amount of time (5 seconds, for example) per frame to ensure that the viewer has enough time to absorb the contents presented in the frame before a transition occurs to the next frame. The configuration options may also control the transition effects (e.g., fade, blur, etc.) between frames, the animation summary visualization settings (e.g., highlighting color for the current data slice value representing the current frame), settings to fill in missing data, and other animation features.

Within a given frame of the animation, one or more moving graphical elements may be shown to indicate how items or processes are transitioning from one state to another state. For example, dots may move along the arrows in the direction of the arrows, and/or nodes or edges with higher or lower metrics in the given frame may be shown as growing or shrinking relative to a prior frame.

In one embodiment, the data management system may smooth data over an animation when the dynamic filter criteria cannot otherwise be evenly distributed based on the underlying data. For example, if the dynamic filter criteria is to transition the animation year-to-year but the underlying data is missing data for a particular year, the data for the particular year may be inferred based on closest sets of data that are available, such as data from a prior year and data from a next year. The inference may be done by smoothing the data or otherwise aggregating, averaging, predicting, or projecting data values from one subset of data to another. In another embodiment, irregularly spaced intervals may be handled by extending an amount of time that certain frames are shown relative to other frames if the frames cover more time than the other frames. These settings may be configured in the animation summary visualization settings.

In one embodiment, an annotation may be saved as metadata for a snapshot or raw data such that the annotation may be shown in combination with a node graph visualization when the snapshot or raw data is viewed. For example, the annotation may indicate that “business was closed for a week due to weather conditions,” or “our biggest customer paid their bill a month late,” to signal why process states may not align with expectations for a given time slice of the node graph visualization. The annotation may be saved with a timestamp or range such that the annotation appears in the animation, for example, adjacent to the node graph visualization, only for the frame for which the annotation is relevant (e.g., where the timestamp falls within the frame's time range) and not for other frames for which the annotation is not relevant (e.g., where the timestamp falls outside the frame's time range). The annotation may additionally or alternatively be saved in association with a particular node or edge such that the annotation is displayed adjacent to the particular node or edge of the node graph visualization, or closer to the particular node or edge than to other nodes or edges of the node graph visualization.

The node graph visualization may be exported to an MP4 or other video file for viewing as a video. The export setting may export a simulated animation that is not shown on the screen, and/or may allow for export of the simulated animation as shown on the screen. If the export setting is to export the simulated animation as shown on the screen, additional user inputs such as selections of certain nodes or edges, mouseover or highlighting of certain metrics, selections of extended visualizations, or pauses or other on-the-fly interactions with the node graph visualization or the animation summary visualization may be preserved in the video such that selected items and customized on-the-fly transitions based on user input are included in the video rather than a deterministic transition from one node graph to another node graph according to predefined settings.

The data management system allows for animating the state of business processes over time. The animation goes beyond a mere view of a data slice at a specific point in time but shows how the states of the processes change over time. The data management system may use one or more of saved snapshots of the states of business processes and/or ledger/transactional data to play an animation of the process states as the process states change over time. In one example, the data management system provides an animation of the states of processes over a period of time based on activity captured in a ledger. In another example, the data management system provides an animation of the states of processes over a period of time based on snapshots captured at regular or irregular intervals.

The visualization may change smoothly (as in animation, including fade in and fade out effects or gradual re-sizing, re-coloring, or re-positioning of graphical elements) to reflect changing data. For instance, as the value of a metric on a node increases, the node may increase in size or change color, attracting users'attention to the change.

If certain snapshot data is missing or the snapshots are irregularly spaced through time, the data management system can accommodate this by timing the advancement from one frame to the next to wait an amount of time that is proportional to the amount of time between snapshots and thus maintain a smooth progression through time.

Alternatively, and to maintain smooth animation, when snapshots are irregularly spaced or missing, the data management system can use the snapshots before and after to infer approximate values for the missing snapshots, again maintaining smooth progression through time.

In one embodiment, timelines can also be looped and/or played in reverse, and the data management system provides a configuration interface for adjusting the rate of progression through time or “frame rate” used when the timeline is played, whether forward or backward. In one example, if a user is playing the animation of a process over the course of a month, the data management system may show where bottlenecks form, indicating where instances are getting stuck in a choke-point within the system and only trickling through. By visually depicting the bottleneck, the data management system may prompt the user to make improvements to the process such as adding additional resources to process items at that choke point.

The data management system uses saved snapshots and/or ledger data to create each “frame” of the animation. The system then iterates through the frames, updating the visualization to reflect the data within each frame.

In one embodiment, a constant rate-of-progress through time is maintained. This rate is configurable, but for example, one might set one second to represent one day. To maintain an even progression through time, the amount of time a particular frame is displayed can be made proportional to the amount of real time between one snapshot and the next. Alternatively, approximate intermediate frames can be generated by essentially using a line-of-best-fit or curve-of-best-fit on the available actual data to create reasonable approximations for missing data and maintain a smooth, constant-speed animation.

The data management system provides an interface for analyzing the enterprise process, for example, when the Show Analytics option is selected in the model toolbar. The data management system displays changes on the node graph visualization and extended visualizations tabs when the changes are made in the Analytics Options pane. In the model toolbar, the data management system may receive a selection of Show Analytics Options. The data management system may then display the left pane along with the View By drop-down list. In the View By drop-down list, the Overview option may be selected by default. The data management system may receive a selection from the other available options. The other options are displayed based on the template. If an option other than Overview is selected, either a Timeline view (for Date and UTIME data types) or a Domain view (for other data types) is displayed.

In one embodiment, the data management system displays a Timeline View indicator when a Date, UTIME, or any other time-related dimension is selected from the View By drop-down list. In this mode, the data management system provides the following options to analyze the process:
Select any of these options from the Grouping Type drop-down list: Year, Quarter, Month, and Day or any other different grouping types. When a value is selected from the Grouping Type drop-down list, the data management system displays a corresponding new drop-down list above the model pane. For example, if the data management system receives a selection of Grouping Type as Year, Quarter, or Month, a new drop-down list called Group (Year), Group (Quarter), or Group (Month) is displayed.

The data management system may select a value from the Group (Quarter) drop-down list (either from the field in the Display Options pane or the field above the model pane). The data management system displays the corresponding data on the node graph visualization and on the extended visualizations tabs on the right. Based on a selection of the Select Metrics icon on the rows to select a value for the Node and Link Metrics, the data management system supports analyzing the enterprise process using different values. The system changes the values accordingly in the Node Metrics and Link Metrics fields and displays the changes on the node graph visualization and extended visualizations tab on the right.

The node and link metrics may be selected for the first available value from the Grouping Type drop-down list by default.

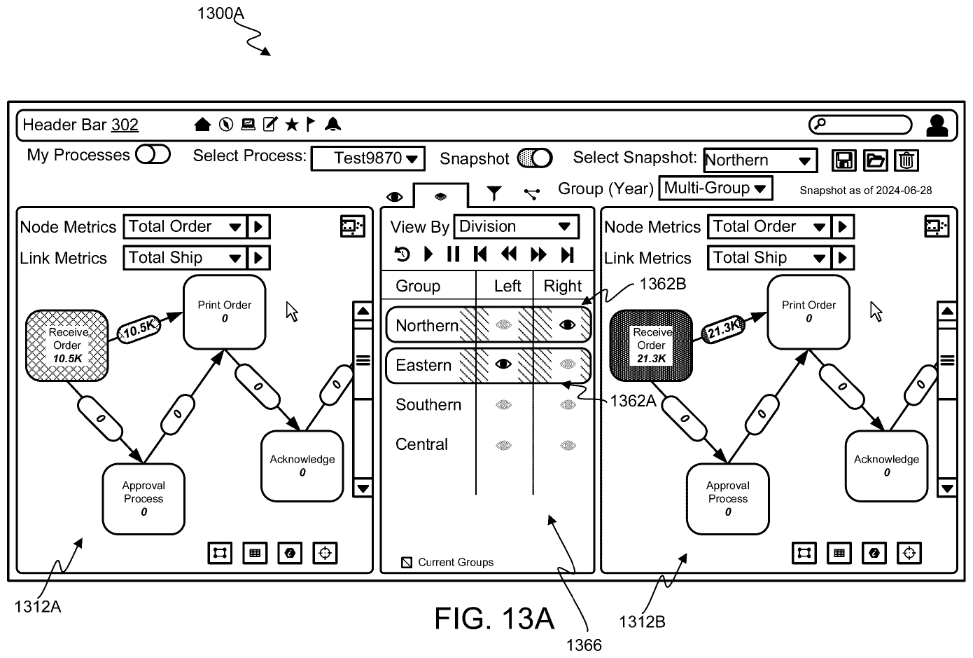

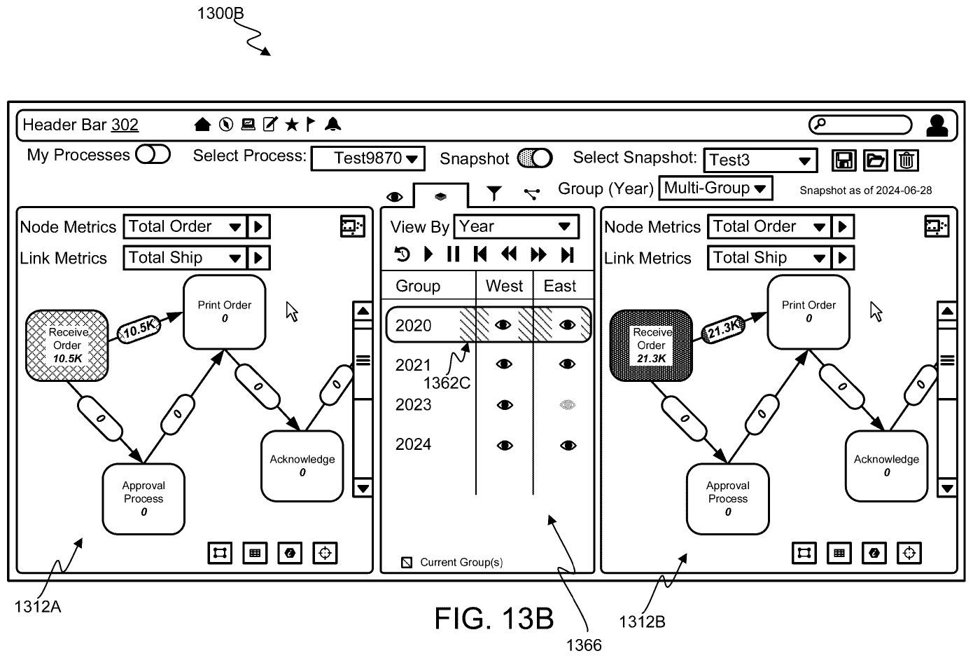

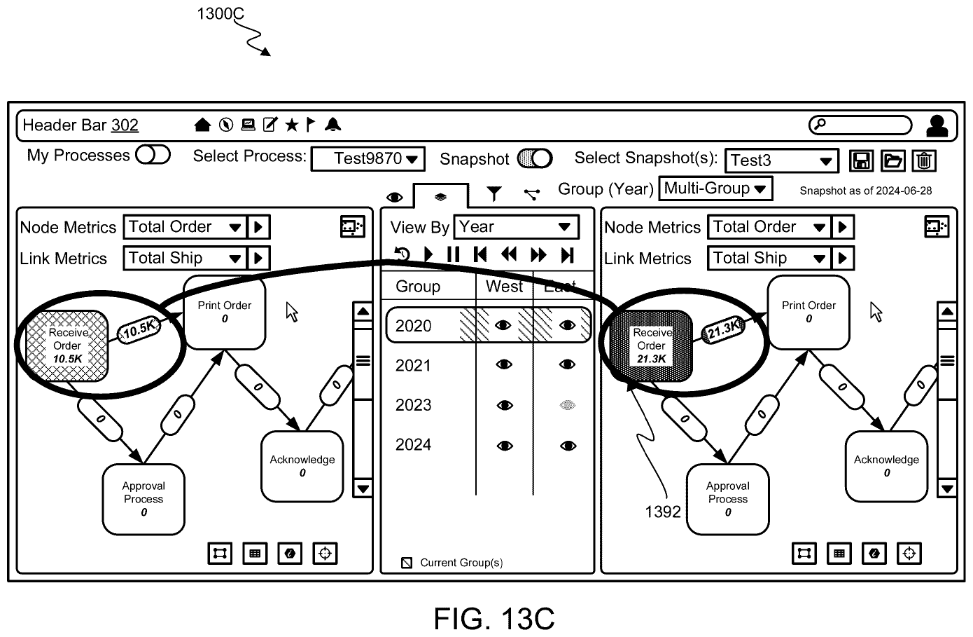

In one example, the metrics are selected (indicated by the Select Metrics eye icon) for the relevant columns for node metrics, link metrics, or relevant data sets, as shown in FIGS. 12K, 13A-C, and 18A-D. The group navigation controls may be used to view a specific data set: Start, Pause, Begin, Previous, Next, and End. Upon receiving a selection of an option to play via the Start icon, the data management system plays back data from all the rows in the selected group from beginning to end in order. The system displays the changes on the interactive node graph and the extended visualizations tab during the playback.

In one embodiment, the playback may be indicated by a “moving hand on the clock” effect. Upon receiving selection of an option to pause playback, the data management system may interrupt the playback and stay on a currently selected frame.

In one embodiment, the system may display a Domain View indicator upon receiving a selection of a data type other than Date, UTIME, or a time-related dimension in the View By drop-down list. In this example, the data management system may provide options for analyzing the process, including a Group drop-down list above the model pane for selecting among the groups. The first group may be selected by default in the Group drop-down list. A new value may be selected from the Group drop-down list to change how data slices are generated for viewing in frames by changing how the data is grouped.

In one embodiment, upon receiving a selection of the Select Metrics icon, indicated by the eye in the corresponding rows, a value may be selected for Node and Link Metrics. The system changes the values accordingly in the Node Metrics and Link Metrics fields and displays the changes on the node graph visualization and extended visualizations tab on the right.

By default, the node and link metrics are selected (indicated by the Select Metrics icon) for the first group in the Domain View panel. The Begin, Previous, Next, and End icons may be selected to view the Node and Link metrics of different groups. The Hide View Options icon (X) may be selected to close the Analytics Options pane.

### Mixed Source Analyses of Process States

In various embodiments, snapshots, animations, live views of process states, and/or other visualizations of process states may be shown side-by-side, in different panels, merged, or overlapping with color-coding to show differences between different sets of data. For example, the visualizations may be shown side-by-side with an ability to step through the visualizations using a common filter that affects which data is shown on multiple visualizations at the same time. If the common filter is selected to show “December” data, for example, the visualizations displayed may transition to show only “December” data rather than showing data for the full year as might be available in the corresponding datasets, whether snapshot, live view, or corresponding animations. The separate visualizations may be loaded according to a multi-view setting that causes display of the common filter to control the separate visualizations of the multi-view setting.

FIGS. 13A-13B illustrate example diagrams of interfaces for viewing snapshots or other node graphs side-by-side. As shown, node graph regions 1312A and 1312B are shown corresponding to selections 1362B of the northern region for right side node graph region 1312B and 1362A of the Eastern region for left side node graph region 1312A in node graph summary region 1366. In the example, the select metrics icons (shown as eyes) are used to indicate which of the selected groups is shown in which region, with darker eyes indicating the metric shows up in the corresponding region and lighter eyes indicating the metric does not show up in the corresponding region.

FIG. 13B shows a different selection 1362C of the different West and East datasets being shown for the same grouping of 2020 data, with data from the West data source being shown in node graph region 1312A and data from the East data source being shown in node graph region 1312B.

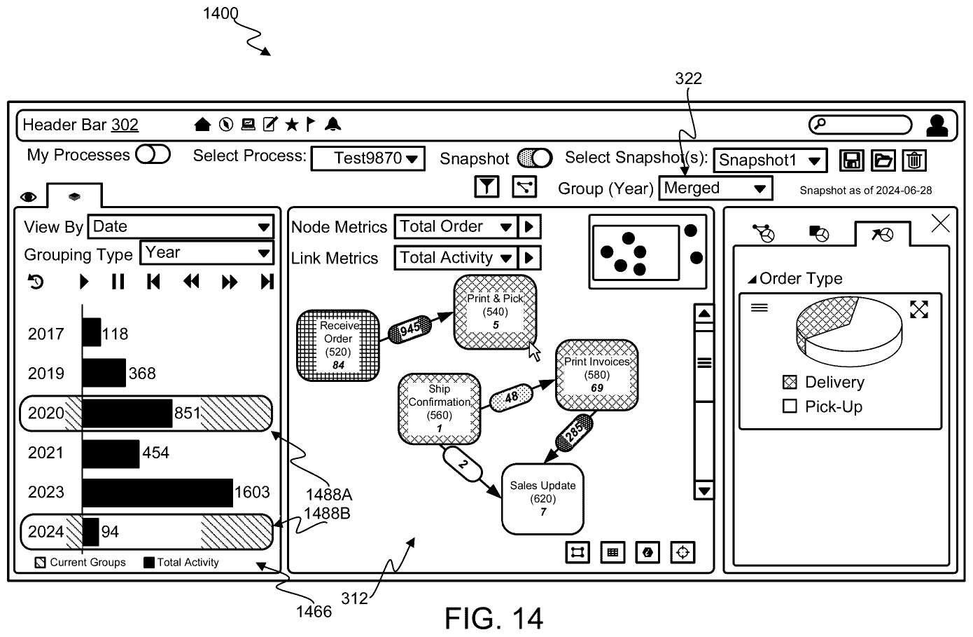

FIG. 14 illustrates an example diagram of an interface for viewing merged snapshots, data groups, or live views from different data sources. As shown, selections 1488A and 1488B have been made of different groups in node graph summary region 1466, and data slices corresponding to the different selections (for the 2020 group slice and the 2024 group slice, respectively) have been merged and displayed in node graph region 312. As shown, node values and link values have been aggregated from the different slices in node graph region 312. Also as shown, the group year is shown as Merged in group selector 322 instead of as an individually selected year. Selection of the Merged option in group selector 322 may allow multiple years to be selected and merged in node graph region 312.

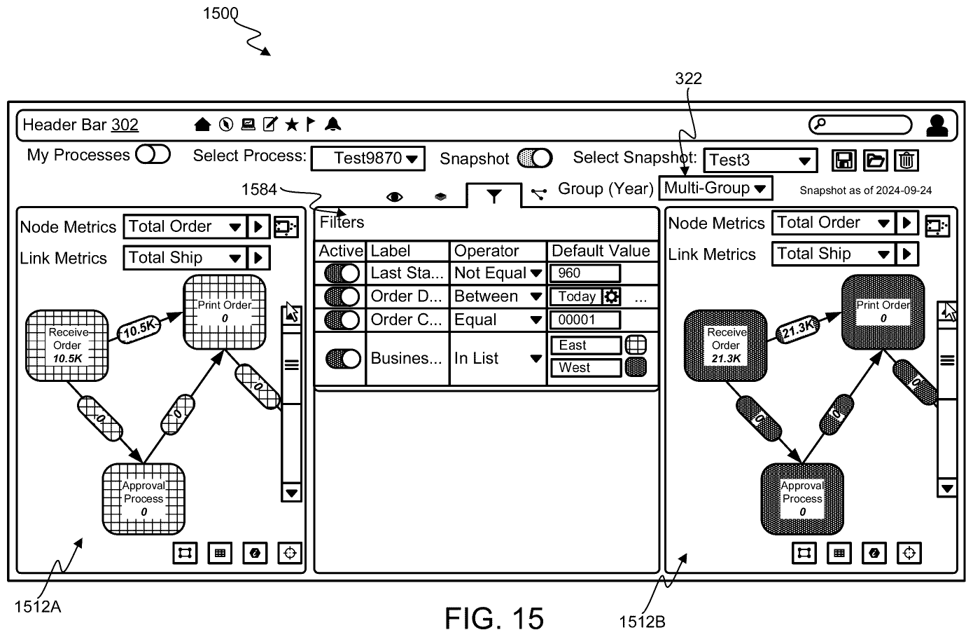

FIG. 15 illustrates an example diagram of an interface for filtering snapshots or other node graphs side-by-side. As shown, filters region 1584 includes filters for controlling which datasets are shown, The Business Unit label is selected with different colors for different items in the list, and the different colors may be shown in left node graph region 1512A and right node graph region 1512B, respectively. As shown, a multi-group option is selected in the group selector 322. Selection of the multi-group option may indicate a preference to show different groups in different node graphs. As different groups are indicated by differently colored values of the Business Unit label, the data management system chooses to display the different groups in different node graph regions in accordance with the setting of group selector 322.

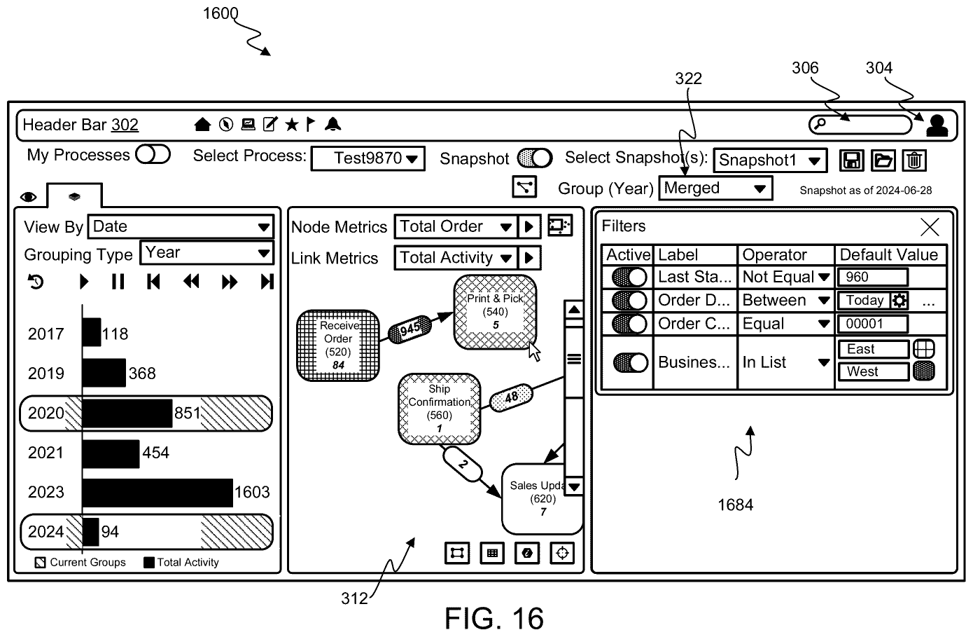

FIG. 16 illustrates an example diagram of an interface for filtering merged snapshots, data groups, or live views from different data sources. As shown, filters region 1684 includes filters for controlling which datasets are shown, The Business Unit label is selected with different colors for different items in the list, and the different colors may be shown as merged in node graph region 312. As shown, a merged option is selected in the group selector 322. Selection of the merged option may indicate a preference to show different groups merged in the same node graph. As different groups are indicated by differently colored values of the Business Unit label, the data management system chooses to display the different groups in the same node graph region, with different nodes and values being colored or graphically indicated corresponding to the different groups in accordance with the setting of the filters in filters region 1684.

A multi-view visualization may also highlight differences between the different sets of data, for example, if a process state metric or a metric regarding a transition between process states is different by more than a relative (e.g., 10%) or absolute (e.g., 100 units) threshold. The differences may be highlighted in a different color or circled and connected with a line, arc, or other graphic between the different node graph visualizations of the different datasets.

FIG. 13C illustrates an example diagram of interfaces for viewing snapshots or other node graphs side-by-side, with a graphical indication 1392 on the interface that connects data from one node graph to data of another node graph. For example, the graphical indication may highlight similarities or differences between node values and/or edge values between the node graphs. In the example, the graphical indication 1392 marks differences between node values and edge values between the node graphs.

As another example, multiple snapshots or other sets of data may be merged together or aggregated into a single snapshot or single set of data, with an option to split the multiple sets of data back up into separate sets of data and an option to view the multiple sets of data as the single set of data. For example, east division data may be saved as one snapshot, and west division data may be saved as a separate snapshot. The east division data and west division data may be merged together into a combined snapshot of east and west division data that may be viewed together based on the merged aggregate data.

In yet another example, multiple snapshots or multiple sets of data may be shown together in overlapping, overlaid, superimposed, or otherwise merged node graph visualizations on a same node graph visualization. In this example, node metrics may include metrics for each of the merged snapshots or sets of data, and multiple edges may be shown between nodes with each edge showing metrics for a different snapshot or different set of data. Alternatively, a single edge may show data for multiple snapshots or multiple sets of data, and/or data from different snapshots or different sets of data may be split among multiple nodes. The nodes and/or edges showing multiple sets of data or snapshots may be graphically distinguished from the nodes and/or edges showing data from a first set of data or snapshot, and both may be graphically distinguished from the nodes and/or edges showing data from a second set of data or snapshot. For example, the nodes and/or edges showing different sets of data or combined sets of data may be color-coded, and the node graph visualization may include a legend that shows which colors correspond to which sets of data and which color corresponds to the combined set of data. Because the sets of data are different, not all nodes and/or edges may be represented in both sets of data, and some nodes and/or edges may exist only for one of the sets of data and correspondingly, in the example, only in one of the colors. For example, nodes and/or edges corresponding to data from the east division may be shown in blue, nodes and/or edges corresponding to data from the west division may be shown in yellow, and nodes and/or edges corresponding to data from both the east and west divisions (e.g., combined in an aggregate (e.g., summed or averaged) metric that accounts for both sets of data or shown as separate aggregate metrics each corresponding to a separate set of data) may be shown in green. In a particular embodiment, the user interface provides a color selection option for graphical elements (e.g., nodes or edges) corresponding to each set of data shown in the node graph visualization along with an option to select a color for the graphical elements corresponding to the combined data or to merge the colors of the separate sets of data to generate the color for the graphical elements corresponding to the combined data. In this manner, the graphical elements may appear overlaid on one another.

In one embodiment, even though the data sets may have non-overlapping process states and/or non-overlapping transitions between process states, the user interface may include an option to preserve a shape of a first node graph visualization, a second node graph visualization, or to generate a new shape based on the nodes and edges in the combined node graph visualization. If the shape of a particular node graph visualization is preserved, another node graph visualization may be toggled in or out of the visualization by merging and un-merging the visualizations without changing the shape of the particular node graph visualization as the visualizations are merged and un-merged. Preserving the shape allows the visualization to retain visual meaning without requiring re-orientation as different data is added into the visualization or removed from the visualization. If a new shape is generated for the combined visualization, and/or if an existing shape of an existing visualization is selected, the user interface may include an option to force the new shape or existing shape onto other node graph visualizations to preserve the node and edge orientation and positions as different node graph visualizations are included or excluded from the displayed data as merged.

In one embodiment, a single set of data may be broken up into separate sets of data for the node graph visualization based on different filter criteria that define the different sets of data. For example, a first filter criteria may define a first division to be colored a first color on a node graph visualization, and a second filter criteria may define a second division to be colored a second color on the node graph visualization, and so on. Data corresponding to the different filter criteria may be shown as separated on the node graph visualization, with a graphical distinction such as color to indicate which edges, nodes, or corresponding metrics correspond to which filter criteria. In the example, data corresponding to the first division may be shown in green, and data corresponding to the second division may be shown in blue.

In various examples, the different sets of data defined by different filter criteria may be shown side-by-side, in different panels, merged, or overlapping with color-coding to show differences between different sets of data. A common filter may be displayed on the interface to control other filter criteria that apply to multiple sets of data shown. The different node graph visualizations shown may be snapshots, live raw data, and/or animations, or a combination of the different types of node graph visualizations.

### Synchronized Animations for Mixed Source Analyses

In various embodiments, animations may be synchronized during playback. For example, in FIG. 13B, different node graphs in regions 1312A and 1312B are shown for the same group. If the animation plays forward using the animation controls, the different node graphs in regions 1312A and 1312B change to correspond to the newly selected group. In this manner, the node graphs may be synchronized to the same group as the animation plays forward, changing synchronously with each other according to the shared timeline and/or shared grouping level and/or ordering. The data management system allows multiple node graphs to be controlled by single option(s) to play or navigate to different groups in the node graph summary region. The single option(s) may be displayed concurrently with the multiple node graphs and is/are effective to control the multiple node graphs. If the option is a play button, for example, the single option(s) changes selected data slices of each of the multiple node graphs synchronously as multiple node graphs are played according to the single option. In a further embodiment, differences between different node graphs may be highlighted or graphically marked, as in FIG. 13C, as the node graph plays forward in the animation.

### Computer System Architecture

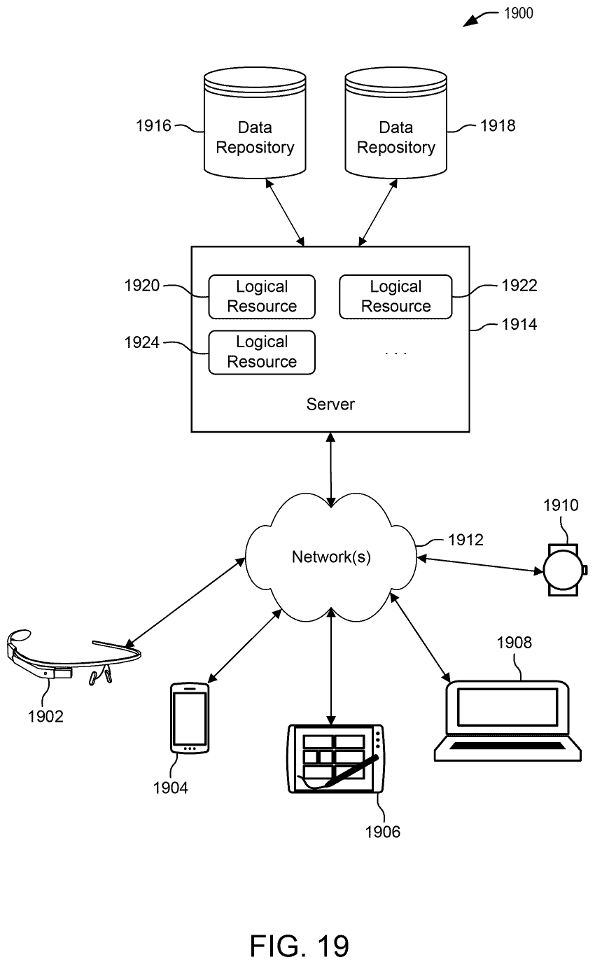

FIG. 19 depicts a simplified diagram of a distributed system 1900 for implementing an embodiment. In the illustrated embodiment, distributed system 1900 includes one or more client computing devices 1902, 1904, 1906, 1908, and/or 1910 coupled to a server 1914 via one or more communication networks 1912. Clients computing devices 1902, 1904, 1906, 1908, and/or 1910 may be configured to execute one or more applications.

In various aspects, server 1914 may be adapted to run one or more services or software applications that enable techniques for storing state model(s), aggregate dataset(s), ledger(s), and/or snapshot(s) and assembling interface component(s) such as an interactive node graph for display on a user interface.

In certain aspects, server 1914 may also provide other services or software applications that can include non-virtual and virtual environments. In some aspects, these services may be offered as web-based or cloud services, such as under a Software as a Service (SaaS) model to the users of client computing devices 1902, 1904, 1906, 1908, and/or 1910. Users operating client computing devices 1902, 1904, 1906, 1908, and/or 1910 may in turn utilize one or more client applications to interact with server 1914 to utilize the services provided by these components.

In the configuration depicted in FIG. 19, server 1914 may include one or more components 1920, 1922 and 1924 that implement the functions performed by server 1914. These components may include software components that may be executed by one or more processors, hardware components, or combinations thereof. It should be appreciated that various different system configurations are possible, which may be different from distributed system 1900. The embodiment shown in FIG. 19 is thus one example of a distributed system for implementing an embodiment system and is not intended to be limiting.

Users may use client computing devices 1902, 1904, 1906, 1908, and/or 1910 for techniques for storing state model(s), aggregate dataset(s), ledger(s), and/or snapshot(s) and assembling interface component(s) such as an interactive node graph for display on a user interface in accordance with the teachings of this disclosure. A client device may provide an interface that enables a user of the client device to interact with the client device. The client device may also output information to the user via this interface. Although FIG. 19 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 1912 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 1912 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 1914 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 1914 can include one or more virtual machines running virtual operating systems, or other computing architectures involving virtualization such as one or more flexible pools of logical storage devices that can be virtualized to maintain virtual storage devices for the server. In various aspects, server 1914 may be adapted to run one or more services or software applications that provide the functionality described in the foregoing disclosure.

The computing systems in server 1914 may run one or more operating systems including any of those discussed above, as well as any commercially available server operating system. Server 1914 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 1914 may include one or more applications to analyze and consolidate data feeds and/or event updates received from users of client computing devices 1902, 1904, 1906, 1908, and/or 1910. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1914 may also include one or more applications to display the data feeds and/or real-time events via one or more display devices of client computing devices 1902, 1904, 1906, 1908, and/or 1910.

Distributed system 1900 may also include one or more data repositories 1916, 1918. These data repositories may be used to store data and other information in certain aspects. For example, one or more of the data repositories 1916, 1918 may be used to store information for techniques for storing state model(s), aggregate dataset(s), ledger(s), and/or snapshot(s) and assembling interface component(s) such as an interactive node graph for display on a user interface. Data repositories 1916, 1918 may reside in a variety of locations. For example, a data repository used by server 1914 may be local to server 1914 or may be remote from server 1914 and in communication with server 1914 via a network-based or dedicated connection. Data repositories 1916, 1918 may be of different types. In certain aspects, a data repository used by server 1914 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 1916, 1918 may also be used by applications to store application data. The data repositories used by applications may be of different types such as, for example, a key-value store repository, an object store repository, or a general storage repository supported by a file system.

In one embodiment, server 1914 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

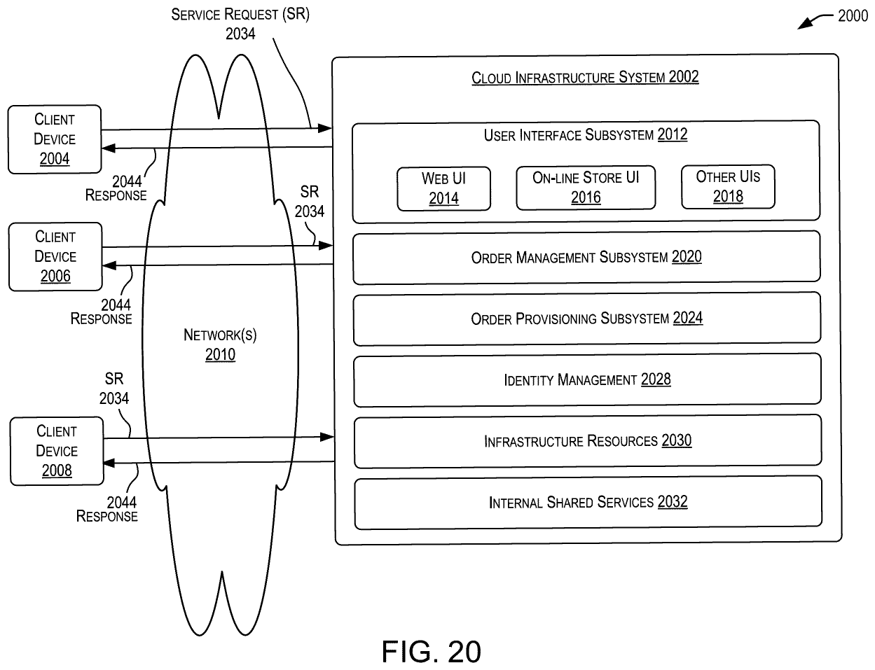

FIG. 20 is a simplified block diagram of a cloud-based system environment in which stores state model(s), aggregate dataset(s), ledger(s), and/or snapshot(s) and assembles interface component(s) such as an interactive node graph for display on a user interface, in accordance with certain aspects. In the embodiment depicted in FIG. 20, cloud infrastructure system 2002 may provide one or more cloud services that may be requested by users using one or more client computing devices 2004, 2006, and 2008. Cloud infrastructure system 2002 may comprise one or more computers and/or servers that may include those described above for server 1914. The computers in cloud infrastructure system 2002 may be organized as general purpose computers, specialized server computers, server farms, server clusters, or any other appropriate arrangement and/or combination.

Network(s) 2010 may facilitate communication and exchange of data between clients 2004, 2006, and 2008 and cloud infrastructure system 2002. Network(s) 2010 may include one or more networks. The networks may be of the same or different types. Network(s) 2010 may support one or more communication protocols, including wired and/or wireless protocols, for facilitating the communications.

The embodiment depicted in FIG. 20 is only one example of a cloud infrastructure system and is not intended to be limiting. It should be appreciated that, in some other aspects, cloud infrastructure system 2002 may have more or fewer components than those depicted in FIG. 20, may combine two or more components, or may have a different configuration or arrangement of components. For example, although FIG. 20 depicts three client computing devices, any number of client computing devices may be supported in alternative aspects.

The term cloud service is generally used to refer to a service that is made available to users on demand and via a communication network such as the Internet by systems (e.g., cloud infrastructure system 2002) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 2010 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 2002 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 2002 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 2002. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 2002. Cloud infrastructure system 2002 then performs processing to provide the services requested in the tenant's subscription order. Cloud infrastructure system 2002 may be configured to provide one or even multiple cloud services.

Cloud infrastructure system 2002 may provide the cloud services via different deployment models. In a public cloud model, cloud infrastructure system 2002 may be owned by a third party cloud services provider and the cloud services are offered to any general public tenant, where the tenant can be an individual or an enterprise. In certain other aspects, under a private cloud model, cloud infrastructure system 2002 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 2002 and the services provided may be shared by several organizations in a related community. Various other models such as hybrids of the above mentioned models may also be used.

Client computing devices 2004, 2006, and 2008 may be of different types (such as devices 1902, 1904, 1906, and 1908 depicted in FIG. 19) and may be capable of operating one or more client applications. A user may use a client device to interact with cloud infrastructure system 2002, such as to request a service provided by cloud infrastructure system 2002.

In some aspects, the processing performed by cloud infrastructure system 2002 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 2002 for determining the intent of an utterance. The data used for this analysis may include structured data (e.g., data stored in a database or structured according to a structured model) and/or unstructured data (e.g., data blobs (binary large objects)).

As depicted in the embodiment in FIG. 20, cloud infrastructure system 2002 may include infrastructure resources 2030 that are utilized for facilitating the provision of various cloud services offered by cloud infrastructure system 2002. Infrastructure resources 2030 may include, for example, processing resources, storage or memory resources, networking resources, and the like.

In certain aspects, to facilitate efficient provisioning of these resources for supporting the various cloud services provided by cloud infrastructure system 2002 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 2002 may itself internally use services 2032 that are shared by different components of cloud infrastructure system 2002 and which facilitate the provisioning of services by cloud infrastructure system 2002. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 2002 may comprise multiple subsystems. These subsystems may be implemented in software, or hardware, or combinations thereof. As depicted in FIG. 20, the subsystems may include a user interface subsystem 2012 that enables users of cloud infrastructure system 2002 to interact with cloud infrastructure system 2002. User interface subsystem 2012 may include various different interfaces such as a web interface 2014, an online store interface 2016 where cloud services provided by cloud infrastructure system 2002 are advertised and are purchasable by a consumer, and other interfaces 2018. For example, a tenant may, using a client device, request (service request 2034) one or more services provided by cloud infrastructure system 2002 using one or more of interfaces 2014, 2016, and 2018. For example, a tenant may access the online store, browse cloud services offered by cloud infrastructure system 2002, and place a subscription order for one or more services offered by cloud infrastructure system 2002 that the tenant wishes to subscribe to. The service request may include information identifying the tenant and one or more services that the tenant desires to subscribe to. For example, a tenant may place a subscription order for a chatbot related service offered by cloud infrastructure system 2002. As part of the order, the client may provide information identifying the input (e.g. utterances).

In certain aspects, such as the embodiment depicted in FIG. 20, cloud infrastructure system 2002 may comprise an order management subsystem (OMS) 2020 that is configured to process the new order. As part of this processing, OMS 2020 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 2020 may then invoke the order provisioning subsystem (OPS) 2024 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 2024 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 2002 may send a response or notification 2044 to the requesting tenant to indicate when the requested service is now ready for use. In some instances, information (e.g., a link) may be sent to the tenant that enables the tenant to start using and availing the benefits of the requested services.

Cloud infrastructure system 2002 may provide services to multiple tenants. For each tenant, cloud infrastructure system 2002 is responsible for managing information related to one or more subscription orders received from the tenant, maintaining tenant data related to the orders, and providing the requested services to the tenant or clients of the tenant. Cloud infrastructure system 2002 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 2002 may provide services to multiple tenants in parallel. Cloud infrastructure system 2002 may store information for these tenants, including possibly proprietary information. In certain aspects, cloud infrastructure system 2002 comprises an identity management subsystem (IMS) 2028 that is configured to manage tenant's information and provide the separation of the managed information such that information related to one tenant is not accessible by another tenant. IMS 2028 may be configured to provide various security-related services such as identity services, such as information access management, authentication and authorization services, services for managing tenant identities and roles and related capabilities, and the like.

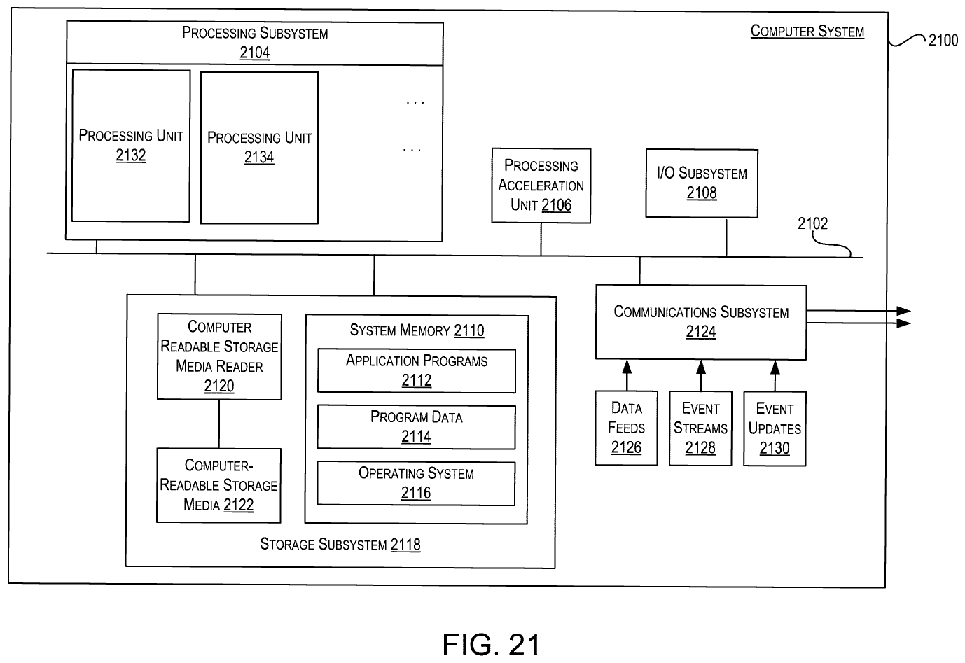

FIG. 21 illustrates an exemplary computer system 2100 that may be used to implement certain aspects. As shown in FIG. 21, computer system 2100 includes various subsystems including a processing subsystem 2104 that communicates with a number of other subsystems via a bus subsystem 2102. These other subsystems may include a processing acceleration unit 2106, an I/O subsystem 2108, a storage subsystem 2118, and a communications subsystem 2124. Storage subsystem 2118 may include non-transitory computer-readable storage media including storage media 2122 and a system memory 2110.

Bus subsystem 2102 provides a mechanism for letting the various components and subsystems of computer system 2100 communicate with each other as intended. Although bus subsystem 2102 is shown schematically as a single bus, alternative aspects of the bus subsystem may utilize multiple buses. Bus subsystem 2102 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 2104 controls the operation of computer system 2100 and may comprise one or more processors, application specific integrated circuits (ASICs), or field programmable gate arrays (FPGAs). The processors may be single core or multicore processors. The processing resources of computer system 2100 can be organized into one or more processing units 2132, 2134, etc. A processing unit may include one or more processors, one or more cores from the same or different processors, a combination of cores and processors, or other combinations of cores and processors. In some aspects, processing subsystem 2104 can include one or more special purpose co-processors such as graphics processors, digital signal processors (DSPs), or the like. In some aspects, some or all of the processing units of processing subsystem 2104 can be implemented using customized circuits, such as application specific integrated circuits (ASICs), or field programmable gate arrays (FPGAs).

In some aspects, the processing units in processing subsystem 2104 can execute instructions stored in system memory 2110 or on computer readable storage media 2122. In various aspects, the processing units can execute a variety of programs or code instructions and can maintain multiple concurrently executing programs or processes. At any given time, some or all of the program code to be executed can be resident in system memory 2110 and/or on computer-readable storage media 2122 including potentially on one or more storage devices. Through suitable programming, processing subsystem 2104 can provide various functionalities described above. In instances where computer system 2100 is executing one or more virtual machines, one or more processing units may be allocated to each virtual machine.

In certain aspects, a processing acceleration unit 2106 may optionally be provided for performing customized processing or for off-loading some of the processing performed by processing subsystem 2104 so as to accelerate the overall processing performed by computer system 2100.

I/O subsystem 2108 may include devices and mechanisms for inputting information to computer system 2100 and/or for outputting information from or via computer system 2100. In general, use of the term input device is intended to include all possible types of devices and mechanisms for inputting information to computer system 2100. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 2100 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 2118 provides a repository or data store for storing information and data that is used by computer system 2100. Storage subsystem 2118 provides a tangible non-transitory computer-readable storage medium for storing the basic programming and data constructs that provide the functionality of some aspects. Storage subsystem 2118 may store software (e.g., programs, code modules, instructions) that when executed by processing subsystem 2104 provides the functionality described above. The software may be executed by one or more processing units of processing subsystem 2104. Storage subsystem 2118 may also provide a repository for storing data used in accordance with the teachings of this disclosure.

Storage subsystem 2118 may include one or more non-transitory memory devices, including volatile and non-volatile memory devices. As shown in FIG. 21, storage subsystem 2118 includes a system memory 2110 and a computer-readable storage media 2122. System memory 2110 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 2100, such as during start-up, may typically be stored in the ROM. The RAM typically contains data and/or program modules that are presently being operated and executed by processing subsystem 2104. In some implementations, system memory 2110 may include multiple different types of memory, such as static random access memory (SRAM), dynamic random access memory (DRAM), and the like.

By way of example, and not limitation, as depicted in FIG. 21, system memory 2110 may load application programs 2112 that are being executed, which may include various applications such as Web browsers, mid-tier applications, relational database management systems (RDBMS), etc., program data 2114, and an operating system 2116. By way of example, operating system 2116 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 2122 may store programming and data constructs that provide the functionality of some aspects. Computer-readable media 2122 may provide storage of computer-readable instructions, data structures, program modules, and other data for computer system 2100. Software (programs, code modules, instructions) that, when executed by processing subsystem 2104 provides the functionality described above, may be stored in storage subsystem 2118. By way of example, computer-readable storage media 2122 may include non-volatile memory such as a hard disk drive, a magnetic disk drive, an optical disk drive such as a CD ROM, digital video disc (DVD), a Blu-Ray® disk, or other optical media. Computer-readable storage media 2122 may include, but is not limited to, Zip® drives, flash memory cards, universal serial bus (USB) flash drives, secure digital (SD) cards, DVD disks, digital video tape, and the like. Computer-readable storage media 2122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 2118 may also include a computer-readable storage media reader 2120 that can further be connected to computer-readable storage media 2122. Reader 2120 may receive and be configured to read data from a memory device such as a disk, a flash drive, etc.

In certain aspects, computer system 2100 may support virtualization technologies, including but not limited to virtualization of processing and memory resources. For example, computer system 2100 may provide support for executing one or more virtual machines. In certain aspects, computer system 2100 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 2100. Accordingly, multiple operating systems may potentially be run concurrently by computer system 2100.

Communications subsystem 2124 provides an interface to other computer systems and networks. Communications subsystem 2124 serves as an interface for receiving data from and transmitting data to other systems from computer system 2100. For example, communications subsystem 2124 may enable computer system 2100 to establish a communication channel to one or more client devices via the Internet for receiving and sending information from and to the client devices. For example, the communications subsystem may be used to transmit a response to a user regarding the inquiry for a chatbot.

Communications subsystem 2124 may support both wired and/or wireless communication protocols. For example, in certain aspects, communications subsystem 2124 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 2124 can provide wired network connectivity (e.g., Ethernet) in addition to or instead of a wireless interface.

Communications subsystem 2124 can receive and transmit data in various forms. For example, in some aspects, in addition to other forms, communications subsystem 2124 may receive input communications in the form of structured and/or unstructured data feeds 2126, event streams 2128, event updates 2130, and the like. For example, communications subsystem 2124 may be configured to receive (or send) data feeds 2126 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 2124 may be configured to receive data in the form of continuous data streams, which may include event streams 2128 of real-time events and/or event updates 2130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 2124 may also be configured to communicate data from computer system 2100 to other computer systems or networks. The data may be communicated in various different forms such as structured and/or unstructured data feeds 2126, event streams 2128, event updates 2130, and the like to one or more databases that may be in communication with one or more streaming data source computers coupled to computer system 2100.

Computer system 2100 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 2100 depicted in FIG. 21 is intended only as a specific example. Many other configurations having more or fewer components than the system depicted in FIG. 21 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
generating an interactive node graph comprising a plurality of nodes, each node of the plurality of nodes representing a process state of a plurality of process states; wherein the interactive node graph comprises a plurality of edges representing a plurality of connections between process states of the plurality of process states;
receiving input selecting a first live metric to use for determining one or more aggregated node values for one or more nodes of the plurality of nodes and a second live metric to use for determining one or more aggregated edge values for one or more edges of the plurality of edges;
causing display of the interactive node graph, including causing display of the one or more aggregated node values and the one or more aggregated edge values;
receiving selection of an option to save the interactive node graph;
based at least in part on the selection of the option, saving the interactive node graph at least in part by storing a snapshot comprising:
the one or more aggregated node values based on the first live metric as of a particular time,
the one or more aggregated edge values based on the second live metric as of the particular time,
a first mapping between the first live metric and the one or more nodes, and
a second mapping between the second live metric and the one or more edges;
wherein the stored snapshot is loadable without access to the first live metric and the second live metric to display the interactive node graph comprising one or more aggregated node values and the one or more aggregated edge values.

2. The computer-implemented method of claim 1, further comprising receiving an update to the first live metric or the second live metric, and, based at least in part on the update, updating display of the interactive node graph to include one or more updated aggregated node values or one or more updated aggregated edge values.

3. The computer-implemented method of claim 1, wherein storing the snapshot further comprises storing one or more filters configured for the interactive node graph, and wherein the stored snapshot is loadable without access to the first live metric and the second live metric to display the interactive node graph as filtered by the one or more filters.

4. The computer-implemented method of claim 1, wherein storing the snapshot further comprises storing two or more groups for which the first live metric and the second live metric are aggregated for the interactive node graph, and wherein the stored snapshot is loadable without access to the first live metric and the second live metric to display the interactive node graph according to selectable groups of the two or more groups.

5. The computer-implemented method of claim 4, wherein the interactive node graph is saved to show aggregated values corresponding to a first group of the two or more groups, the computer-implemented method further comprising:
loading the interactive node graph from the stored snapshot;
receiving other input on the interactive node graph as loaded from the stored snapshot; wherein the other input selects a second group of the two or more groups; and
based at least in part on the other input, updating the interactive node graph to show other aggregated values corresponding to the second group without access to the first live metric and the second live metric.

6. The computer-implemented method of claim 1, wherein storing the snapshot further comprises storing one or more visualization settings separate from the interactive node graph, wherein the one or more visualization settings are based at least in part on a plurality of aggregated values of the one or more aggregated node values and the one or more aggregated edge values, and wherein the stored snapshot is loadable without access to the first live metric and the second live metric to display the interactive node graph concurrently with one or more visualizations according to the one or more visualization settings based at least in part on the plurality of aggregated values.

7. The computer-implemented method of claim 1, wherein storing the snapshot further comprises storing one or more other aggregated node values or one or more other aggregated edge values according to another live metric that is not selected for display in the interactive node graph, the computer-implemented method further comprising:
loading the stored snapshot to display the interactive node graph;
receiving input to change selection of the first live metric to use for determining the one or more aggregated node values or the second live metric to use for determining the one or more aggregated edge values to the other live metric;
updating display of the interactive node graph without access to the other live metric to show the one or more other aggregated node values or the one or more other aggregated edge values.

8. The computer-implemented method of claim 1, further comprising simulating the one or more aggregated node values or the one or more aggregated edge values as of the particular time based at least in part on values of the first live metric as of another particular time.

9. The computer-implemented method of claim 1, further comprising simulating the one or more aggregated node values or the one or more aggregated edge values as of the particular time based at least in part on aggregated values of the first live metric from one or more other snapshots as of another particular time.

10. The computer-implemented method of claim 1, further comprising concurrently displaying two or more interactive node graphs and a common set of controls, wherein the common set of controls is used to change which aggregated values are shown in both of the two or more interactive node graphs.

11. A computer-program product comprising one or more non-transitory machine-readable storage media, including stored instructions configured to cause a computing system to perform a set of actions comprising:
generating an interactive node graph comprising a plurality of nodes, each node of the plurality of nodes representing a process state of a plurality of process states; wherein the interactive node graph comprises a plurality of edges representing a plurality of connections between process states of the plurality of process states;
receiving input selecting a first live metric to use for determining one or more aggregated node values for one or more nodes of the plurality of nodes and a second live metric to use for determining one or more aggregated edge values for one or more edges of the plurality of edges;
causing display of the interactive node graph, including causing display of the one or more aggregated node values and the one or more aggregated edge values;
receiving selection of an option to save the interactive node graph;
based at least in part on the selection of the option, saving the interactive node graph at least in part by storing a snapshot comprising:
the one or more aggregated node values based on the first live metric as of a particular time,
the one or more aggregated edge values based on the second live metric as of the particular time,
a first mapping between the first live metric and the one or more nodes, and
a second mapping between the second live metric and the one or more edges;
wherein the stored snapshot is loadable without access to the first live metric and the second live metric to display the interactive node graph comprising one or more aggregated node values and the one or more aggregated edge values.

12. The computer-program product of claim 11, wherein the set of actions further comprises receiving an update to the first live metric or the second live metric, and, based at least in part on the update, updating display of the interactive node graph to include one or more updated aggregated node values or one or more updated aggregated edge values.

13. The computer-program product of claim 11, wherein storing the snapshot further comprises storing two or more groups for which the first live metric and the second live metric are aggregated for the interactive node graph, and wherein the stored snapshot is loadable without access to the first live metric and the second live metric to display the interactive node graph according to selectable groups of the two or more groups.

14. The computer-program product of claim 11, wherein storing the snapshot further comprises storing one or more other aggregated node values or one or more other aggregated edge values according to another live metric that is not selected for display in the interactive node graph, wherein the set of actions further comprises:
loading the stored snapshot to display the interactive node graph;
receiving input to change selection of the first live metric to use for determining the one or more aggregated node values or the second live metric to use for determining the one or more aggregated edge values to the other live metric;
updating display of the interactive node graph without access to the other live metric to show the one or more other aggregated node values or the one or more other aggregated edge values.

15. The computer-program product of claim 11, wherein the set of actions further comprises simulating the one or more aggregated node values or the one or more aggregated edge values as of the particular time based at least in part on aggregated values of the first live metric from one or more other snapshots as of another particular time.

16. A system comprising:
one or more processors;
one or more non-transitory computer-readable media storing instructions, which, when executed by the system, cause the system to perform a set of actions comprising:
generating an interactive node graph comprising a plurality of nodes, each node of the plurality of nodes representing a process state of a plurality of process states; wherein the interactive node graph comprises a plurality of edges representing a plurality of connections between process states of the plurality of process states;
receiving input selecting a first live metric to use for determining one or more aggregated node values for one or more nodes of the plurality of nodes and a second live metric to use for determining one or more aggregated edge values for one or more edges of the plurality of edges;
causing display of the interactive node graph, including causing display of the one or more aggregated node values and the one or more aggregated edge values;
receiving selection of an option to save the interactive node graph;
based at least in part on the selection of the option, saving the interactive node graph at least in part by storing a snapshot comprising:
the one or more aggregated node values based on the first live metric as of a particular time,
the one or more aggregated edge values based on the second live metric as of the particular time,
a first mapping between the first live metric and the one or more nodes, and
a second mapping between the second live metric and the one or more edges;
wherein the stored snapshot is loadable without access to the first live metric and the second live metric to display the interactive node graph comprising one or more aggregated node values and the one or more aggregated edge values.

17. The system of claim 16, wherein the set of actions further comprises receiving an update to the first live metric or the second live metric, and, based at least in part on the update, updating display of the interactive node graph to include one or more updated aggregated node values or one or more updated aggregated edge values.

18. The system of claim 16, wherein storing the snapshot further comprises storing two or more groups for which the first live metric and the second live metric are aggregated for the interactive node graph, and wherein the stored snapshot is loadable without access to the first live metric and the second live metric to display the interactive node graph according to selectable groups of the two or more groups.

19. The system of claim 16, wherein storing the snapshot further comprises storing one or more other aggregated node values or one or more other aggregated edge values according to another live metric that is not selected for display in the interactive node graph, wherein the set of actions further comprises:
loading the stored snapshot to display the interactive node graph;
receiving input to change selection of the first live metric to use for determining the one or more aggregated node values or the second live metric to use for determining the one or more aggregated edge values to the other live metric;
updating display of the interactive node graph without access to the other live metric to show the one or more other aggregated node values or the one or more other aggregated edge values.

20. The system claim 16, wherein the set of actions further comprises simulating the one or more aggregated node values or the one or more aggregated edge values as of the particular time based at least in part on aggregated values of the first live metric from one or more other snapshots as of another particular time.
